(19) United States
(12) Patent Application Publication
(10) Pub. No.: US 2025/0347894 A1
(43) Pub. Date: Nov. 13, 2025

(54) CAPTURING OPTICAL LENS ASSEMBLY, IMAGE CAPTURING UNIT AND ELECTRONIC DEVICE

(71) Applicant: LARGAN PRECISION CO., LTD., Taichung City (TW)

(72) Inventors: Kuan-Ting YEH, Taichung City (TW); Yu-Han SHIH, Taichung City (TW)

(73) Assignee: LARGAN PRECISION CO., LTD., Taichung City (TW)

(21) Appl. No.: 18/747,209

(22) Filed: Jun. 18, 2024

(30) Foreign Application Priority Data
May 8, 2024 (TW) 113116934

(51) Int. Cl. G02B 13/00; G02B 1/04; G02B 9/64

(52) U.S. Cl. CPC G02B 13/0045; G02B 1/041; G02B 9/64; G02B 13/0065

(57) ABSTRACT

A capturing optical lens assembly includes eight lens elements which are, in order from an object side to an image side along an optical path: a first lens element, a second lens element, a third lens element, a fourth lens element, a fifth lens element, a sixth lens element, a seventh lens element and an eighth lens element. The first lens element has negative refractive power. The fourth lens element has an object-side surface being convex in a paraxial region thereof. The fifth lens element has an image-side surface being concave in a paraxial region thereof. The seventh lens element has an object-side surface having at least one inflection point. The eighth lens element with negative refractive power has an object-side surface being concave in a paraxial region thereof.

### RELATED APPLICATIONS

This application claims priority to Taiwan Application 113116934, filed on May 8, 2024, which is incorporated by reference herein in its entirety.

### BACKGROUND

### Technical Field

The present disclosure relates to a capturing optical lens assembly, an image capturing unit and an electronic device, more particularly to a capturing optical lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a capturing optical lens assembly includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

Preferably, the first lens element has negative refractive power. Preferably, the object-side surface of the fourth lens element is convex in a paraxial region thereof. Preferably, the image-side surface of the fifth lens element is concave in a paraxial region thereof. Preferably, the object-side surface of the seventh lens element has at least one inflection point. Preferably, the eighth lens element has negative refractive power. Preferably, the object-side surface of the eighth lens element is concave in a paraxial region thereof. Preferably, the capturing optical lens assembly further includes an aperture stop.

When an axial distance between the object-side surface of the first lens element and the image-side surface of the third lens element is Dr1r6, an axial distance between the aperture stop and the image-side surface of the eighth lens element is SD, an axial distance between the second lens element and the third lens element is T23, an axial distance between the third lens element and the fourth lens element is T34, an axial distance between the fourth lens element and the fifth lens element is T45, an Abbe number of the third lens element is V3, and a refractive index of the third lens element is N3, the following conditions are preferably satisfied:

$$1. 05 < Dr 1 r 6 / SD < 2. ;$$

$$0.03 < ( T 23 + T 45 ) / T 34 < 5. ; and$$

$$17. < V 3 / N 3 < 50.00 .$$

According to another aspect of the present disclosure, a capturing optical lens assembly includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

Preferably, the object-side surface of the second lens element is concave in a paraxial region thereof. Preferably, the image-side surface of the second lens element is convex in a paraxial region thereof. Preferably, the object-side surface of the fourth lens element is convex in a paraxial region thereof. Preferably, the fifth lens element has negative refractive power. Preferably, the object-side surface of the seventh lens element has at least one inflection point. Preferably, the capturing optical lens assembly further includes an aperture stop.

When an axial distance between the object-side surface of the first lens element and the image-side surface of the third lens element is Dr1r6, an axial distance between the aperture stop and the image-side surface of the eighth lens element is SD, a curvature radius of the image-side surface of the first lens element is R2, a curvature radius of the image-side surface of the eighth lens element is R16, and a maximum field of view of the capturing optical lens assembly is FOV, the following conditions are preferably satisfied:

$$1.05 < Dr 1 r 6 / SD < 2. ;$$

$$- 1. < R 2 / R 16 < 1.3 ; and$$

$$130. degrees < FOV < 200. degrees .$$

According to another aspect of the present disclosure, an image capturing unit includes one of the aforementioned capturing optical lens assemblies and an image sensor, wherein the image sensor is disposed on an image surface of the capturing optical lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows: FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a schematic view of an image capturing unit according to the 11th embodiment of the present disclosure;

FIG. 22 shows spherical aberration curves, astigmatic field curves and a distortion curve of the image capturing unit according to the 11th embodiment;

FIG. 23 is a schematic view of an image capturing unit according to the 12th embodiment of the present disclosure;

FIG. 24 shows spherical aberration curves, astigmatic field curves and a distortion curve of the image capturing unit according to the 12th embodiment;

FIG. 25 is a perspective view of an image capturing unit according to the 13th embodiment of the present disclosure;

FIG. 26 is a perspective view of an electronic device according to the 14th embodiment of the present disclosure;

FIG. 27 is another perspective view of the electronic device in FIG. 26;

FIG. 28 is a perspective view of an electronic device according to the 15th embodiment of the present disclosure;

FIG. 29 is another perspective view of the electronic device in FIG. 28;

FIG. 30 is a block diagram of the electronic device in FIG. 28;

FIG. 31 is a perspective view of an electronic device according to the 16th embodiment of the present disclosure;

FIG. 32 is a perspective view of an electronic device according to the 17th embodiment of the present disclosure;

FIG. 33 shows a schematic view of inflection points on lens surfaces, critical points on lens surfaces, Yc71 and Yi81 according to the 1st embodiment of the present disclosure;

FIG. 34 shows a schematic view of ET1, ET3, ET6, SAG1R2, YIR1, Y4R1, Y5R2, Y6R1, Y6R2, Y7R1 and Y8R2 according to the 1st embodiment of the present disclosure;

FIG. 35 shows a schematic view of a configuration of a light-folding element in a capturing optical lens assembly according to one embodiment of the present disclosure;

FIG. 36 shows a schematic view of another configuration of a light-folding element in a capturing optical lens assembly according to one embodiment of the present disclosure; and

FIG. 37 shows a schematic view of a configuration of two light-folding elements in a capturing optical lens assembly according to one embodiment of the present disclosure.

### DETAILED DESCRIPTION

A capturing optical lens assembly includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

The first lens element can have negative refractive power. Therefore, it is favorable for forming a short focal length of the lens structure, such that light from a large field of view can enter the capturing optical lens assembly for enlarging the light receiving range, which can be applicable to various applications.

The object-side surface of the second lens element can be concave in a paraxial region thereof. Therefore, it is favorable for controlling the shape of the object-side surface of the second lens element, thereby alleviating light from the large field of view and reducing spherical aberration of the capturing optical lens assembly. The image-side surface of the second lens element can be convex in a paraxial region thereof. Therefore, it is favorable for preventing light divergence to correct astigmatism.

The fourth lens element can have positive refractive power. Therefore, it is favorable for balancing aberrations of the first through third lens elements, thereby converging light to reduce the overall size of the capturing optical lens assembly. The object-side surface of the fourth lens element is convex in a paraxial region thereof. Therefore, it is favorable for enhancing the convergence ability of the fourth lens element to effectively correct spherical aberration of the capturing optical lens assembly. The image-side surface of the fourth lens element can be convex in a paraxial region thereof. Therefore, it is favorable for converging light to reduce the length of the capturing optical lens assembly and to correct aberrations.

The fifth lens element can have negative refractive power. Therefore, it is favorable for collaborating with the refractive power of the fourth lens element so as to balance the distribution of overall refractive power of the capturing optical lens assembly and to correct aberrations such as spherical aberration generated by size reduction. The image-side surface of the fifth lens element can be concave in a paraxial region thereof. Therefore, it is favorable for adjusting the emitting direction of light from the fifth lens element, thereby enlarging the image surface.

The seventh lens element can have positive refractive power. Therefore, it is favorable for reducing the length of the capturing optical lens assembly at the image end thereof. The object-side surface of the seventh lens element can be convex in a paraxial region thereof. Therefore, it is favorable for adjusting the surface shape and the refractive power of the seventh lens element so as to correct field curvature and to reduce the back focal length.

The eighth lens element can have negative refractive power. Therefore, it is favorable for effectively controlling the back focal length so as to reduce the total track length of the capturing optical lens assembly. The object-side surface of the eighth lens element can be concave in a paraxial region thereof. Therefore, it is favorable for controlling incident angle of light incident onto the object-side surface of the eighth lens element, thereby preventing light divergence and poor relative illuminance at the periphery due to an overly large incident angle.

According to the present disclosure, the object-side surface of the first lens element can have at least one convex shape in an off-axis region thereof. Therefore, it is favorable for receiving peripheral light so as to obtain image information from a relatively large range.

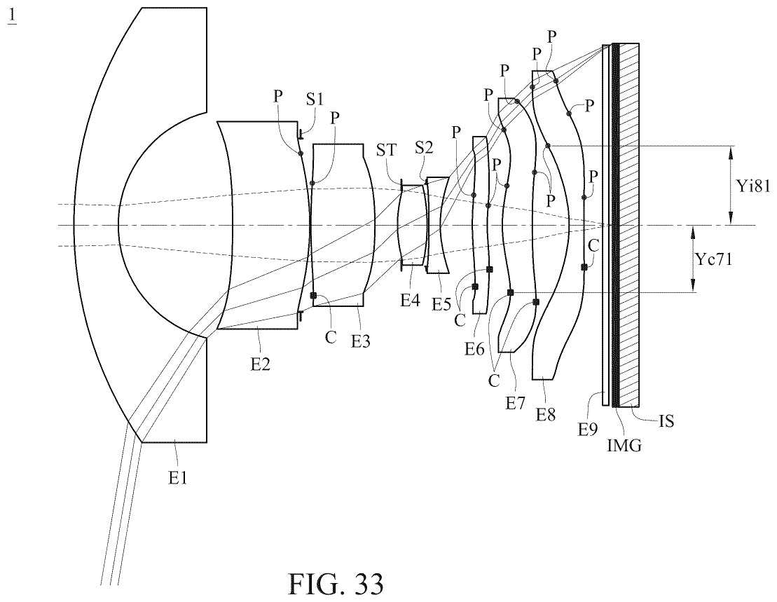

According to the present disclosure, the object-side surface of the seventh lens element has at least one inflection point. Therefore, it is favorable for reducing surface reflection of light from the large field of view so as to enhance the aberration correction ability at the periphery of the seventh lens element, thereby balancing convergence quality of light from the large field of view. According to the present disclosure, the object-side surface of the eighth lens element can have at least one inflection point. Therefore, it is favorable for adjusting optical path at the periphery to prevent vignette at the peripheral image while correcting field curvature and distortion. Please refer to FIG. 33, which shows a schematic view of inflection points P on the object-side surface of the seventh lens element E7 and the object-side surface of the eighth lens element E8 according to the 1st embodiment of the present disclosure. The abovementioned inflection points P on the object-side surface of the seventh lens element E7 and the object-side surface of the eighth lens element E8, as well as the image-side surface of the second lens element E2, the object-side surface of the third lens element E3, the object-side surface of the sixth lens element E6, the image-side surface of the sixth lens element E6, the image-side surface of the seventh lens element E7 and the image-side surface of the eighth lens element E8 in FIG. 33 are exemplary. Each of lens surfaces in various embodiments of the present disclosure may also have one or more inflection points.

According to the present disclosure, at least one lens element of the capturing optical lens assembly can be made of glass material. Therefore, it is favorable for increasing flexibility in refractive power configuration of the capturing optical lens assembly and reducing influence on the capturing optical lens assembly by ambient temperature. According to the present disclosure, at least two lens elements of the capturing optical lens assembly can be made of plastic material. Therefore, it is favorable for reducing manufacture cost, thereby reducing manufacturing difficulty of aspheric lenses.

According to the present disclosure, both of the object-side surface and the image-side surface of at least one lens element of the capturing optical lens assembly can be spherical. Therefore, it is favorable for reducing manufacturing error. Moreover, at least one lens element of the capturing optical lens assembly can be made of glass material with both of the object-side surface and the image-side surface thereof being spherical. Therefore, it is favorable for effectively increasing manufacturability and yield rate and also increasing the lifespan of applied product.

According to the present disclosure, there can be an air gap in a paraxial region between each of all adjacent lens elements of the capturing optical lens assembly; that is, each of the first through eighth lens elements can be a single and non-cemented lens element. The manufacturing process of cemented lenses is more complex than the non-cemented lenses, particularly when an image-side surface of one lens element and an object-side surface of the following lens element need to have accurate curvatures to ensure both lenses being properly cemented. In addition, during the cementing process, those two lens elements might not be well cemented due to misalignment, which is not favorable for the image quality. Therefore, having an air gap in a paraxial region between adjacent lens elements of the capturing optical lens assembly in the present disclosure is favorable for effectively preventing the problems of the cemented lens elements so as to increase flexibility in lens design and thus to improve image quality.

According to the present disclosure, the capturing optical lens assembly can further include an aperture stop. When an axial distance between the object-side surface of the first lens element and the image-side surface of the third lens element is Dr1r6, and an axial distance between the aperture stop and the image-side surface of the eighth lens element is SD, the following condition is satisfied: 1.05<Dr1r6/SD<2.00. Therefore, it is favorable for controlling the size at the object end of the capturing optical lens assembly under the assistance of the position of the aperture stop, thereby obtaining a proper balance between the total track length and the aperture stop position. Moreover, the following condition can also be satisfied: 1.10<Dr1r6/SD<1.80. Moreover, the following condition can also be satisfied: 1.29≤Dr1r6/SD≤1.67.

When an axial distance between the second lens element and the third lens element is T23, an axial distance between the third lens element and the fourth lens element is T34, and an axial distance between the fourth lens element and the fifth lens element is T45, the following condition can be satisfied: 0.03< (T23+T45)/T34<5.00. Therefore, it is favorable for adjusting the lens interval configuration, thereby guiding light from the large field of view to enter the image surface. Moreover, the following condition can also be satisfied: 0.05<(T23+T45)/T34<3.80. Moreover, the following condition can also be satisfied: 0.05<(T23+T45)/T34<1.50. Moreover, the following condition can also be satisfied: 0.12≤(T23+T45)/T34≤1.23.

When an Abbe number of the third lens element is V3, and a refractive index of the third lens element is N3, the following condition can be satisfied: 17.00<V3/N3<50.00. Therefore, a proper material selection of the third lens element is favorable for balancing the convergence abilities among different wavelengths. Moreover, the following condition can also be satisfied: 19.00<V3/N3<48.00. Moreover, the following condition can also be satisfied: 22.00<V3/N3<45.00. Moreover, the following condition can also be satisfied: 36.22≤V3/N3≤38.79.

When a curvature radius of the image-side surface of the first lens element is R2, and a curvature radius of the image-side surface of the eighth lens element is R16, the following condition can be satisfied: −1.00<R2/R16<1.30. Therefore, it is favorable for adjusting the surface shapes and refractive powers of the first and eighth lens elements so as to correct astigmatism and field curvature, thereby improving image quality. Moreover, the following condition can also be satisfied: −0.70<R2/R16<1.00. Moreover, the following condition can also be satisfied: −0.50<R2/R16<0.85. Moreover, the following condition can also be satisfied: −0.12≤R2/R16≤0.57.

When a maximum field of view of the capturing optical lens assembly is FOV, the following condition can be satisfied: 130.0 degrees<FOV<200.0 degrees. Therefore, it is favorable for having a relatively wide field of view of the optical lens so as to enlarge the application range of the product. Moreover, the following condition can also be satisfied: 140.0 degrees<FOV<195.0 degrees. Moreover, the following condition can also be satisfied: 145.0 degrees<FOV<185.0 degrees. Moreover, the following condition can also be satisfied: 153.8 degrees≤FOV≤173.04 degrees.

When an axial distance between the image-side surface of the eighth lens element and the image surface is BL, and a focal length of the capturing optical lens assembly is f, the following condition can be satisfied: 0.08<BL/f<0.55. Therefore, it is favorable for effectively controlling the back focal length so as to prevent an overly long total track length. Moreover, the following condition can also be satisfied: 0.13<BL/f<0.40.

When an axial distance between the aperture stop and the image surface is SL, and an axial distance between the object-side surface of the first lens element and the image surface is TL, the following condition can be satisfied: 0.25<SL/TL<0.75. Therefore, it is favorable for adjusting the position of the aperture stop with the cooperation with a lens structure having a wide field of view, thereby increasing relative illuminance at the peripheral field of view and obtaining a proper balance between illuminance, the depth of view and the image size. Moreover, the following condition can also be satisfied: 0.28<SL/TL<0.62. Moreover, the following condition can also be satisfied: 0.30<SL/TL<0.55.

When a central thickness of the second lens element is CT2, and a central thickness of the eighth lens element is CT8, the following condition can be satisfied: 2.00<CT2/CT8<10.00. Therefore, it is favorable for having a sufficient thickness of the second lens element so as to receive light from the large field of view into the capturing optical lens assembly. Moreover, the following condition can also be satisfied: 2.30<CT2/CT8<8.00.

When the axial distance between the object-side surface of the first lens element and the image surface is TL, an f-number of the capturing optical lens assembly is Fno, and a maximum image height of the capturing optical lens assembly (which can be half of a diagonal length of an effective photosensitive area of the image sensor) is ImgH, the following condition can be satisfied: 4.80<TL×Fno/ImgH<9.00. Therefore, it is favorable for obtaining a proper balance between the total track length, illuminance and the image size. Moreover, the following condition can also be satisfied: 5.70<TL×Fno/ImgH<8.50.

When the focal length of the capturing optical lens assembly is f, and a composite focal length of the fifth lens element and the sixth lens element is f56, the following condition can be satisfied: −1.50<f/f56<−0.30. Therefore, it is favorable for collaborating the refractive powers of the fifth and sixth lens elements so as to correct aberrations. Moreover, the following condition can also be satisfied: −1.20<f/f56<−0.35.

When a curvature radius of the object-side surface of the fourth lens element is R7, and a curvature radius of the image-side surface of the fourth lens element is R8, the following condition can be satisfied: −2.00< (R7+R8)/(R7−R8)<2.00. Therefore, it is favorable for adjusting the lens shape of the fourth lens element so as to correct aberrations caused by incident light from the large field of view and to reduce the sensitivity of the capturing optical lens assembly. Moreover, the following condition can also be satisfied: −0.70< (R7+R8)/(R7−R8)<0.70.

When the focal length of the capturing optical lens assembly is f, a focal length of the first lens element is f1, a focal length of the fifth lens element is f5, and a focal length of the eighth lens element is f8, the following condition can be satisfied: −2.50<f/f1+f/f5+f/f8<−1.00. Therefore, it is favorable for balancing the refractive power distribution of the capturing optical lens assembly under the specifications of a wide field of view and a short total track length. Moreover, the following condition can also be satisfied: −2.20<f/f1+f/f5+f/f8<−1.20.

When the curvature radius of the object-side surface of the fourth lens element is R7, and the curvature radius of the image-side surface of the fourth lens element is R8, the following condition can be satisfied: −4.00<R7/R8<2.50. Therefore, it is favorable for correcting spherical aberration and coma so as to increase image clearance. Moreover, the following condition can also be satisfied: −3.50<R7/R8<2.00.

When a curvature radius of the object-side surface of the first lens element is R1, and the curvature radius of the image-side surface of the eighth lens element is R16, the following condition can be satisfied: −2.50<R1/R16<5.50. Therefore, it is favorable for adjusting the light incident angle into and the light emitting angle from the capturing optical lens assembly, thereby obtaining a proper balance between the field of view and size distribution. Moreover, the following condition can also be satisfied: −2.00<R1/R16<4.50.

When a curvature radius of the object-side surface of the second lens element is R3, and a curvature radius of the image-side surface of the second lens element is R4, the following condition can be satisfied: 0.10<R3/R4<25.00. Therefore, it is favorable for adjusting the lens shape and the refractive power of the second lens element so as to adjust optical path of light from the large field of view. Moreover, the following condition can also be satisfied: 0.25<R3/R4<15.50.

When the focal length of the capturing optical lens assembly is f, a focal length of the second lens element is f2, and a focal length of the third lens element is f3, the following condition can be satisfied: 0.03<|f/f2|+|f/f3|<1.00. Therefore, it is favorable for controlling the refractive powers of the second and third lens elements so as to balance the convergence and divergence of incident light with a large field of view, thereby improving convergence quality of light from various fields of view. Moreover, the following condition can also be satisfied: 0.10<|f/f2|+|f/f3|<0.90.

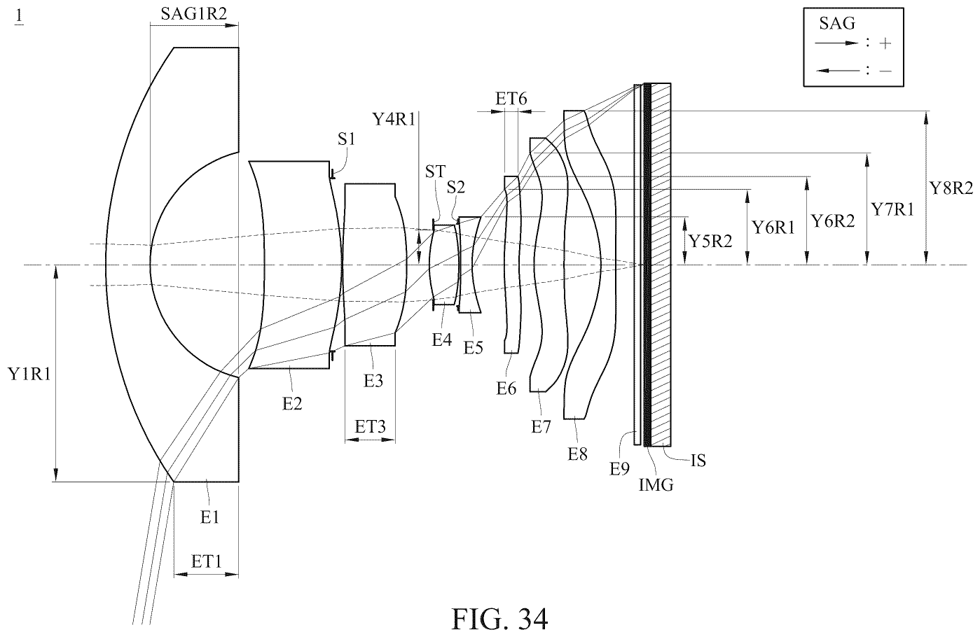

When a displacement in parallel with an optical axis from an axial vertex on the image-side surface of the first lens element to a maximum effective radius position on the image-side surface of the first lens element is SAG1R2, and a central thickness of the first lens element is CT1, the following condition can be satisfied: 1.35<SAG1R2/CT1<2.50. Therefore, it is favorable for effectively controlling the curvature degree at the periphery of the image-side surface of the first lens element, thereby obtaining a proper balance between the field of view and the manufacturability. Moreover, the following condition can also be satisfied: 1.40<SAG1R2/CT1<2.20. Please refer to FIG. 34, which shows a schematic view of SAG1R2 according to the 1st embodiment of the present disclosure. When the direction from the axial vertex of one surface to the maximum effective radius position of the same surface is facing towards the image side of the capturing optical lens assembly, the value of displacement is positive; when the direction from the axial vertex of the surface to the maximum effective radius position of the same surface is facing towards the object side of the capturing optical lens assembly, the value of displacement is negative.

When a maximum effective radius of the object-side surface of the first lens element is Y1R1, and a maximum effective radius of the image-side surface of the eighth lens element is Y8R2, the following condition can be satisfied: 1.00<Y1R1/Y8R2<2.00. Therefore, it is favorable for obtaining a proper balance between a wide field of view and an enlarged image surface by adjusting the ratio relationship of optical effective radii of the first and eighth lens elements. Moreover, the following condition can also be satisfied: 1.00<Y1R1/Y8R2<1.85. Please refer to FIG. 34, which shows a schematic view of Y1R1 and Y8R2 according to the 1st embodiment of the present disclosure.

When a distance in parallel with the optical axis between a maximum effective radius position of the object-side surface of the third lens element and a maximum effective radius position of the image-side surface of third lens element is ET3, and a distance in parallel with the optical axis between a maximum effective radius position of the object-side surface of the sixth lens element and a maximum effective radius position of the image-side surface of sixth lens element is ET6, the following condition can be satisfied: 1.60<ET3/ET6<5.00. Therefore, it is favorable for controlling the edge thicknesses of lens elements so as to improve manufacturability. Moreover, the following condition can also be satisfied: 2.00<ET3/ET6<4.00. Please refer to FIG. 34, which shows a schematic view of ET3 and ET6 according to the 1st embodiment of the present disclosure.

When the maximum image height of the capturing optical lens assembly is ImgH, the maximum effective radius of the object-side surface of the first lens element is Y1R1, and a maximum effective radius of the object-side surface of the fourth lens element is Y4R1, the following condition can be satisfied: 4.50<ImgH/Y4R1+Y1R1/Y4R1<16.00. Therefore, it is favorable for reducing the overall size of the capturing optical lens assembly under the specifications of a relatively wide field of view in photography and a relatively large image range while increasing the flexibility of mechanism space configuration. Moreover, the following condition can also be satisfied: 6.00<ImgH/Y4R1+Y1R1/Y4R1<14.50. Please refer to FIG. 34, which shows a schematic view of Y1R1 and Y4R1 according to the 1st embodiment of the present disclosure.

When the focal length of the fifth lens element is f5, and the focal length of the eighth lens element is f8, the following condition can be satisfied: −1.0<f5/f8<3.00. Therefore, it is favorable for adjusting the refractive power configuration of the fifth and eighth lens elements so as to correct aberrations and astigmatism and to adjust the field of view. Moreover, the following condition can also be satisfied: −0.5<f5/f8<2.80. Moreover, the following condition can also be satisfied: 0.00<f5/f8<2.50.

When the curvature radius of the image-side surface of the second lens element is R4, and a curvature radius of the object-side surface of the eighth lens element is R15, the following condition can be satisfied: −1.00<R15/R4<20.00. Therefore, it is favorable for collaborating the curvature radii of the second and eighth lens elements to correct distortion and field curvature. Moreover, the following condition can also be satisfied: 0.00<R15/R4<15.00.

When the focal length of the capturing optical lens assembly is f, and a focal length of the sixth lens element is f6, the following condition can be satisfied: −0.50<f/f6<0.30. Therefore, it is favorable for serving the sixth lens element as a correction lens element, thereby improving the contrast and recognizability of the image and thus improving image quality. Moreover, the following condition can also be satisfied: −0.30<f/f6<0.20.

When the curvature radius of the object-side surface of the eighth lens element is R15, and the curvature radius of the image-side surface of the eighth lens element is R16, the following condition can be satisfied: −7.50<(R15+R16)/(R15−R16)<1.50. Therefore, it is favorable for standardizing the design of the lens shape of the eighth lens element so as to achieve the effects of elimination of distortion, reduction in the total track length and also reduction in the sensitivity of the capturing optical lens assembly. Moreover, the following condition can also be satisfied: −5.60<(R15+R16)/(R15−R16)<1.00. Moreover, the following condition can also be satisfied: −3.10<(R15+R16)/(R15−R16)<0.80.

When the central thickness of the second lens element is CT2, a central thickness of the third lens element is CT3, a central thickness of the fourth lens element is CT4, a central thickness of the fifth lens element is CT5, a central thickness of the sixth lens element is CT6, a central thickness of the seventh lens element is CT7, and the central thickness of the eighth lens element is CT8, the following condition can be satisfied: 0.70< (CT2+CT3)/(CT4+CT5+CT6+CT7+CT8)<1.80. Therefore, it is favorable for adjusting the lens distribution so as to form a miniaturized lens structure with a wide field of view, thereby meeting various product applications. Moreover, the following condition can also be satisfied:

$$0.82 < ( CT 2 + CT 3 ) / ( CT 4 + CT 5 + CT 6 + CT 7 + CT 8 ) < 1.7 .$$

When the curvature radius of the image-side surface of the first lens element is R2, and a curvature radius of the object-side surface of the seventh lens element is R13, the following condition can be satisfied: −0.10<R2/R13<2.00. Therefore, it is favorable for collaborating the curvature radii of the image-side surface of the first lens element and the object-side surface of the seventh lens element, thereby harmonizing the optical path and correcting astigmatism and magnification chromatic aberration. Moreover, the following condition can also be satisfied: 0.15<R2/R13<1.80. Moreover, the following condition can also be satisfied: 0.20<R2/R13<1.55.

When the maximum image height of the capturing optical lens assembly is ImgH, and an axial distance between the object-side surface of the first lens element and the image-side surface of the eighth lens element is TD, the following condition can be satisfied: 0.50<2×ImgH/TD<1.10. Therefore, it is favorable for obtaining a proper balance between the image size and the overall size of the capturing optical lens assembly. Moreover, the following condition can also be satisfied: 0.56<2×ImgH/TD<1.00.

When a maximum effective radius of the image-side surface of the fifth lens element is Y5R2, a maximum effective radius of the object-side surface of the sixth lens element is Y6R1, a maximum effective radius of the image-side surface of the sixth lens element is Y6R2, and a maximum effective radius of the object-side surface of the seventh lens element is Y7R1, the following condition can be satisfied: 2.30<Y7R1/Y6R2+Y6R1/Y5R2<4.00. Therefore, it is favorable for reducing the overall size of the capturing optical lens assembly under the specifications of a wide field of view. Moreover, the following condition can also be satisfied: 2.50<Y7R1/Y6R2+Y6R1/Y5R2<3.20. Please refer to FIG. 34, which shows a schematic view of Y5R2, Y6R1, Y6R2 and Y7R1 according to the 1st embodiment of the present disclosure.

When a vertical distance between an off-axial critical point closest to an optical axis on the object-side surface of the seventh lens element and the optical axis is Yc71, and a vertical distance between an inflection point closest to the optical axis on the object-side surface of the eighth lens element and the optical axis is Yi81, the following condition can be satisfied: 0.65<Yc71/Yi81<1.40. Therefore, it is favorable for collaborating the seventh and eighth lens elements so as to adjust reflective angle of light at the peripheral area, thereby improving image quality of light from the wide field of view and increasing the response efficiency of the image sensor. Please refer to FIG. 33, which shows a schematic view of Yc71 and Yi81 according to the 1st embodiment of the present disclosure. The abovementioned critical point C on the object-side surface of the seventh lens element E7, as well as critical points C on the object-side surface of the third lens element E3, the object-side surface of the sixth lens element E6, the image-side surface of the sixth lens element E6, the image-side surface of the seventh lens element E7 and the image-side surface of the eighth lens element E8 in FIG. 33 are exemplary. Each of lens surfaces in various embodiments of the present disclosure may also have one or more critical points in an off-axis region thereof.

When a distance in parallel with the optical axis between a maximum effective radius position of the object-side surface of the first lens element and a maximum effective radius position of the image-side surface of first lens element is ET1, and the central thickness of the first lens element is CT1, the following condition can be satisfied: 1.10<ET1/CT1<2.20. Therefore, it is favorable for controlling the ratio of the edge thickness to the center thickness of the first lens element, such that the first lens element has a sufficient edge thickness to adjust the reflective angle of light from the large field of view while ensuring the formability of the lens element. Please refer to FIG. 34, which shows a schematic view of ET1 according to the 1st embodiment of the present disclosure.

According to the present disclosure, the aforementioned features and conditions can be utilized in numerous combinations so as to achieve corresponding effects.

According to the present disclosure, the lens elements of the capturing optical lens assembly can be made of either glass or plastic material. When the lens elements are made of glass material, the refractive power distribution of the capturing optical lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the capturing optical lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the capturing optical lens assembly, based on the corresponding image sensor, can be flat or curved, especially a curved surface being concave facing towards the object side of the capturing optical lens assembly.

According to the present disclosure, an image correction unit, such as a field flattener, can be optionally disposed between the lens element closest to the image side of the capturing optical lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

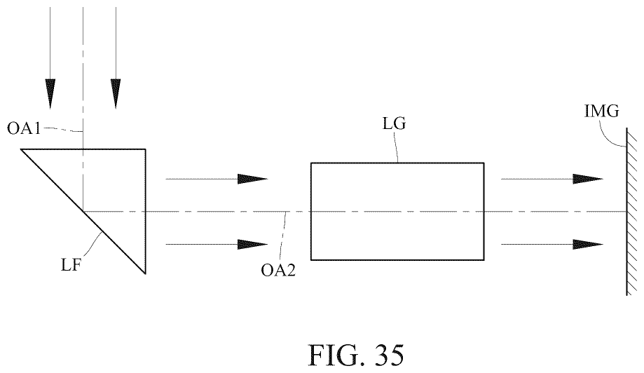

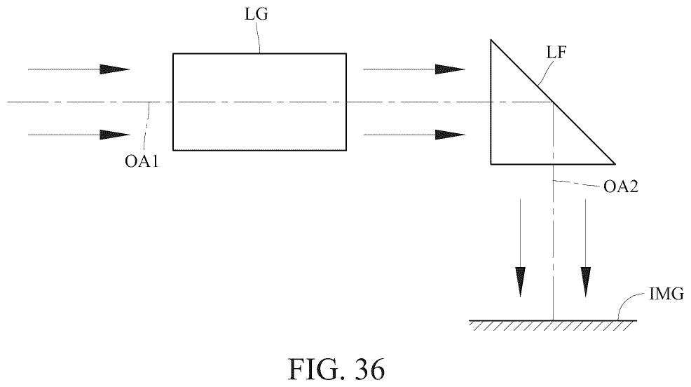

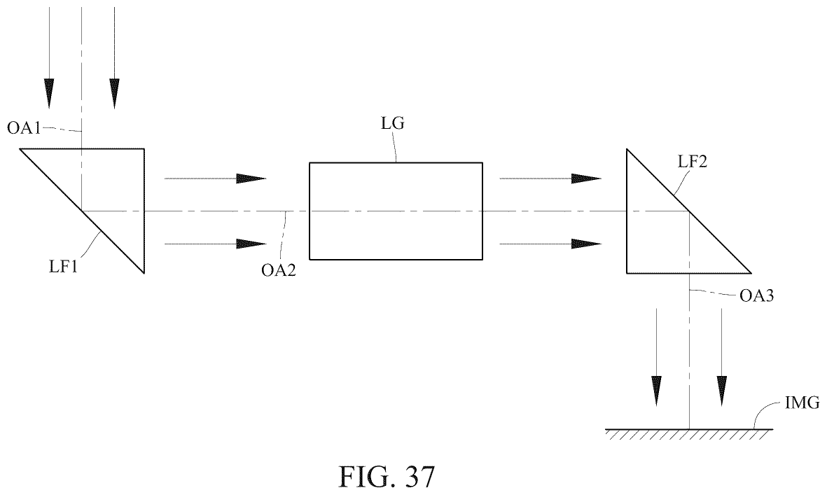

According to the present disclosure, at least one light-folding element, such as a prism or a mirror which can have a surface being planar, spherical, aspheric or in free-form, can be optionally disposed between an imaged object and the image surface on the imaging optical path, such that the capturing optical lens assembly can be more flexible in space arrangement, and therefore the dimensions of an electronic device is not restricted by the total track length of the capturing optical lens assembly. Specifically, please refer to FIG. 35 and FIG. 36. FIG. 35 shows a schematic view of a configuration of a light-folding element in a capturing optical lens assembly according to one embodiment of the present disclosure, and FIG. 36 shows a schematic view of another configuration of a light-folding element in a capturing optical lens assembly according to one embodiment of the present disclosure. In FIG. 35 and FIG. 36, the capturing optical lens assembly can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the capturing optical lens assembly as shown in FIG. 35 or disposed between a lens group LG of the capturing optical lens assembly and the image surface IMG as shown in FIG. 36. Furthermore, please refer to FIG. 37, which shows a schematic view of a configuration of two light-folding elements in a capturing optical lens assembly according to one embodiment of the present disclosure. In FIG. 37, the capturing optical lens assembly can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the capturing optical lens assembly, the second light-folding element LF2 is disposed between the lens group LG of the capturing optical lens assembly and the image surface IMG, and the travelling direction of light on the first optical axis OA1 can be the same direction as the travelling direction of light on the third optical axis OA3 as shown in FIG. 37. The capturing optical lens assembly can be optionally provided with three or more light-folding elements, and the present disclosure is not limited to the type, amount and position of the light-folding elements of the embodiments disclosed in the aforementioned figures.

According to the present disclosure, the capturing optical lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the capturing optical lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the capturing optical lens assembly and thereby provides a wider field of view for the same.

According to the present disclosure, the capturing optical lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the capturing optical lens assembly can include one or more optical elements for limiting the form of light passing through the capturing optical lens assembly. Each optical element can be, but not limited to, a filter, a polarizer, etc., and each optical element can be, but not limited to, a single-piece element, a composite component, a thin film, etc. The optical element can be located at the object side or the image side of the capturing optical lens assembly or between any two adjacent lens elements so as to allow light in a specific form to pass through, thereby meeting application requirements.

According to the present disclosure, the capturing optical lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and the image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

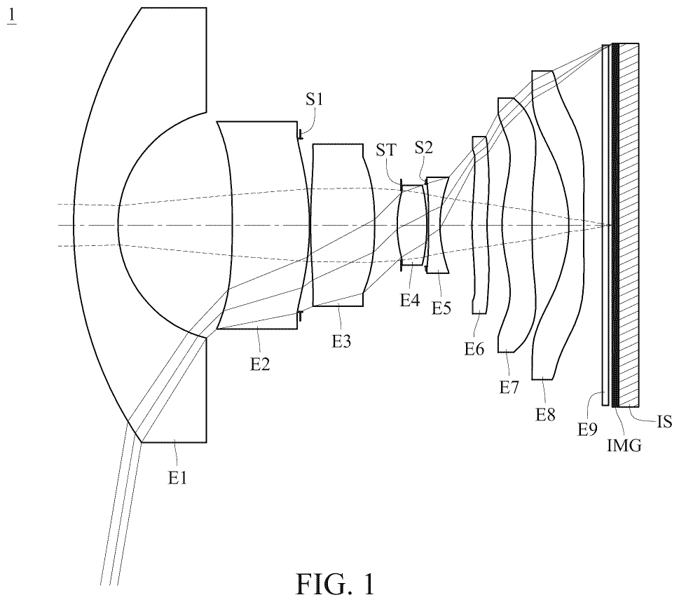

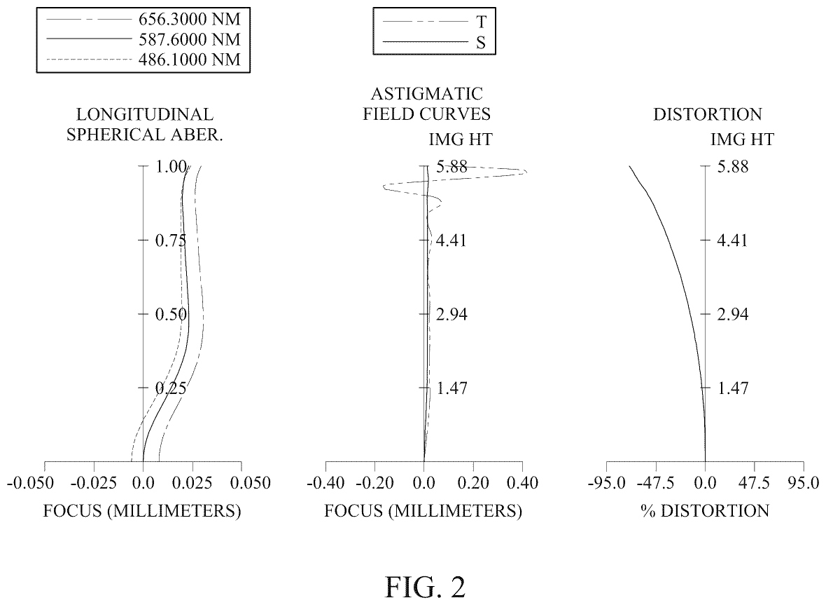

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The object-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26 and 28.

In the capturing optical lens assembly of the image capturing unit 1 according to the 1 st embodiment, when a focal length of the capturing optical lens assembly is f, an f-number of the capturing optical lens assembly is Fno, and half of a maximum field of view of the capturing optical lens assembly is HFOV, these parameters have the following values: f=3.71 millimeters (mm), Fno=2.75, HFOV=80.5 degrees (deg.).

When the maximum field of view of the capturing optical lens assembly is FOV, the following condition is satisfied: FOV=161.0 degrees.

When an axial distance between the object-side surface of the first lens element E1 and the image surface IMG is TL, the f-number of the capturing optical lens assembly is Fno, and a maximum image height of the capturing optical lens assembly is ImgH, the following condition is satisfied: TL×Fno/ImgH=8.16.

When the maximum image height of the capturing optical lens assembly is ImgH, and an axial distance between the object-side surface of the first lens element E1 and the image-side surface of the eighth lens element E8 is TD, the following condition is satisfied: 2×ImgH/TD=0.71.

When an axial distance between the image-side surface of the eighth lens element E8 and the image surface IMG is BL, and the focal length of the capturing optical lens assembly is f, the following condition is satisfied: BL/f=0.25.

When the focal length of the capturing optical lens assembly is f, and a focal length of the sixth lens element E6 is f6, the following condition is satisfied: f/f6=−0.10.

When a focal length of the fifth lens element E5 is f5, and a focal length of the eighth lens element E8 is f8, the following condition is satisfied: f5/f8=0.78.

When the focal length of the capturing optical lens assembly is f, and a composite focal length of the fifth lens element E5 and the sixth lens element E6 is f56, the following condition is satisfied: f/f56=−0.82.

When the focal length of the capturing optical lens assembly is f, a focal length of the second lens element E2 is f2, and a focal length of the third lens element E3 is f3, the following condition is satisfied: |f/f2|+|f/f3|=0.45.

When the focal length of the capturing optical lens assembly is f, a focal length of the first lens element E1 is f1, the focal length of the fifth lens element E5 is f5, and the focal length of the eighth lens element E8 is f8, the following condition is satisfied: f/f1+f/f5+f/f8=−1.72.

When an axial distance between the aperture stop ST and the image surface IMG is SL, and the axial distance between the object-side surface of the first lens element E1 and the image surface IMG is TL, the following condition is satisfied: SL/TL=0.39.

When an axial distance between the object-side surface of the first lens element E1 and the image-side surface of the third lens element E3 is Dr1r6, and an axial distance between the aperture stop ST and the image-side surface of the eighth lens element E8 is SD, the following condition is satisfied: Dr1r6/SD=1.65.

When a central thickness of the second lens element E2 is CT2, and a central thickness of the eighth lens element E8 is CT8, the following condition is satisfied: CT2/CT8=5.21.

When an axial distance between the second lens element E2 and the third lens element E3 is T23, an axial distance between the third lens element E3 and the fourth lens element E4 is T34, and an axial distance between the fourth lens element E4 and the fifth lens element E5 is T45, the following condition is satisfied: (T23+T45)/T34=0.12. In this embodiment, an axial distance between two adjacent lens elements is a distance in a paraxial region between two adjacent lens surfaces of the two adjacent lens elements.

When the central thickness of the second lens element E2 is CT2, a central thickness of the third lens element E3 is CT3, a central thickness of the fourth lens element E4 is CT4, a central thickness of the fifth lens element E5 is CT5, a central thickness of the sixth lens element E6 is CT6, a central thickness of the seventh lens element E7 is CT7, and the central thickness of the eighth lens element E8 is CT8, the following condition is satisfied:

$$( CT 2 + CT 3 ) / ( CT 4 + CT 5 + CT 6 + CT 7 + CT 8 ) = 1.4 .$$

When a curvature radius of the object-side surface of the first lens element E1 is R1, and a curvature radius of the image-side surface of the eighth lens element E8 is R16, the following condition is satisfied: R1/R16=0.02.

When a curvature radius of the image-side surface of the first lens element E1 is R2, and the curvature radius of the image-side surface of the eighth lens element E8 is R16, the following condition is satisfied: R2/R16=0.01.

When the curvature radius of the image-side surface of the first lens element E1 is R2, and a curvature radius of the object-side surface of the seventh lens element E7 is R13, the following condition is satisfied: R2/R13=0.96.

When a curvature radius of the object-side surface of the second lens element E2 is R3, and a curvature radius of the image-side surface of the second lens element E2 is R4, the following condition is satisfied: R3/R4=3.36.

When the curvature radius of the image-side surface of the second lens element E2 is R4, and a curvature radius of the object-side surface of the eighth lens element E8 is R15, the following condition is satisfied: R15/R4=0.54.

When a curvature radius of the object-side surface of the fourth lens element E4 is R7, and a curvature radius of the image-side surface of the fourth lens element E4 is R8, the following condition is satisfied: R7/R8=−0.60.

When the curvature radius of the object-side surface of the fourth lens element E4 is R7, and the curvature radius of the image-side surface of the fourth lens element E4 is R8, the following condition is satisfied: (R7+R8)/(R7−R8)=−0.25.

When the curvature radius of the object-side surface of the eighth lens element E8 is R15, and the curvature radius of the image-side surface of the eighth lens element E8 is R16, the following condition is satisfied: (R15+R16)/(R15−R16)=−0.99.

When an Abbe number of the third lens element E3 is V3, and a refractive index of the third lens element E3 is N3, the following condition is satisfied: V3/N3=37.23.

When a distance in parallel with the optical axis between a maximum effective radius position of the object-side surface of the first lens element E1 and a maximum effective radius position of the image-side surface of first lens element E1 is ET1, and a central thickness of the first lens element E1 is CT1, the following condition is satisfied: ET1/CT1=1.46.

When a distance in parallel with the optical axis between a maximum effective radius position of the object-side surface of the third lens element E3 and a maximum effective radius position of the image-side surface of third lens element E3 is ET3, and a distance in parallel with the optical axis between a maximum effective radius position of the object-side surface of the sixth lens element E6 and a maximum effective radius position of the image-side surface of sixth lens element E6 is ET6, the following condition is satisfied: ET3/ET6=3.76.

When a displacement in parallel with the optical axis from an axial vertex on the image-side surface of the first lens element E1 to a maximum effective radius position on the image-side surface of the first lens element E1 is SAG1R2, and the central thickness of the first lens element E1 is CT1, the following condition is satisfied: SAG1R2/CT1=2.00. In this embodiment, the direction of SAG1R2 is facing towards the image side of the capturing optical lens assembly, so the value of SAG1R2 is positive.

When a vertical distance between an off-axial critical point closest to the optical axis on the object-side surface of the seventh lens element E7 and the optical axis is Yc71, and a vertical distance between an inflection point closest to the optical axis on the object-side surface of the eighth lens element E8 and the optical axis is Yi81, the following condition is satisfied: Yc71/Yi81=0.85.

When the maximum image height of the capturing optical lens assembly is ImgH, a maximum effective radius of the object-side surface of the first lens element E1 is Y1R1, and a maximum effective radius of the object-side surface of the fourth lens element E4 is Y4R1, the following condition is satisfied: ImgH/Y4R1+Y1R1/Y4R1=11.19.

When the maximum effective radius of the object-side surface of the first lens element E1 is Y1R1, and a maximum effective radius of the image-side surface of the eighth lens element E8 is Y8R2, the following condition is satisfied: Y1R1/Y8R2=1.41.

When a maximum effective radius of the image-side surface of the fifth lens element E5 is Y5R2, a maximum effective radius of the object-side surface of the sixth lens element E6 is Y6R1, a maximum effective radius of the image-side surface of the sixth lens element E6 is Y6R2, and a maximum effective radius of the object-side surface of the seventh lens element E7 is Y7R1, the following condition is satisfied: Y7R1/Y6R2+Y6R1/Y5R2=2.84.

The detailed optical data of the 1st embodiment are shown in Table 1A and the aspheric surface data are shown in Table 1B below.

TABLE 1A
1st Embodiment
f = 3.71 mm, Fno = 2.75, HFOV = 80.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.3529 | (SPH) | 1.438 | Glass | 1.804 | 46.6 | −7.28 |
| 2 | | 3.7656 | (SPH) | 3.706 | | | | |
| 3 | Lens 2 | −26.8633 | (ASP) | 2.500 | Plastic | 1.587 | 28.3 | 18.46 |
| 4 | | −7.9898 | (ASP) | −0.300 | | | | |
| 5 | Stop | Plano | | 0.335 | | | | |
| 6 | Lens 3 | 19.3644 | (ASP) | 2.075 | Plastic | 1.515 | 56.4 | 14.77 |
| 7 | | −12.0855 | (ASP) | 0.856 | | | | |
| 8 | Ape. Stop | Plano | | −0.126 | | | | |
| 9 | Lens 4 | 3.7467 | (ASP) | 0.959 | Glass | 1.589 | 61.3 | 4.13 |
| 10 | | −6.2937 | (ASP) | −0.024 | | | | |
| 11 | Stop | Plano | | 0.080 | | | | |
| 12 | Lens 5 | −298.4475 | (ASP) | 0.370 | Plastic | 1.642 | 22.5 | −5.44 |
| 13 | | 3.5342 | (ASP) | 1.041 | | | | |
| 14 | Lens 6 | 7.6821 | (ASP) | 0.483 | Plastic | 1.511 | 56.8 | −37.25 |
| 15 | | 5.3563 | (ASP) | 0.486 | | | | |
| 16 | Lens 7 | 3.9055 | (ASP) | 0.973 | Plastic | 1.515 | 56.4 | 8.71 |
| 17 | | 27.4682 | (ASP) | 1.192 | | | | |
| 18 | Lens 8 | −4.3047 | (ASP) | 0.480 | Plastic | 1.614 | 26.0 | −6.97 |
| 19 | | 655.4657 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.117 | | | | |
| 22 | Image | Plano | — | | | | |

Note:
Reference wavelength is 587.6 nm (d-line).
An effective radius of the stop S1 (Surface 5) is 2.808 mm.
An effective radius of the stop S2 (Surface 11) is 1.338 mm.

TABLE 1B
Aspheric Coefficients

| Surface # | 3 | 4 | 6 | 7 |
|---|---|---|---|---|
| k = | 0.00000E+00 | 0.00000E+00 | 0.00000E+00 | 0.00000E+00 |
| A4 = | −2.54369114E−03 | 3.49193090E−03 | 3.05563258E−04 | −1.46944656E−02 |
| A6 = | 4.06282926E−05 | −6.53169243E−04 | −3.15170051E−04 | 2.36730098E−03 |
| A8 = | 2.37351930E−06 | 5.37586154E−05 | −4.30147283E−04 | 2.58679576E−04 |
| A10 = | −1.36639939E−06 | 1.64721500E−05 | 2.85588358E−04 | −4.91761183E−04 |
| A12 = | −6.97873344E−09 | −7.50266867E−06 | −1.07881362E−04 | 2.57181748E−04 |
| A14 = | 2.23213463E−08 | 1.59475212E−06 | 2.73131341E−05 | −8.20274801E−05 |
| A16 = | −1.46134756E−09 | −1.83305596E−07 | −4.54590482E−06 | 1.68620682E−05 |
| A18 = | 1.19195438E−11 | 9.63560811E−09 | 4.71702296E−07 | −2.15867217E−06 |
| A20 = | 6.73734002E−13 | 6.71282135E−12 | −2.74967352E−08 | 1.55528559E−07 |
| A22 = | — | −1.52371305E−11 | 6.83953532E−10 | −4.77558085E−09 |
| Surface # | 9 | 10 | 12 | 13 |
| k = | 0.00000E+00 | 0.00000E+00 | 0.00000E+00 | −1.20729E+01 |
| A4 = | −1.36654643E−02 | −4.73476291E−03 | −2.55933895E−02 | 9.90621100E−03 |
| A6 = | 2.65335914E−03 | 2.28052825E−03 | 2.43472158E−02 | −4.41266683E−04 |
| A8 = | −2.45274753E−03 | −2.94056170E−03 | −3.89039586E−02 | 4.61190936E−04 |
| A10 = | 1.41771667E−03 | 1.19416069E−03 | 5.79156332E−02 | −1.56603319E−03 |
| A12 = | −4.20210860E−04 | −3.67902780E−04 | −6.22489629E−02 | 1.43418909E−03 |
| A14 = | — | — | 4.36058878E−02 | −6.79681670E−04 |
| A16 = | — | — | −1.89522801E−02 | 1.64757000E−04 |
| A18 = | — | — | 4.62284986E−03 | −1.60402386E−05 |
| A20 = | — | — | −4.82915199E−04 | — |
| Surface # | 14 | 15 | 16 | 17 |
| k = | 0.00000E+00 | 0.00000E+00 | −8.56982E−01 | 0.00000E+00 |
| A4 = | −3.79341311E−02 | −7.23322304E−02 | −4.04166747E−02 | −3.80207254E−03 |
| A6 = | 3.62477081E−02 | 5.33389828E−02 | 2.18077451E−02 | 3.82605915E−03 |
| A8 = | −3.53056135E−02 | −3.81091100E−02 | −9.90875705E−03 | 1.22123226E−03 |
| A10 = | 2.63868135E−02 | 2.07042935E−02 | 2.89532165E−03 | −1.85583672E−03 |
| A12 = | −1.41376610E−02 | −8.07775410E−03 | −5.65717184E−04 | 7.76142742E−04 |
| A14 = | 5.32062990E−03 | 2.23701791E−03 | 7.54716843E−05 | −1.84295455E−04 |
| A16 - | −1.38781617E−03 | −4.36091048E−04 | −6.95483538E−06 | 2.85453027E−05 |
| A18 = | 2.45140680E−04 | 5.90274204E−05 | 4.44979650E−07 | −3.02271090E−06 |
| A20 = | −2.79673327E−05 | −5.40507073E−06 | −1.96338412E−08 | 2.20969775E−07 |
| A22 = | 1.86001797E−06 | 3.18321014E−07 | 5.79393746E−10 | −1.09707260E−08 |
| A24 = | −5.48031787E−08 | −1.08537608E−08 | −1.04865783E−11 | 3.52903349E−10 |
| A26 = | — | 1.62495369E−10 | 8.93786399E−14 | −6.62670088E−12 |
| A28 = | — | — | — | 5.50828368E−14 |

| Surface # | 18 | 19 |
|---|---|---|
| k = | −8.30453E−01 | 0.00000E+00 |
| A4 = | 1.02975763E−02 | 1.22341906E−02 |
| A6 = | −1.01637028E−02 | −1.17682374E−02 |
| A8 = | 7.00813516E−03 | 5.36372887E−03 |
| A10 = | −2.69764485E−03 | −1.53504467E−03 |
| A12 = | 6.26037647E−04 | 2.86021091E−04 |
| A14 = | −9.39758185E−05 | −3.60581813E−05 |
| A16 = | 9.53833927E−06 | 3.15369747E−06 |
| A18 = | −6.68950042E−07 | −1.93343974E−07 |
| A20 = | 3.25030588E−08 | 8.27481667E−09 |
| A22 = | −1.07515314E−09 | −2.41962326E−10 |
| A24 = | 2.31176022E−11 | 4.60378927E−12 |
| A26 = | −2.91458095E−13 | −5.13324283E−14 |
| A28 = | 1.63560059E−15 | 2.54337948E−16 |

In Table 1A, the curvature radius, the thickness and the focal length are shown in millimeters (mm). Surface numbers 0-22 represent the surfaces sequentially arranged from the object side to the image side along the optical axis. In Table 1B, k represents the conic coefficient of the equation of the aspheric surface profiles. A4-A28 represent the aspheric coefficients ranging from the 4th order to the 28th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

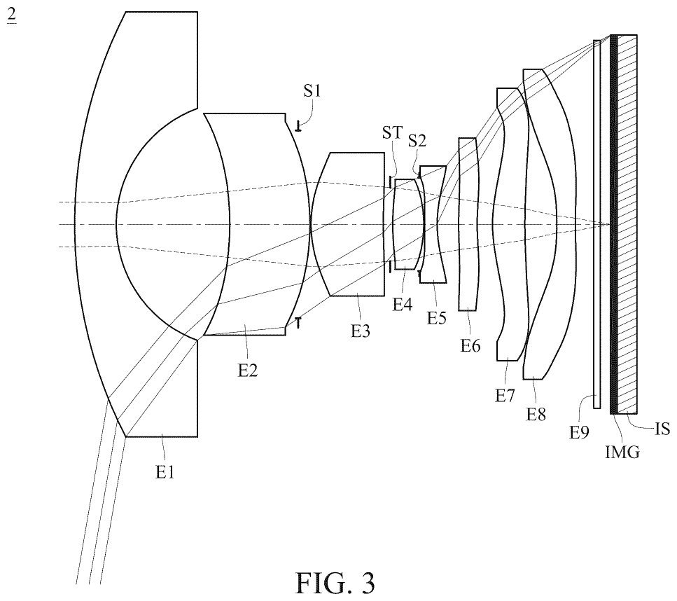

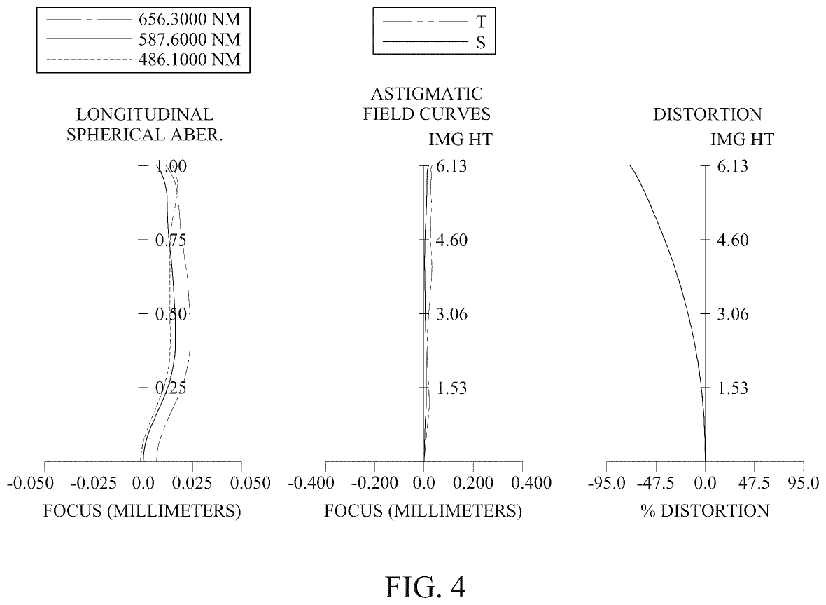

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has three inflection points. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 2nd embodiment are shown in Table 2A and the aspheric surface data are shown in Table 2B below.

TABLE 2A
2nd Embodiment
f = 3.86 mm, Fno = 2.65, HFOV = 80.2 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 15.1394 | (SPH) | 1.351 | Glass | 1.804 | 46.6 | −7.16 |
| 2 | | 4.0034 | (SPH) | 3.679 | | | | |
| 3 | Lens 2 | −9.5455 | (ASP) | 2.600 | Plastic | 1.614 | 25.6 | 46.92 |
| 4 | | −7.9113 | (ASP) | −0.385 | | | | |
| 5 | Stop | Plano | | 0.420 | | | | |
| 6 | Lens 3 | 3.7935 | (ASP) | 2.344 | Plastic | 1.544 | 56.0 | 8.65 |
| 7 | | 15.3154 | (ASP) | 0.224 | | | | |
| 8 | Ape. Stop | Plano | | 0.082 | | | | |
| 9 | Lens 4 | 7.3313 | (ASP) | 1.004 | Glass | 1.589 | 61.2 | 4.55 |
| 10 | | −4.0071 | (ASP) | −0.141 | | | | |
| 11 | Stop | Plano | | 0.176 | | | | |
| 12 | Lens 5 | 92.0513 | (ASP) | 0.400 | Plastic | 1.66 | 20.4 | −5.95 |
| 13 | | 3.7577 | (ASP) | 0.698 | | | | |
| 14 | Lens 6 | 11.9287 | (ASP) | 0.600 | Plastic | 1.544 | 56.0 | −28.10 |
| 15 | | 6.5815 | (ASP) | 0.498 | | | | |
| 16 | Lens 7 | 4.2067 | (ASP) | 1.049 | Plastic | 1.544 | 56.0 | 10.49 |
| 17 | | 14.5776 | (ASP) | 1.034 | | | | |
| 18 | Lens 8 | −12.3030 | (ASP) | 0.600 | Plastic | 1.639 | 23.5 | −9.10 |
| 19 | | 11.2120 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.332 | | | | |
| 22 | Image | Plano | — | | | | |

Note:
Reference wavelength is 587.6 nm (d-line).
An effective radius of the stop S1 (Surface 5) is 3.044 mm.
An effective radius of the stop S2 (Surface 11) is 1.518 mm.

TABLE 2B
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | −7.00873584E−04 | −1.28061004E−03 | −4.49796472E−03 | −1.10400579E−02 |
| A6= | −9.65818877E−05 | 4.58962002E−04 | 1.62256470E−03 | −9.24075429E−03 |
| A8= | 3.76416830E−05 | −1.24664435E−04 | −2.19493944E−03 | 2.85603023E−02 |
| A10= | −8.17468429E−06 | 1.72438079E−05 | 1.66406068E−03 | −4.53223696E−02 |
| A12= | 1.13687144E−06 | −9.18761860E−07 | −8.31435744E−04 | 4.59195302E−02 |
| A14= | −1.09315002E−07 | −7.51800053E−08 | 2.66232642E−04 | −2.89436540E−02 |
| A16= | 6.94361571E−09 | 1.64860671E−08 | −5.44614800E−05 | 1.07397633E−02 |
| A18= | −2.54539983E−10 | −1.17261860E−09 | 6.89392889E−06 | −1.92077043E−03 |
| A20= | 4.00901593E−12 | 3.74316243E−11 | −4.90870173E−07 | 1.45345552E−05 |
| A22= | — | −4.08036412E−13 | 1.49837854E−08 | 3.23441972E−05 |
| Surface # | 9 | 10 | 12 | 13 |
| k= | 0.00000E+00 | 0.00000E+00 | 0.00000E+00 | 0.00000E+00 |
| A4= | −1.40439467E−02 | 7.41417061E−03 | −1.72856865E−02 | −2.75754829E−02 |
| A6= | 5.89758590E−05 | −2.18876464E−02 | −1.36056092E−02 | 1.44856025E−02 |
| A8= | 1.72619114E−03 | 1.69629062E−02 | 1.74655563E−02 | −1.27517936E−02 |
| A10= | −5.95519089E−04 | −7.84568443E−03 | −2.25849601E−02 | 8.59333168E−03 |
| A12= | 2.08299212E−04 | 1.95683984E−03 | 2.21941300E−02 | −4.00608714E−03 |
| A14= | — | −1.99175700E−04 | −1.44154945E−02 | 1.21342877E−03 |
| A16= | — | — | 5.59443639E−03 | −2.25515188E−04 |
| A18= | — | — | −1.17334610E−03 | 2.31037898E−05 |
| A20= | — | — | 1.01308612E−04 | −9.87273136E−07 |
| Surface # | 14 | 15 | 16 | 17 |
| k= | 0.00000E+00 | 0.00000E+00 | 0.00000E+00 | 0.00000E+00 |
| A4= | −3.05664469E−02 | −5.11081755E−02 | −3.39248502E−02 | −1.50878518E−02 |
| A6= | 2.37926670E−02 | 3.04497399E−02 | 1.45212437E−02 | 6.11442873E−03 |
| A8= | −2.11578183E−02 | −1.79179620E−02 | −5.65606657E−03 | −1.25489998E−03 |
| A10= | 1.51428684E−02 | 7.94125945E−03 | 1.61676897E−03 | 6.11069357E−05 |
| A12= | −7.79023502E−03 | −2.44876527E−03 | −3.45566021E−04 | 3.18505400E−05 |
| A14= | 2.82245830E−03 | 5.04744016E−04 | 5.58280238E−05 | −8.97438136E−06 |
| A16= | −7.12555911E−04 | −6.38770127E−05 | −6.77993183E−06 | 1.22265225E−06 |
| A18= | 1.22565337E−04 | 3.45378571E−06 | 6.04498130E−07 | −1.03838929E−07 |
| A20= | −1.36866385E−05 | 2.61306664E−07 | −3.80058364E−08 | 5.82014385E−09 |
| A22= | 8.94213995E−07 | −5.98274709E−08 | 1.58040786E−09 | −2.15347518E−10 |
| A24= | −2.59407807E−08 | 4.12289281E−09 | −3.87140300E−11 | 5.04754384E−12 |
| A26= | — | −1.06040027E−10 | 4.20551089E−13 | −6.75158444E−14 |
| A28= | — | — | — | 3.88692412E−16 |

| Surface # | 18 | 19 |
|---|---|---|
| k= | 0.00000E+00 | 0.00000E+00 |
| A4= | −2.98468263E−02 | −2.64735080E−02 |
| A6= | 8.39673797E−03 | 7.56534990E−03 |
| A8= | −7.88098875E−04 | −1.60340911E−03 |
| A10= | −2.60462536E−04 | 2.35272874E−04 |
| A12= | 1.15014583E−04 | −2.50833243E−05 |
| A14= | −2.16191758E−05 | 2.11116890E−06 |
| A16= | 2.45597125E−06 | −1.48331519E−07 |
| A18= | −1.83390050E−07 | 8.49178210E−09 |
| A20= | 9.23078286E−09 | −3.67228852E−10 |
| A22= | −3.11056057E−10 | 1.10978574E−11 |
| A24= | 6.73853529E−12 | −2.16590938E−13 |
| A26= | −8.49279990E−14 | 2.42213997E−15 |
| A28= | 4.73575051E−16 | −1.16490081E−17 |

In the 2nd embodiment, the equation of the aspheric surface profiles of the aforementioned lens elements is the same as the equation of the 1st embodiment. Also, the definitions of these parameters shown in Table 2C are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Schematic Parameters

| | | | |
|---|---|---|---|
| f[mm] | 3.86 | R1/R16 | 1.35 |
| Fno | 2.65 | R2/R16 | 0.36 |
| HFOV [deg.] | 80.2 | R2/R13 | 0.95 |
| FOV [deg.] | 160.4 | R3/R4 | 1.21 |
| TL × Fno/ImgH | 7.52 | R15/R4 | 1.56 |
| 2 × ImgH/TD | 0.76 | R7/R8 | −1.83 |
| BL/f | 0.30 | (R7 + R8)/(R7 − R8) | 0.29 |
| f/f6 | −0.14 | (R15 + R16)/(R15 − R16) | 0.05 |
| f5/f8 | 0.65 | V3/N3 | 36.27 |
| f/f56 | −0.82 | ET1/CT1 | 1.72 |
| \|f/f2\| + \|f/f3\| | 0.53 | ET3/ET6 | 3.16 |
| f/f1 + f/f5 + f/f8 | −1.61 | SAG1R2/CT1 | 1.95 |
| SL/TL | 0.41 | Yc71/Yi81 | 1.25 |
| Dr1r6/SD | 1.67 | ImgH/Y4R1 + Y1R1/Y4R1 | 10.03 |
| CT2/CT8 | 4.33 | Y1R1/Y8R2 | 1.37 |
| (T23 + T45)/T34 | 0.23 | Y7R1/Y6R2 + Y6R1/Y5R2 | 2.63 |
| (CT2 + CT3)/(CT4 + | 1.35 | — | — |
| CT5 + CT6 + CT7 + CT8) | | | |

### 3rd Embodiment

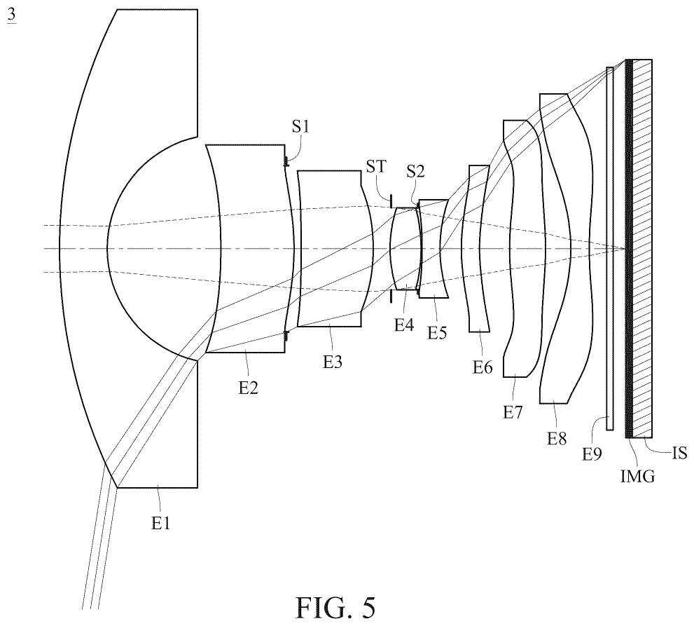

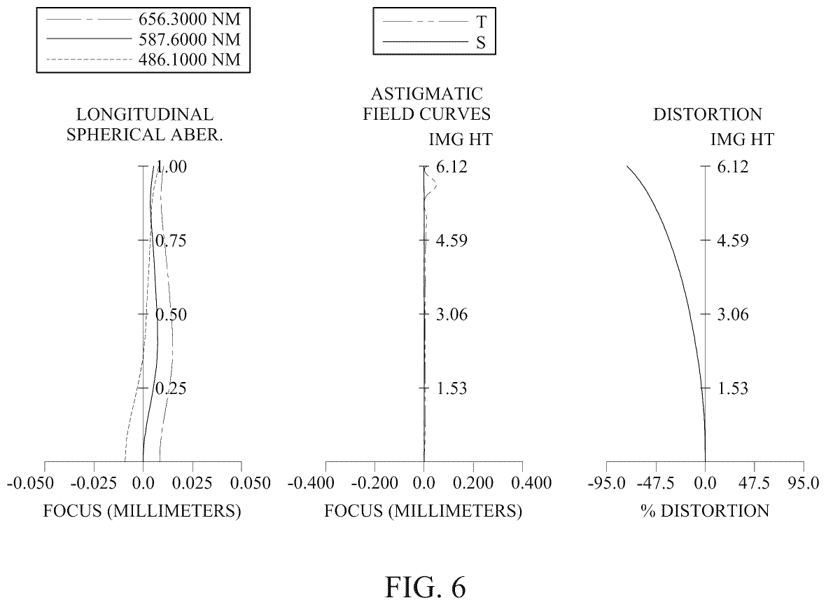

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has three inflection points. The object-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 3rd embodiment are shown in Table 3A and the aspheric surface data are shown in Table 3B below.

TABLE 3A
3rd Embodiment
f = 3.92 mm, Fno = 2.58, HFOV = 81.1 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 16.9893 | (SPH) | 1.545 | Glass | 1.589 | 61.3 | −8.43 |
| 2 | | 3.7129 | (SPH) | 3.683 | | | | |
| 3 | Lens 2 | −16.7058 | (ASP) | 2.373 | Plastic | 1.587 | 28.3 | 22.20 |
| 4 | | −7.7079 | (ASP) | −0.249 | | | | |
| 5 | Stop | Plano | | 0.482 | | | | |
| 6 | Lens 3 | −38.7603 | (ASP) | 2.333 | Plastic | 1.544 | 56.0 | 13.38 |
| 7 | | −6.2582 | (ASP) | 0.579 | | | | |
| 8 | Ape. Stop | Plano | | −0.034 | | | | |
| 9 | Lens 4 | 3.9326 | (ASP) | 1.004 | Plastic | 1.544 | 56.0 | 4.34 |
| 10 | | −5.3721 | (ASP) | −0.104 | | | | |
| 11 | Stop | Plano | | 0.139 | | | | |
| 12 | Lens 5 | −12.5102 | (ASP) | 0.580 | Plastic | 1.639 | 23.5 | −5.13 |
| 13 | | 4.5132 | (ASP) | 0.692 | | | | |
| 14 | Lens 6 | 5.7995 | (ASP) | 0.590 | Plastic | 1.544 | 56.0 | 112.40 |
| 15 | | 6.1775 | (ASP) | 0.974 | | | | |
| 16 | Lens 7 | 8.7372 | (ASP) | 1.163 | Plastic | 1.511 | 56.8 | 9.67 |
| 17 | | −10.8447 | (ASP) | 0.822 | | | | |
| 18 | Lens 8 | −5.0438 | (ASP) | 0.600 | Plastic | 1.566 | 37.4 | −6.55 |
| 19 | | 14.6046 | (ASP) | 0.560 | | | | |

| | | | | | | | |
|---|---|---|---|---|---|---|---|
| 20 | Filter | Plano | 0.210 | Glass | 1.517 | 64.2 | — |
| 21 | | Plano | 0.411 | | | | |
| 22 | Image | Plano | — | | | | |

Note:
Reference wavelength is 587.6 nm (d-line).
An effective radius of the stop S1 (Surface 5) is 2.694 mm.
An effective radius of the stop S2 (Surface 11) is 1.328 mm.

TABLE 3B
Aspheric Coefficients

| Surface # | 3 | 4 | 6 | 7 |
|---|---|---|---|---|
| k = | 0.00000E+00 | 0.00000E+00 | 0.00000E+00 | 0.00000E+00 |
| A4 = | −1.54418026E−03 | 5.15025369E−03 | 1.69750134E−03 | −8.18271804E−03 |
| A6 = | 7.72465693E−05 | −5.98865918E−04 | −9.95542142E−04 | 2.27455574E−03 |
| A8 = | −3.23069289E−06 | −3.95704625E−05 | 9.31628437E−05 | −6.63407873E−04 |
| A10 = | −1.47132493E−06 | 7.57785237E−05 | −1.81270763E−05 | 5.11209225E−04 |
| A12 = | 4.04994585E−07 | −3.00649642E−05 | 1.67587166E−05 | −4.42426835E−04 |
| A14 = | −5.27744670E−08 | 6.98246828E−06 | −7.32379344E−06 | 2.43505652E−04 |
| A16 = | 3.52499554E−09 | −9.81573274E−07 | 1.75669750E−06 | −8.12956686E−05 |
| A18 = | −8.89912319E−11 | 7.78806584E−08 | −2.39912847E−07 | 1.62132087E−05 |
| A20 = | −3.87159109E−13 | −2.66701281E−09 | 1.78391319E−08 | −1.78312499E−06 |
| A22 = | — | — | −5.72357497E−10 | 8.34388800E−08 |
| Surface # | 9 | 10 | 12 | 13 |
| k = | 0.00000E+00 | 0.00000E+00 | 0.00000E+00 | −8.09202E+00 |
| A4 = | −7.64893564E−03 | −3.57631798E−03 | −9.23421335E−03 | 2.64087174E−03 |
| A6 = | 2.48341110E−03 | 3.20858355E−05 | 4.98211947E−03 | 4.06137690E−03 |
| A8 = | −1.14934070E−03 | −9.47194385E−04 | −7.58390144E−03 | −3.39791027E−03 |
| A10 = | 4.61321167E−04 | 1.68506499E−03 | 9.57918129E−03 | 2.07730839E−03 |
| A12 = | −1.08161895E−04 | −9.08637120E−04 | −7.13380396E−03 | −8.38472278E−04 |
| A14 = | — | — | 3.15487681E−03 | 2.09507161E−04 |
| A16 = | — | — | −8.01495976E−04 | −2.99276480E−05 |
| A18 = | — | — | 9.07428262E−05 | 1.94908863E−06 |
| Surface # | 14 | 15 | 16 | 17 |
| k = | 0.00000E+00 | 0.00000E+00 | 0.00000E+00 | 0.00000E+00 |
| A4 = | −1.86633518E−02 | −2.12974796E−02 | −8.94756949E−03 | 7.39009742E−03 |
| A6 = | 8.44526099E−03 | 8.00200562E−03 | 1.84775499E−03 | 8.69649967E−05 |
| A8 = | −3.96260253E−03 | −2.68276581E−03 | −1.04075890E−03 | −1.19956980E−03 |
| A10 = | 1.60939966E−03 | 8.27618552E−04 | 5.07366127E−04 | 7.33822054E−04 |
| A12 = | −5.16509693E−04 | −2.19798440E−04 | −1.64054152E−04 | −2.33604893E−04 |
| A14 = | 1.18935133E−04 | 4.75057651E−05 | 3.36566543E−05 | 4.67421743E−05 |
| A16 = | −1.83528752E−05 | −7.97631724E−06 | −4.46483653E−06 | −6.37059146E−06 |
| A18 = | 1.68813299E−06 | 9.74524080E−07 | 3.82076633E−07 | 6.12379947E−07 |
| A20 = | −7.02841803E−08 | −8.00033904E−08 | −2.02960101E−08 | −4.17679878E−08 |
| A22 = | — | 3.90643627E−09 | 6.06930751E−10 | 1.98327658E−09 |
| A24 = | — | −8.52239618E−11 | −7.79489366E−12 | −6.23547238E−11 |
| A26 = | — | — | — | 1.16550114E−12 |
| A28 = | — | — | — | −9.78664824E−15 |

| Surface # | 18 | 19 |
|---|---|---|
| k = | −1.07372E+00 | 0.00000E+00 |
| A4 = | 1.47040447E−02 | 8.65799202E−03 |
| A6 = | −7.25288551E−03 | −8.02809923E−03 |
| A8 = | 1.81831741E−03 | 2.82929521E−03 |
| A10 = | −2.05785941E−04 | −6.59915314E−04 |
| A12 = | −2.12074828E−07 | 1.09375127E−04 |
| A14 = | 3.11739029E−06 | −1.31288744E−05 |
| A16 = | −4.23602647E−07 | 1.14383394E−06 |
| A18 = | 2.86128508E−08 | −7.19325590E−08 |
| A20 = | −1.04094230E−09 | 3.22024206E−09 |
| A22 = | 1.48425999E−11 | −9.98445713E−11 |
| A24 = | 2.61453361E−13 | 2.03463788E−12 |
| A26 = | −1.26214696E−14 | −2.44875997E−14 |
| A28 = | 1.34868123E−16 | 1.31805019E−16 |

In the 3rd embodiment, the equation of the aspheric surface profiles of the aforementioned lens elements is the same as the equation of the 1st embodiment. Also, the definitions of these parameters shown in Table 3C are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Schematic Parameters

| | | | |
|---|---|---|---|
| f[mm] | 3.92 | R1/R16 | 1.16 |
| Fno | 2.58 | R2/R16 | 0.25 |
| HFOV [deg.] | 81.1 | R2/R13 | 0.42 |
| FOV [deg.] | 162.2 | R3/R4 | 2.17 |
| TL × Fno/ImgH | 7.74 | R15/R4 | 0.65 |
| 2 × ImgH/TD | 0.71 | R7/R8 | −0.73 |
| BL/f | 0.30 | (R7 + R8)/(R7 − R8) | −0.15 |
| f/f6 | 0.03 | (R15 + R16)/(R15 − R16) | −0.49 |
| f5/f8 | 0.78 | V3/N3 | 36.27 |
| f/f56 | −0.75 | ET1/CT1 | 1.68 |
| \|f/f2\| + \|f/f3\| | 0.47 | ET3/ET6 | 3.09 |
| f/f1 + f/f5 + f/f8 | −1.83 | SAG1R2/CT1 | 1.89 |
| SL/TL | 0.41 | Yc71/Yi81 | 0.86 |
| Dr1r6/SD | 1.58 | ImgH/Y4R1 + Y1R1/Y4R1 | 10.20 |
| CT2/CT8 | 3.96 | Y1R1/Y8R2 | 1.55 |
| (T23 + T45)/T34 | 0.49 | Y7R1/Y6R2 + Y6R1/Y5R2 | 2.75 |
| (CT2 + CT3)/(CT4 + | 1.20 | — | — |
| CT5 + CT6 + CT7 + CT8) | | | |

### 4th Embodiment

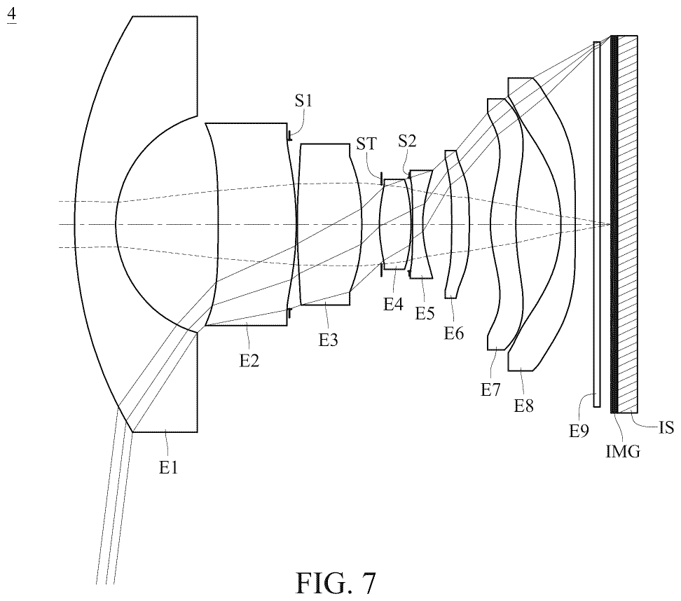

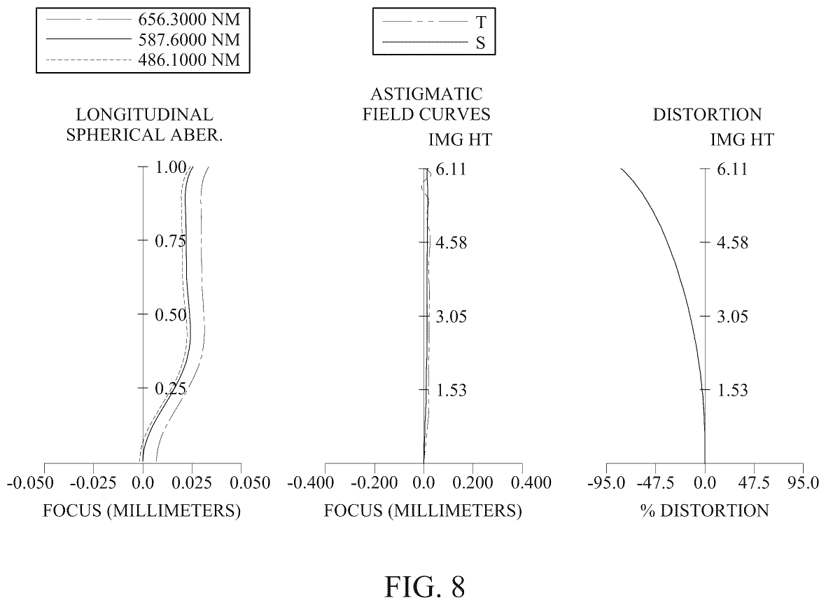

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric. The object-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of plastic material and has the object-side surface and the image-side surface being both aspheric. The image-side surface of the sixth lens element E6 has two inflection points.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being convex in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has four inflection points.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 4th embodiment are shown in Table 4A and the aspheric surface data are shown in Table 4B below.

TABLE 4A
4th Embodiment
f = 3.97 mm, Fno = 2.63, HFOV = 83.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.9939 | (SPH) | 1.334 | Glass | 1.804 | 46.6 | −6.76 |
| 2 | | 3.6578 | (SPH) | 3.318 | | | | |
| 3 | Lens 2 | −76.6526 | (ASP) | 2.530 | Plastic | 1.587 | 28.3 | 18.54 |
| 4 | | −9.6492 | (ASP) | −0.221 | | | | |
| 5 | Stop | Plano | | 0.256 | | | | |
| 6 | Lens 3 | 20.7924 | (ASP) | 2.088 | Plastic | 1.518 | 58.9 | 13.90 |
| 7 | | −10.6430 | (ASP) | 0.637 | | | | |
| 8 | Ape. Stop | Plano | | −0.065 | | | | |
| 9 | Lens 4 | 4.3314 | (ASP) | 1.025 | Glass | 1.589 | 61.3 | 4.32 |
| 10 | | −5.6254 | (ASP) | −0.053 | | | | |
| 11 | Stop | Plano | | 0.100 | | | | |
| 12 | Lens 5 | 129.5706 | (ASP) | 0.330 | Plastic | 1.639 | 23.3 | −5.56 |
| 13 | | 3.4555 | (ASP) | 0.939 | | | | |
| 14 | Lens 6 | −200.0000 | (ASP) | 0.571 | Plastic | 1.511 | 56.8 | 3319.25 |
| 15 | | −179.0727 | (ASP) | 0.685 | | | | |
| 16 | Lens 7 | 3.8626 | (ASP) | 0.823 | Plastic | 1.544 | 56.0 | 11.73 |
| 17 | | 9.0525 | (ASP) | 1.462 | | | | |
| 18 | Lens 8 | −4.3011 | (ASP) | 0.460 | Plastic | 1.615 | 25.4 | −7.92 |
| 19 | | −38.3810 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.354 | | | | |
| 22 | Image | Plano | — | | | | |

Note:
Reference wavelength is 587.6 nm (d-line).
An effective radius of the stop S1 (Surface 5) is 2.742 mm.
An effective radius of the stop S2 (Surface 11) is 1.514 mm.

TABLE 4B
Aspheric Coefficients

| Surface # | 3 | 4 | 6 | 7 |
|---|---|---|---|---|
| k = | 0.00000E+00 | 0.00000E+00 | 0.00000E+00 | 0.00000E+00 |
| A4 = | −2.78493056E−03 | 3.25566718E−03 | 1.49145345E−03 | −1.63006151E−02 |
| A6 = | −1.23105828E−04 | −1.74295898E−03 | −1.78868384E−03 | 3.09958613E−03 |
| A8 = | 6.59767931E−05 | 8.90069521E−04 | 6.75506424E−04 | 5.12966965E−04 |
| A10 = | −2.48092555E−05 | −3.34786795E−04 | −1.55627106E−04 | −8.68534558E−04 |
| A12 = | 5.83184456E−06 | 8.96750413E−05 | 4.78173891E−06 | 4.35892478E−04 |
| A14 = | −8.72056225E−07 | −1.69563163E−05 | 6.84265762E−06 | −1.24635816E−04 |
| A16 = | 7.93929381E−08 | 2.26599096E−06 | −1.70905843E−06 | 2.12031160E−05 |
| A18 = | −3.93929192E−09 | −2.03650028E−07 | 1.86294625E−07 | −1.98160819E−06 |
| A20 = | 8.09111573E−11 | 1.10359181E−08 | −9.70130897E−09 | 7.60609655E−08 |
| A22 = | — | −2.73584117E−10 | 1.85512382E−10 | 3.35895637E−10 |
| Surface # | 9 | 10 | 12 | 13 |
| k = | 0.00000E+00 | 0.00000E+00 | 0.00000E+00 | −1.43121E+01 |
| A4 = | −1.76517095E−02 | 2.02677205E−03 | −2.27135389E−02 | 1.20260091E−02 |
| A6 = | 3.19837937E−03 | −5.69077308E−03 | 1.62415204E−02 | −3.20747127E−03 |
| A8 = | −1.59831249E−03 | 2.57843043E−03 | −2.18140611E−02 | −3.62542219E−04 |
| A10 = | 7.42117643E−04 | −6.90049649E−04 | 2.42963592E−02 | 9.44457209E−04 |
| A12 = | −1.88368237E−04 | −1.06526638E−05 | −1.88699221E−02 | −6.01393837E−04 |
| A14 = | — | — | 9.48043398E−03 | 1.90671397E−04 |
| A16 = | — | — | −2.97525935E−03 | −3.18907687E−05 |
| A18 = | — | — | 5.26091894E−04 | 2.24267038E−06 |
| A20 = | — | — | −3.97688841E−05 | — |
| Surface # | 14 | 15 | 16 | 17 |
| k = | 0.00000E+00 | 0.00000E+00 | −7.98766E−01 | 0.00000E+00 |
| A4 = | −2.74086927E−02 | −4.44184455E−02 | −1.94529430E−02 | 5.69894031E−03 |
| A6 = | 1.58877794E−02 | 1.08914910E−02 | 1.01965601E−03 | −6.46938519E−03 |
| A8 = | −1.45363222E−02 | 3.22784002E−03 | 1.13741673E−03 | 3.54515489E−03 |
| A10 = | 1.26384040E−02 | −9.11178578E−03 | −8.89189920E−04 | −1.45984697E−03 |
| A12 = | −8.63546859E−03 | 8.23910863E−03 | 3.46958980E−04 | 4.23951101E−04 |
| A14 = | 4.30494808E−03 | −4.57694029E−03 | −8.66578078E−05 | −8.69446469E−05 |
| A16 = | −1.50206067E−03 | 1.71042809E−03 | 1.45916012E−05 | 1.26691230E−05 |
| A18 = | 3.56018460E−04 | −4.36823187E−04 | −1.66968826E−06 | −1.31339226E−06 |
| A20 = | −5.45840511E−05 | 7.51888232E−05 | 1.28275405E−07 | 9.60948201E−08 |
| A22 = | 4.88138225E−06 | −8.33370810E−06 | −6.40117382E−09 | −4.84707675E−09 |
| A24 = | −1.93722002E−07 | 5.35987819E−07 | 1.93754263E−10 | 1.60306792E−10 |
| A26 = | — | −1.51616012E−08 | −3.07005717E−12 | −3.12648349E−12 |
| A28 = | — | — | 1.70196998E−14 | 2.72292908E−14 |

| Surface # | 18 | 19 |
|---|---|---|
| k = | −7.08730E−01 | 0.00000E+00 |
| A4 = | 2.52099787E−02 | 2.57275788E−02 |
| A6 = | −2.56733387E−02 | −2.33350149E−02 |
| A8 = | 1.32332482E−02 | 1.01488003E−02 |
| A10 = | −4.46423254E−03 | −2.87398111E−03 |
| A12 = | 1.05277858E−03 | 5.60804218E−04 |
| A14 = | −1.76108656E−04 | −7.71702406E−05 |
| A16 = | 2.09579895E−05 | 7.56940882E−06 |
| A18 = | −1.77040274E−06 | −5.30009878E−07 |
| A20 = | 1.05117450E−07 | 2.62465390E−08 |
| A22 = | −4.28480398E−09 | −8.96801557E−10 |
| A24 = | 1.14181664E−10 | 2.00962793E−11 |
| A26 = | −1.79285125E−12 | −2.65659899E−13 |
| A28 = | 1.25943840E−14 | 1.56980599E−15 |

In the 4th embodiment, the equation of the aspheric surface profiles of the aforementioned lens elements is the same as the equation of the 1st embodiment. Also, the definitions of these parameters shown in Table 4C are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Schematic Parameters

| | | | |
|---|---|---|---|
| f[mm] | 3.97 | R1/R16 | −0.34 |
| Fno | 2.63 | R2/R16 | −0.10 |
| HFOV [deg.] | 83.0 | R2/R13 | 0.95 |
| FOV [deg.] | 166.0 | R3/R4 | 7.94 |
| TL × Fno/ImgH | 7.48 | R15/R4 | 0.45 |
| 2 × ImgH/TD | 0.75 | R7/R8 | −0.77 |
| BL/f | 0.29 | (R7 + R8)/(R7 − R8) | −0.13 |
| f/f6 | 0.0012 | (R15 + R16)/(R15 − R16) | −1.25 |
| f5/f8 | 0.70 | V3/N3 | 38.80 |
| f/f56 | −0.71 | ET1/CT1 | 1.57 |
| \|f/f2\| + \|f/f3\| | 0.50 | ET3/ET6 | 4.52 |
| f/f1 + f/f5 + f/f8 | −1.80 | SAG1R2/CT1 | 1.98 |
| SL/TL | 0.43 | Yc71/Yi81 | 0.77 |
| Dr1r6/SD | 1.48 | ImgH/Y4R1 + Y1R1/Y4R1 | 9.57 |
| CT2/CT8 | 5.50 | Y1R1/Y8R2 | 1.42 |
| (T23 + T45)/T34 | 0.14 | Y7R1/Y6R2 + Y6R1/Y5R2 | 2.73 |
| (CT2 + CT3)/(CT4 + | 1.44 | — | — |
| CT5 + CT6 + CT7 + | | | |
| CT8) | | | |

### 5th Embodiment

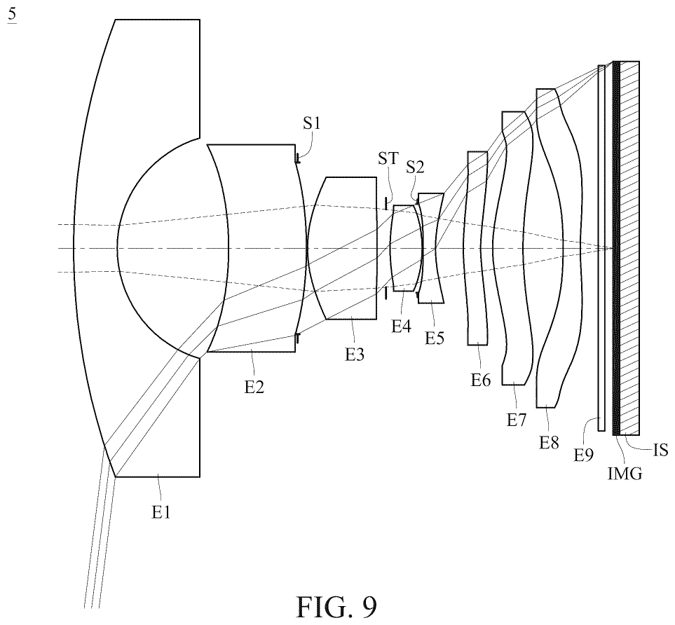

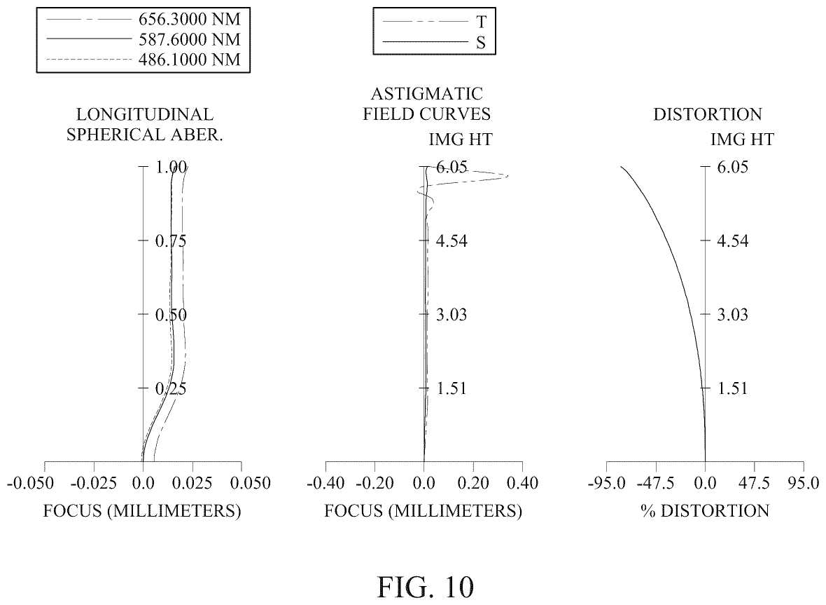

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has two inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 5th embodiment are shown in Table 5A and the aspheric surface data are shown in Table 5B below.

TABLE 5A
5th Embodiment
f = 4.08 mm, Fno = 2.66, HFOV = 82.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 20.9445 | (SPH) | 1.412 | Glass | 1.589 | 61.3 | −7.93 |
| 2 | | 3.7254 | (SPH) | 3.609 | | | | |
| 3 | Lens 2 | −9.7425 | (ASP) | 2.519 | Plastic | 1.544 | 56.0 | −149.83 |
| 4 | | −12.0730 | (ASP) | −0.289 | | | | |
| 5 | Stop | Plano | | 0.324 | | | | |
| 6 | Lens 3 | 3.9603 | (ASP) | 2.250 | Plastic | 1.544 | 56.0 | 7.39 |
| 7 | | 203.0390 | (ASP) | 0.292 | | | | |
| 8 | Ape. Stop | Plano | | 0.131 | | | | |
| 9 | Lens 4 | 5.5046 | (ASP) | 1.036 | Plastic | 1.544 | 56.0 | 4.33 |
| 10 | | −3.8483 | (ASP) | −0.149 | | | | |
| 11 | Stop | Plano | | 0.184 | | | | |
| 12 | Lens 5 | −25.1180 | (ASP) | 0.400 | Plastic | 1.639 | 23.5 | −5.30 |
| 13 | | 3.9389 | (ASP) | 0.902 | | | | |
| 14 | Lens 6 | 7.2777 | (ASP) | 0.560 | Plastic | 1.544 | 56.0 | −26.06 |
| 15 | | 4.6790 | (ASP) | 0.389 | | | | |
| 16 | Lens 7 | 4.1225 | (ASP) | 0.983 | Plastic | 1.544 | 56.0 | 12.44 |
| 17 | | 9.6564 | (ASP) | 1.296 | | | | |
| 18 | Lens 8 | −19.2010 | (ASP) | 0.560 | Plastic | 1.614 | 26.0 | −11.55 |
| 19 | | 11.3580 | (ASP) | 0.580 | | | | |

| | | | | | | | |
|---|---|---|---|---|---|---|---|
| 20 | Filter | Plano | 0.210 | Glass | 1.517 | 64.2 | — |
| 21 | | Plano | 0.269 | | | | |
| 22 | Image | Plano | — | | | | |

Note:
Reference wavelength is 587.6 nm (d-line).
An effective radius of the stop S1 (Surface 5) is 2.782 mm.
An effective radius of the stop S2 (Surface 11) is 1.442 mm.

TABLE 5B
Aspheric Coefficients

| Surface # | 3 | 4 | 6 | 7 |
|---|---|---|---|---|
| k = | 0.00000E+00 | 0.00000E+00 | 0.00000E+00 | 0.00000E+00 |
| A4 = | −4.47753271E−04 | −1.25424975E−03 | −4.16069280E−03 | −9.77961950E−03 |
| A6 = | −1.09277550E−04 | 1.10627274E−03 | 1.36991535E−03 | −5.60942520E−03 |
| A8 = | 4.21068843E−05 | −7.73599933E−04 | −1.48319329E−03 | 1.91978972E−02 |
| A10 = | −1.33352808E−05 | 3.45362642E−04 | 8.82761230E−04 | −2.86760041E−02 |
| A12 = | 2.72064535E−06 | −1.05004720E−04 | −3.75111265E−04 | 2.68737134E−02 |
| A14 = | −3.53407706E−07 | 2.16511823E−05 | 1.10443714E−04 | −1.59630909E−02 |
| A16 = | 2.78207646E−08 | −2.97052607E−06 | −2.20451652E−05 | 5.89769031E−03 |
| A18 = | −1.19503048E−09 | 2.59827503E−07 | 2.86010459E−06 | −1.26379527E−03 |
| A20 = | 2.13884898E−11 | −1.31108009E−08 | −2.16512714E−07 | 1.31724366E−04 |
| A22 = | — | 2.90305940E−10 | 7.24583173E−09 | −3.58431546E−06 |
| Surface # | 9 | 10 | 12 | 13 |
| k = | 0.00000E+00 | 0.00000E+00 | 0.00000E+00 | 0.00000E+00 |
| A4 = | −1.41926057E−02 | 2.95614908E−03 | −2.54816157E−02 | −2.98592586E−02 |
| A6 = | 1.30690915E−03 | −1.43887162E−02 | 3.23214464E−03 | 1.66028775E−02 |
| A8 = | −1.20969078E−04 | 1.15603272E−02 | −6.77236107E−03 | −1.29192660E−02 |
| A10 = | 3.39861239E−04 | −5.68708451E−03 | 1.05817684E−02 | 8.63827990E−03 |
| A12 = | −7.43948927E−05 | 1.61943450E−03 | −9.21361897E−03 | −4.28794616E−03 |
| A14 = | — | −2.17983712E−04 | 4.59519844E−03 | 1.43585778E−03 |
| A16 = | — | — | −1.34669146E−03 | −3.02793788E−04 |
| A18 = | — | — | 2.10961779E−04 | 3.59665996E−05 |
| A20 = | — | — | −1.38069199E−05 | −1.81496304E−06 |
| Surface # | 14 | 15 | 16 | 17 |
| k = | 0.00000E+00 | 0.00000E+00 | 0.00000E+00 | 0.00000E+00 |
| A4 = | −2.85113047E−02 | −5.56398045E−02 | −3.73174087E−02 | −1.02248953E−02 |
| A6 = | 1.99454901E−02 | 3.48702866E−02 | 1.71346894E−02 | 3.56720168E−03 |
| A8 = | −1.42298998E−02 | −1.96696400E−02 | −6.59094731E−03 | −8.05127366E−05 |
| A10 = | 7.96689889E−03 | 8.40342576E−03 | 1.78081006E−03 | −3.83724754E−04 |
| A12 = | −3.22775094E−03 | −2.60222806E−03 | −3.43567106E−04 | 1.51406649E−04 |
| A14 = | 9.21727841E−04 | 5.78134096E−04 | 4.83893977E−05 | −3.14497198E−05 |
| A16 = | −1.82877920E−04 | −9.17221303E−05 | −5.07655651E−06 | 4.19815588E−06 |
| A18 = | 2.46160271E−05 | 1.02706794E−05 | 3.98834218E−07 | −3.81866092E−07 |
| A20 = | −2.14084438E−06 | −7.90579015E−07 | −2.29592140E−08 | 2.40182067E−08 |
| A22 = | 1.08394592E−07 | 3.96902103E−08 | 9.10466644E−10 | −1.03085732E−09 |
| A24 = | −2.42428278E−09 | −1.16643933E−09 | −2.19552288E−11 | 2.88590753E−11 |
| A26 = | — | 1.51658476E−11 | 2.39459874E−13 | −4.75195534E−13 |
| A28 = | — | — | — | 3.48994604E−15 |

| Surface # | 18 | 19 |
|---|---|---|
| k = | 0.00000E+00 | 0.00000E+00 |
| A4 = | −1.11736551E−02 | −7.14351255E−03 |
| A6 = | −2.40065438E−03 | −3.43696004E−03 |
| A8 = | 2.68211397E−03 | 2.14653597E−03 |
| A10 = | −9.37761715E−04 | −6.17339332E−04 |
| A12 = | 1.94267704E−04 | 1.11049172E−04 |
| A14 = | −2.69326843E−05 | −1.35915372E−05 |
| A16 = | 2.60790881E−06 | 1.16978938E−06 |
| A18 = | −1.78568506E−07 | −7.15420952E−08 |
| A20 = | 8.59778565E−09 | 3.09144192E−09 |
| A22 = | −2.84421329E−10 | −9.21883821E−11 |
| A24 = | 6.14991917E−12 | 1.80320977E−12 |
| A26 = | −7.82317228E−14 | −2.07982279E−14 |
| A28 = | 4.43843952E−16 | 1.07111309E−16 |

In the 5th embodiment, the equation of the aspheric surface profiles of the aforementioned lens elements is the same as the equation of the 1st embodiment. Also, the definitions of these parameters shown in Table 5C are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Schematic Parameters

| | | | |
|---|---|---|---|
| f [mm] | 4.08 | R1/R16 | 1.84 |
| Fno | 2.66 | R2/R16 | 0.33 |
| HFOV [deg.] | 82.9 | R2/R13 | 0.90 |
| FOV [deg.] | 165.8 | R3/R4 | 0.81 |
| TL × Fno/ImgH | 7.68 | R15/R4 | 1.59 |
| 2 × ImgH/TD | 0.74 | R7/R8 | −1.43 |
| BL/f | 0.26 | (R7 + R8)/(R7 − R8) | 0.18 |
| f/f6 | −0.16 | (R15 + R16)/(R15 − R16) | 0.26 |
| f5/f8 | 0.46 | V3/N3 | 36.27 |
| f/f56 | −0.99 | ET1/CT1 | 1.93 |
| \|f/f2\| + \|f/f3\| | 0.58 | ET3/ET6 | 2.54 |
| f/f1 + f/f5 + f/f8 | −1.64 | SAG1R2/CT1 | 1.89 |
| SL/TL | 0.42 | Yc71/Yi81 | 1.40 |
| Dr1r6/SD | 1.56 | ImgH/Y4R1 + Y1R1/Y4R1 | 9.97 |
| CT2/CT8 | 4.50 | Y1R1/Y8R2 | 1.44 |
| (T23 + T45)/T34 | 0.17 | Y7R1/Y6R2 + Y6R1/Y5R2 | 2.74 |
| (CT2 + CT3)/(CT4 + | 1.35 | — | — |
| CT5 + CT6 + | | | |
| CT7 + CT8) | | | |

### 6th Embodiment

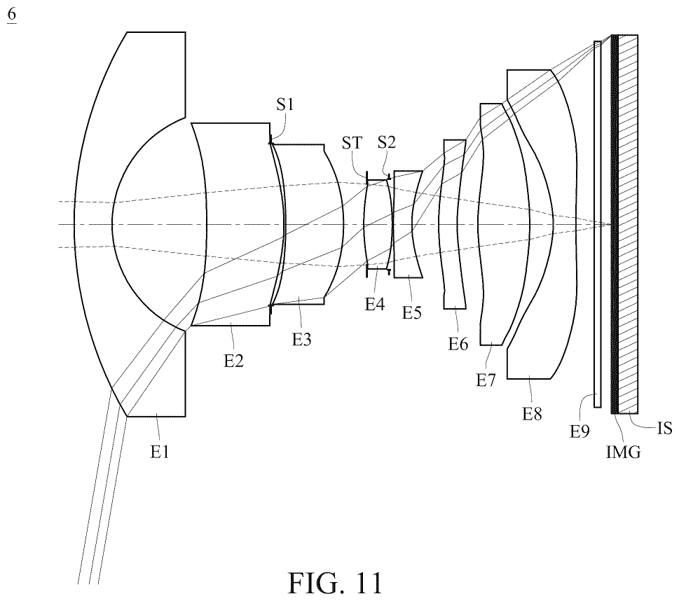

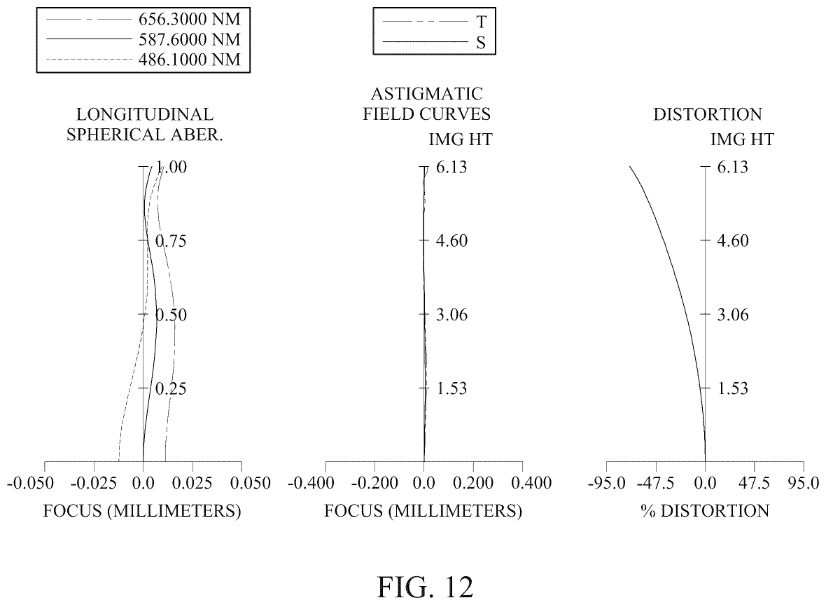

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has two inflection points.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has two critical points in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has one inflection point. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 6th embodiment are shown in Table 6A and the aspheric surface data are shown in Table 6B below.

TABLE 6A
6th Embodiment
f = 3.92 mm, Fno = 2.65, HFOV = 80.2 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.2121 | (SPH) | 1.226 | Glass | 1.804 | 46.6 | −7.10 |
| 2 | | 3.7165 | (SPH) | 3.067 | | | | |
| 3 | Lens 2 | −20.0642 | (ASP) | 2.500 | Plastic | 1.587 | 28.3 | 12.79 |
| 4 | | −5.7173 | (ASP) | −0.421 | | | | |
| 5 | Stop | Plano | | 0.481 | | | | |
| 6 | Lens 3 | −11.3528 | (ASP) | 1.871 | Plastic | 1.544 | 56.0 | 17.77 |
| 7 | | −5.5245 | (ASP) | 0.757 | | | | |
| 8 | Ape. Stop | Plano | | −0.101 | | | | |
| 9 | Lens 4 | 6.2193 | (ASP) | 0.922 | Glass | 1.589 | 61.2 | 5.60 |
| 10 | | −6.6309 | (ASP) | −0.105 | | | | |
| 11 | Stop | Plano | | 0.140 | | | | |
| 12 | Lens 5 | 11.8543 | (ASP) | 0.600 | Plastic | 1.669 | 19.5 | −7.65 |
| 13 | | 3.5030 | (ASP) | 0.868 | | | | |
| 14 | Lens 6 | 6.8942 | (ASP) | 0.600 | Plastic | 1.544 | 56.0 | −105.14 |
| 15 | | 5.9640 | (ASP) | 0.671 | | | | |
| 16 | Lens 7 | 6.6371 | (ASP) | 1.680 | Plastic | 1.544 | 56.0 | 6.95 |
| 17 | | −8.0141 | (ASP) | 0.758 | | | | |
| 18 | Lens 8 | −3.7774 | (ASP) | 0.736 | Plastic | 1.639 | 23.5 | −5.02 |
| 19 | | 22.8709 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.344 | | | | |
| 22 | Image | Plano | — | | | | |

Note:
Reference wavelength is 587.6 nm (d-line).
An effective radius of the stop S1 (Surface 5) is 2.624 mm.
An effective radius of the stop S2 (Surface 11) is 1.474 mm.

TABLE 6B
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | −3.22021650E−03 | 6.93599425E−03 | 1.91588097E−03 | −6.61251404E−03 |
| A6= | 1.79644129E−04 | −3.57120282E−04 | −1.64753839E−04 | 1.35374056E−03 |
| A8= | −1.89660267E−05 | −7.30981569E−04 | −1.25123143E−03 | −2.66035406E−04 |
| A10= | 2.32564714E−06 | 4.63462300E−04 | 7.09542678E−04 | 6.45633714E−05 |
| A12= | −8.14619473E−08 | −1.50625165E−04 | −2.16293182E−04 | −2.43095737E−05 |
| A14= | −2.79119767E−08 | 3.04579253E−05 | 4.04826570E−05 | 8.84131233E−06 |
| A16= | 4.97865435E−09 | −3.84376065E−06 | −4.56570971E−06 | −2.18170716E−06 |
| A18= | −3.18572751E−10 | 2.79689340E−07 | 2.76592796E−07 | 3.28244726E−07 |
| A20= | 7.02829613E−12 | −9.01791178E−09 | −5.69701248E−09 | −2.72433557E−08 |
| A22= | — | — | −1.18521952E−10 | 9.61605323E−10 |
| Surface # | 9 | 10 | 12 | 13 |
| k= | 0.00000E+00 | 0.00000E+00 | 0.00000E+00 | −8.81647E+00 |
| A4= | −5.55517176E−03 | −8.26441732E−03 | −1.70517373E−02 | 9.38127079E−03 |
| A6= | 8.96088159E−04 | 2.40004972E−03 | 3.75860217E−03 | −4.60388360E−03 |
| A8= | −4.69324676E−04 | −2.00178898E−03 | −2.72258411E−03 | 1.67172721E−03 |
| A10= | 1.60215652E−04 | 1.30184805E−03 | 2.97664388E−03 | −1.14491194E−04 |
| A12= | −6.06607518E−05 | −5.50917098E−04 | −2.12161094E−03 | −2.34875326E−04 |
| A14= | — | 8.21487460E−05 | 8.68188428E−04 | 1.21311275E−04 |
| A16= | — | — | −1.99661355E−04 | −2.70556813E−05 |
| A18= | — | — | 2.05480342E−05 | 2.44840166E−06 |
| Surface # | 14 | 15 | 16 | 17 |
| k= | 0.00000E+00 | 0.00000E+00 | 0.00000E+00 | 0.00000E+00 |
| A4= | −1.63032563E−02 | −2.54869922E−02 | −1.25787757E−02 | 5.31719913E−03 |
| A6= | 8.11250463E−03 | 1.10996999E−02 | 2.75714609E−03 | 5.10035634E−05 |
| A8= | −4.43703376E−03 | −5.30447352E−03 | −9.78798567E−04 | 2.17183179E−04 |
| A10= | 2.01829891E−03 | 2.35413973E−03 | 2.38986274E−04 | −2.88911874E−04 |
| A12= | −7.12718295E−04 | −8.40326152E−04 | −3.87513282E−05 | 9.12393051E−05 |
| A14= | 1.80686263E−04 | 2.22746208E−04 | 4.37978714E−06 | −1.38805756E−05 |
| A16= | −3.04508249E−05 | −4.19232209E−05 | −4.30340526E−07 | 1.04056937E−06 |
| A18= | 3.01446584E−06 | 5.40748440E−06 | 4.27683491E−08 | −1.05007845E−08 |
| A20= | −1.33194096E−07 | −4.54410281E−07 | −3.29362944E−09 | −4.98175877E−09 |
| A22= | — | 2.24175932E−08 | 1.44248905E−10 | 4.46041464E−10 |
| A24= | — | −4.92054049E−10 | −2.59377019E−12 | −1.75504344E−11 |
| A26= | — | — | — | 3.21041081E−13 |
| A28= | — | — | — | −1.94590724E−15 |

| Surface # | 18 | 19 |
|---|---|---|
| k= | −1.00000E+00 | 0.00000E+00 |
| A4= | 2.00968608E−03 | −1.11274217E−02 |
| A6= | 6.62076524E−03 | 5.61735422E−03 |
| A8= | −4.15043839E−03 | −1.87523136E−03 |
| A10= | 1.56441584E−03 | 3.84479725E−04 |
| A12= | −4.56754435E−04 | −5.37875450E−05 |
| A14= | 9.99810505E−05 | 5.37693195E−06 |
| A16= | −1.56097914E−05 | −3.87620189E−07 |
| A18= | 1.70797361E−06 | 1.99055833E−08 |
| A20= | −1.29641401E−07 | −7.06061947E−10 |
| A22= | 6.68041417E−09 | 1.63039794E−11 |
| A24= | −2.22786527E−10 | −2.16580031E−13 |
| A26= | 4.33402143E−12 | 1.14980681E−15 |
| A28= | −3.73175890E−14 | 2.17363155E−18 |

In the 6th embodiment, the equation of the aspheric surface profiles of the aforementioned lens elements is the same as the equation of the 1st embodiment. Also, the definitions of these parameters shown in Table 6C are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Schematic Parameters

| | | | |
|---|---|---|---|
| f [mm] | 3.92 | R1/R16 | 0.53 |
| Fno | 2.65 | R2/R16 | 0.16 |
| HFOV [deg.] | 80.2 | R2/R13 | 0.56 |
| FOV [deg.] | 160.4 | R3/R4 | 3.51 |
| TL × Fno/ImgH | 7.53 | R15/R4 | 0.66 |
| 2 × ImgH/TD | 0.75 | R7/R8 | −0.94 |
| BL/f | 0.29 | (R7 + R8)/(R7 − R8) | −0.03 |
| f/f6 | −0.04 | (R15 + R16)/(R15 − R16) | −0.72 |
| f5/f8 | 1.52 | V3/N3 | 36.27 |
| f/f56 | −0.57 | ET1/CT1 | 1.54 |
| \|f/f2\| + \|f/f3\| | 0.53 | ET3/ET6 | 2.34 |
| f/f1 + f/f5 + f/f8 | −1.84 | SAG1R2/CT1 | 1.94 |
| SL/TL | 0.46 | Yc71/Yi81 | 0.87 |
| Dr1r6/SD | 1.29 | ImgH/Y4R1 + Y1R1/Y4R1 | 9.35 |
| CT2/CT8 | 3.40 | Y1R1/Y8R2 | 1.24 |
| (T23 + T45)/T34 | 0.14 | Y7R1/Y6R2 + Y6R1/Y5R2 | 2.60 |
| (CT2 + CT3)/(CT4 + | 0.96 | — | — |
| CT5 + CT6 + | | | |
| CT7 + CT8) | | | |

### 7th Embodiment

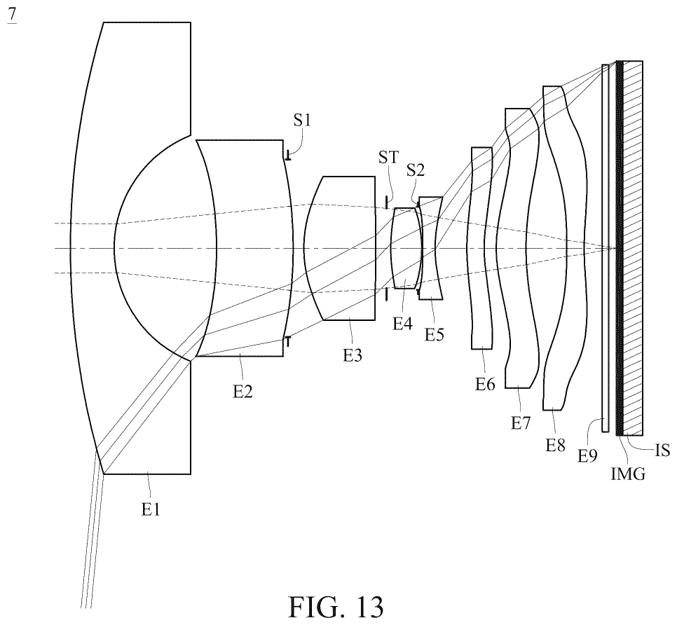

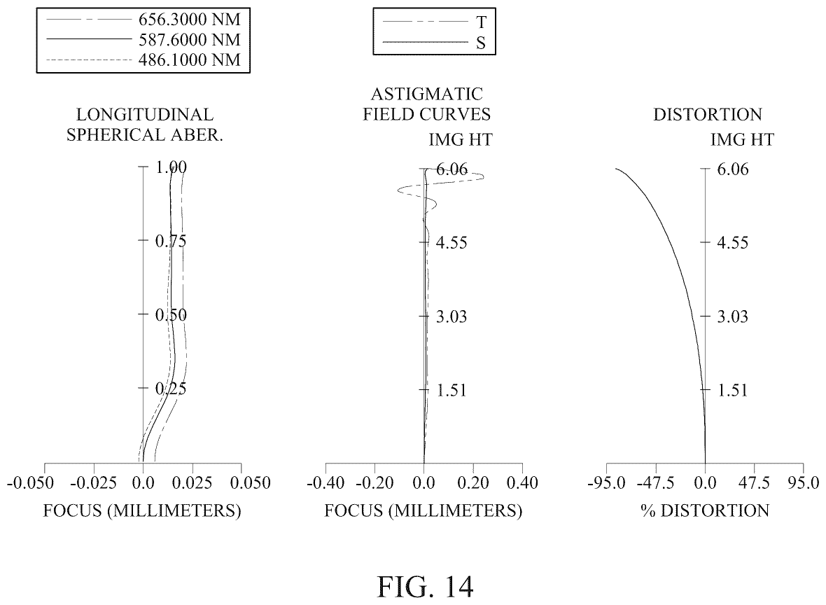

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has two inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 7th embodiment are shown in Table 7A and the aspheric surface data are shown in Table 7B below.

TABLE 7A
7th Embodiment
f = 4.27 mm, Fno = 2.65, HFOV = 84.6 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 25.3142 | (SPH) | 1.418 | Glass | 1.589 | 61.3 | −8.13 |
| 2 | | 3.9446 | (SPH) | 3.319 | | | | |
| 3 | Lens 2 | −11.6809 | (ASP) | 2.480 | Plastic | 1.544 | 56.0 | −154.38 |
| 4 | | −14.5829 | (ASP) | −0.169 | | | | |
| 5 | Stop | Plano | | 0.516 | | | | |
| 6 | Lens 3 | 3.9745 | (ASP) | 2.327 | Plastic | 1.534 | 56.0 | 7.58 |
| 7 | | 165.3962 | (ASP) | 0.348 | | | | |
| 8 | Ape. Stop | Plano | | 0.138 | | | | |
| 9 | Lens 4 | 5.1901 | (ASP) | 1.002 | Plastic | 1.544 | 56.0 | 4.39 |
| 10 | | −4.1275 | (ASP) | −0.121 | | | | |
| 11 | Stop | Plano | | 0.156 | | | | |
| 12 | Lens 5 | −30.7989 | (ASP) | 0.400 | Plastic | 1.639 | 23.5 | −5.53 |
| 13 | | 4.0101 | (ASP) | 1.029 | | | | |
| 14 | Lens 6 | 6.6779 | (ASP) | 0.560 | Plastic | 1.544 | 56.0 | −24.90 |
| 15 | | 4.3407 | (ASP) | 0.390 | | | | |
| 16 | Lens 7 | 4.0954 | (ASP) | 0.966 | Plastic | 1.544 | 56.0 | 13.64 |
| 17 | | 8.3807 | (ASP) | 1.318 | | | | |
| 18 | Lens 8 | −29.2743 | (ASP) | 0.566 | Plastic | 1.614 | 25.6 | −12.40 |
| 19 | | 10.3533 | (ASP) | 0.580 | | | | |

| | | | | | | | |
|---|---|---|---|---|---|---|---|
| 20 | Filter | Plano | 0.210 | Glass | 1.517 | 64.2 | — |
| 21 | | Plano | 0.248 | | | | |
| 22 | Image | Plano | — | | | | |

Note:
Reference wavelength is 587.6 nm (d-line).
An effective radius of the stop S1 (Surface 5) is 2.879 mm.
An effective radius of the stop S2 (Surface 11) is 1.349 mm.

TABLE 7B
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | −4.59244266E−04 | −1.10774625E−03 | −4.08012790E−03 | −9.30493579E−03 |
| A6= | −9.47745399E−05 | 4.75832961E−04 | 8.24260379E−04 | −4.43951722E−03 |
| A8= | 3.60643698E−05 | −1.92321770E−04 | −9.71872086E−04 | 1.47662118E−02 |
| A10= | −1.16641157E−05 | 6.25068605E−05 | 6.75648775E−04 | −2.08173328E−02 |
| A12= | 2.33163522E−06 | −1.58404007E−05 | −3.29917689E−04 | 1.85803993E−02 |
| A14= | −2.87300341E−07 | 2.92942490E−06 | 1.08346478E−04 | −1.05885349E−02 |
| A16= | 2.09175889E−08 | −3.78930556E−07 | −2.34828417E−05 | 3.78928240E−03 |
| A18= | −8.12590804E−10 | 3.26170009E−08 | 3.22755058E−06 | −8.00869472E−04 |
| A20= | 1.27972332E−11 | −1.67075559E−09 | −2.53799837E−07 | 8.63367496E−05 |
| A22= | — | 3.80991014E−11 | 8.67641075E−09 | −3.07643560E−06 |
| Surface # | 9 | 10 | 12 | 13 |
| k= | 0.00000E+00 | 0.00000E+00 | 0.00000E+00 | 0.00000E+00 |
| A4= | −1.25376121E−02 | 1.99106626E−03 | −2.56080367E−02 | −2.85594872E−02 |
| A6= | 1.17325539E−03 | −1.21363869E−02 | 5.42320710E−03 | 1.50166616E−02 |
| A8= | −1.55321257E−04 | 9.34493955E−03 | −1.16950253E−02 | −1.10922535E−02 |
| A10= | 3.53513274E−04 | −4.30891797E−03 | 1.94196455E−02 | 7.06347499E−03 |
| A12= | −6.74270858E−05 | 1.20516590E−03 | −1.97894621E−02 | −3.30552564E−03 |
| A14= | — | −1.67623003E−04 | 1.27108369E−02 | 1.02679974E−03 |
| A16= | — | — | −5.10835953E−03 | −1.96808546E−04 |
| A18= | — | — | 1.16499852E−03 | 2.05496148E−05 |
| A20= | — | — | −1.15300430E−04 | −8.54987351E−07 |
| Surface # | 14 | 15 | 16 | 17 |
| k= | 0.00000E+00 | 0.00000E+00 | 0.00000E+00 | 0.00000E+00 |
| A4= | −2.66444298E−02 | −5.18160959E−02 | −3.25442070E−02 | −6.90571571E−03 |
| A6= | 1.58959220E−02 | 2.86322370E−02 | 1.29139385E−02 | 2.22275594E−03 |
| A8= | −9.87184527E−03 | −1.47963031E−02 | −4.54031623E−03 | 1.18095467E−04 |
| A10= | 5.00837552E−03 | 6.02314345E−03 | 1.09809919E−03 | −3.78134387E−04 |
| A12= | −1.90306015E−03 | −1.82378053E−03 | −1.77223280E−04 | 1.45641277E−04 |
| A14= | 5.18152232E−04 | 4.00881747E−04 | 1.79924308E−05 | −3.09040910E−05 |
| A16= | −9.86866324E−05 | −6.32089390E−05 | −9.43643088E−07 | 4.24706273E−06 |
| A18= | 1.27745742E−05 | 7.04012069E−06 | −7.33386495E−09 | −3.97383997E−07 |
| A20= | −1.06711305E−06 | −5.38478049E−07 | 4.68354974E−09 | 2.56032785E−08 |
| A22= | 5.17295858E−08 | 2.68237245E−08 | −3.13079914E−10 | −1.11928529E−09 |
| A24= | −1.10289100E−09 | −7.81670143E−10 | 9.52756307E−12 | 3.17172060E−11 |
| A26= | — | 1.00901847E−11 | −1.16489238E−13 | −5.25349204E−13 |
| A28= | — | — | — | 3.85861495E−15 |

| Surface # | 18 | 19 |
|---|---|---|
| k= | 0.00000E+00 | 0.00000E+00 |
| A4= | −5.51379212E−03 | −8.42200054E−04 |
| A6= | −5.99450157E−03 | −7.85033507E−03 |
| A8= | 4.30283827E−03 | 3.95367393E−03 |
| A10= | −1.45346072E−03 | −1.09099667E−03 |
| A12= | 3.05741232E−04 | 1.93907259E−04 |
| A14= | −4.32969895E−05 | −2.35786322E−05 |
| A16= | 4.25790563E−06 | 2.01681857E−06 |
| A18= | −2.93812349E−07 | −1.22548445E−07 |
| A20= | 1.41625121E−08 | 5.26168596E−09 |
| A22= | −4.66744790E−10 | −1.55977683E−10 |
| A24= | 1.00201148E−11 | 3.03516208E−12 |
| A26= | −1.26260912E−13 | −3.48582596E−14 |
| A28= | 7.08458973E−16 | 1.78927009E−16 |

In the 7th embodiment, the equation of the aspheric surface profiles of the aforementioned lens elements is the same as the equation of the 1st embodiment. Also, the definitions of these parameters shown in Table 7C are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Schematic Parameters

| | | | |
|---|---|---|---|
| f [mm] | 4.27 | R1/R16 | 2.45 |
| Fno | 2.65 | R2/R16 | 0.38 |
| HFOV [deg.] | 84.6 | R2/R13 | 0.96 |
| FOV [deg.] | 169.2 | R3/R4 | 0.80 |
| TL × Fno/ImgH | 7.73 | R15/R4 | 2.01 |
| 2 × ImgH/TD | 0.73 | R7/R8 | −1.26 |
| BL/f | 0.24 | (R7 + R8)/(R7 − R8) | 0.11 |
| f/f6 | −0.17 | (R15 + R16)/(R15 − R16) | 0.48 |
| f5/f8 | 0.45 | V3/N3 | 36.51 |
| f/f56 | −1.01 | ET1/CT1 | 1.98 |
| \|f/f2\| + \|f/f3\| | 0.59 | ET3/ET6 | 2.55 |
| f/f1 + f/f5 + f/f8 | −1.64 | SAG1R2/CT1 | 1.75 |
| SL/TL | 0.42 | Yc71/Yi81 | 0.98 |
| Dr1r6/SD | 1.54 | ImgH/Y4R1 + Y1R1/Y4R1 | 9.98 |
| CT2/CT8 | 4.38 | Y1R1/Y8R2 | 1.40 |
| (T23 + T45)/T34 | 0.79 | Y7R1/Y6R2 + Y6R1/Y5R2 | 2.89 |
| (CT2 + CT3)/(CT4 + | 1.38 | — | — |
| CT5 + CT6 + | | | |
| CT7 + CT8) | | | |

### 8th Embodiment

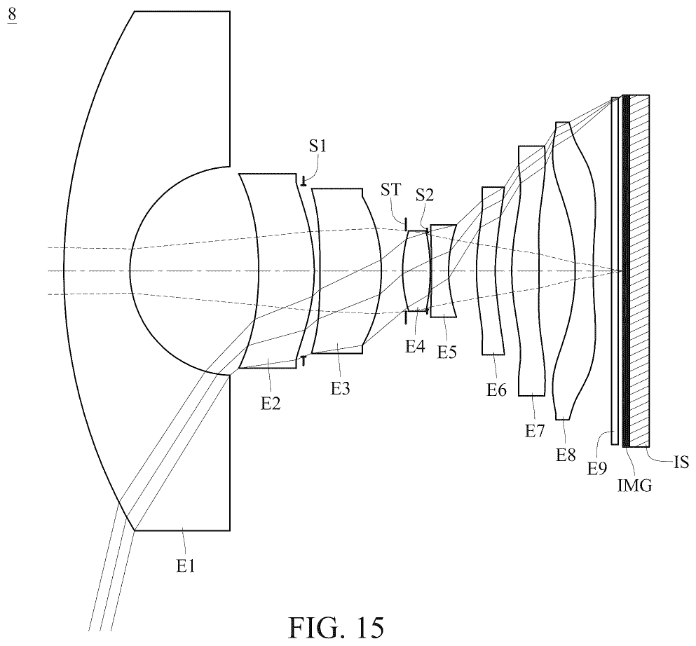

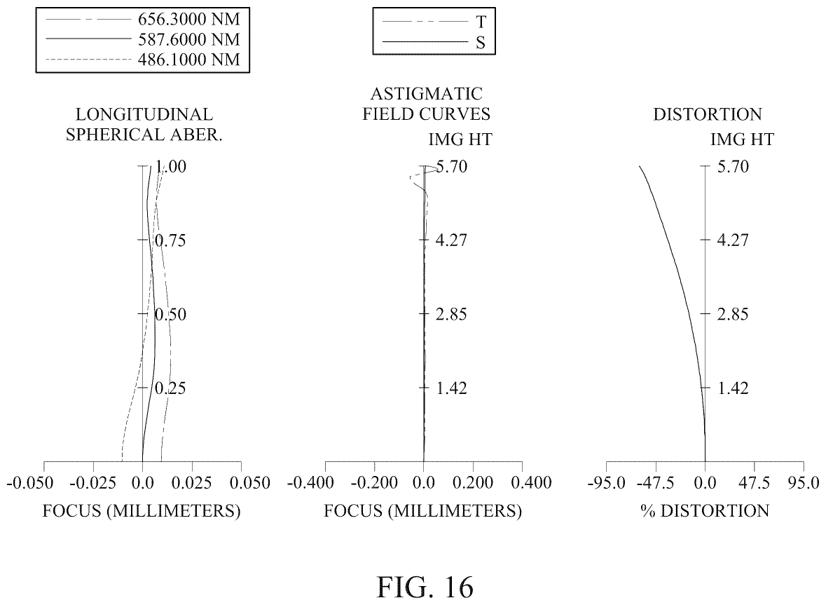

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has two critical points in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has one critical point in an off-axis region thereof. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 8th embodiment are shown in Table 8A and the aspheric surface data are shown in Table 8B below.

TABLE 8A
8th Embodiment
f = 3.65 mm, Fno = 2.42, HFOV = 76.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 16.6128 | (SPH) | 2.140 | Plastic | 1.544 | 55.9 | −8.30 |
| 2 | | 3.3857 | (SPH) | 4.171 | | | | |
| 3 | Lens 2 | −10.4677 | (ASP) | 1.800 | Plastic | 1.587 | 28.3 | 16.28 |
| 4 | | −5.3145 | (ASP) | −0.349 | | | | |
| 5 | Stop | Plano | | 0.540 | | | | |
| 6 | Lens 3 | −19.7505 | (ASP) | 1.980 | Plastic | 1.544 | 56.0 | 14.63 |
| 7 | | −5.8725 | (ASP) | 0.793 | | | | |
| 8 | Ape. Stop | Plano | | −0.102 | | | | |
| 9 | Lens 4 | 4.2532 | (ASP) | 0.893 | Plastic | 1.544 | 56.0 | 4.91 |
| 10 | | −6.6420 | (ASP) | −0.104 | | | | |
| 11 | Stop | Plano | | 0.139 | | | | |
| 12 | Lens 5 | 74.5071 | (ASP) | 0.560 | Plastic | 1.669 | 19.5 | −6.26 |
| 13 | | 3.9554 | (ASP) | 0.902 | | | | |
| 14 | Lens 6 | 6.3311 | (ASP) | 0.610 | Plastic | 1.544 | 56.0 | −127.71 |
| 15 | | 5.6054 | (ASP) | 0.533 | | | | |
| 16 | Lens 7 | 6.6839 | (ASP) | 0.886 | Plastic | 1.544 | 55.9 | 9.78 |
| 17 | | −24.6901 | (ASP) | 1.170 | | | | |
| 18 | Lens 8 | −5.9723 | (ASP) | 0.580 | Plastic | 1.584 | 28.2 | −7.43 |
| 19 | | 16.4518 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.152 | | | | |
| 22 | Image | Plano | — | | | | |

Note:
Reference wavelength is 587.6 nm (d-line).
An effective radius of the stop S1 (Surface 5) is 2.779 mm.
An effective radius of the stop S2 (Surface 11) is 1.252 mm.

TABLE 8B
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | −2.53204504E−03 | 8.23356839E−03 | 4.49290849E−03 | −6.12780162E−03 |
| A6= | 1.58751534E−04 | −2.44258654E−03 | −3.40269660E−03 | 7.55062293E−04 |
| A8= | −9.90288475E−06 | 7.13456684E−04 | 1.13576890E−03 | 1.83514731E−05 |
| A10= | −1.57267311E−06 | −1.64462471E−04 | −3.98311915E−04 | −1.53358619E−06 |
| A12= | 7.09297972E−07 | 2.87076262E−05 | 1.25610393E−04 | −2.66756774E−05 |
| A14= | −1.25148614E−07 | −3.38328701E−06 | −2.95987611E−05 | 1.60080168E−05 |
| A16= | 1.23669015E−08 | 2.39842694E−07 | 4.79388238E−06 | −4.54820126E−06 |
| A18= | −5.90161874E−10 | −7.80528258E−09 | −4.96259980E−07 | 7.20338875E−07 |
| A20= | 8.34931944E−12 | 2.28732817E−11 | 2.93679417E−08 | −6.13034457E−08 |
| A22= | — | — | −7.52506837E−10 | 2.19945643E−09 |
| Surface # | 9 | 10 | 12 | 13 |
| k= | 0.00000E+00 | 0.00000E+00 | 0.00000E+00 | −8.84286E+00 |
| A4= | −3.53145945E−03 | −9.45687351E−03 | −2.16848308E−02 | 1.59190449E−03 |
| A6= | 8.39916629E−04 | 8.69565785E−03 | 1.46754136E−02 | 2.72871398E−03 |
| A8= | −1.07607592E−03 | −9.43708242E−03 | −1.49698551E−02 | −4.76925753E−04 |
| A10= | 6.00321441E−04 | 6.24888565E−03 | 1.48461130E−02 | −6.18566439E−04 |
| A12= | −1.74955321E−04 | −2.27418122E−03 | −1.08327501E−02 | 7.19215658E−04 |
| A14= | — | 3.10186770E−04 | 5.28825859E−03 | −3.38999877E−04 |
| A16= | — | — | −1.55168978E−03 | 7.43837891E−05 |
| A18= | — | — | 2.02467210E−04 | −6.09490523E−06 |
| Surface # | 14 | 15 | 16 | 17 |
| k= | 0.00000E+00 | 0.00000E+00 | 0.00000E+00 | 0.00000E+00 |
| A4= | −1.89371113E−02 | −2.83858025E−02 | −9.67086575E−03 | 1.07269391E−02 |
| A6= | 9.34372108E−03 | 1.20389057E−02 | 3.11629016E−03 | −1.24129764E−03 |
| A8= | −5.16079718E−03 | −4.97300778E−03 | −1.05841989E−03 | 3.94911199E−04 |
| A10= | 2.32304501E−03 | 1.76591072E−03 | 2.87587249E−04 | −1.16127542E−04 |
| A12= | −7.76607275E−04 | −4.95407974E−04 | −7.50422892E−05 | 7.41631521E−06 |
| A14= | 1.79485867E−04 | 1.07210160E−04 | 1.58900779E−05 | 3.57942610E−06 |
| A16= | −2.71793237E−05 | −1.75728751E−05 | −2.34000535E−06 | −1.05677458E−06 |
| A18= | 2.41931419E−06 | 2.08389665E−06 | 2.23695517E−07 | 1.43905162E−07 |
| A20= | −9.62983630E−08 | −1.65949247E−07 | −1.31439282E−08 | −1.18591957E−08 |
| A22= | — | 7.84595687E−09 | 4.30150138E−10 | 6.23559879E−10 |
| A24= | — | −1.65293575E−10 | −5.99729899E−12 | −2.05455200E−11 |
| A26= | — | — | — | 3.87939346E−13 |
| A28= | — | — | — | −3.21057546E−15 |

| Surface # | 18 | 19 |
|---|---|---|
| k= | −1.01890E+00 | 0.00000E+00 |
| A4= | 9.17275727E−03 | 5.39356966E−03 |
| A6= | −4.79370386E−03 | −6.50950352E−03 |
| A8= | 1.25531108E−03 | 2.46182575E−03 |
| A10= | −1.28504737E−04 | −6.35136411E−04 |
| A12= | −1.33788392E−05 | 1.18588553E−04 |
| A14= | 6.08624462E−06 | −1.61880026E−05 |
| A16= | −9.06103001E−07 | 1.60747219E−06 |
| A18= | 7.84600902E−08 | −1.14961367E−07 |
| A20= | −4.36772729E−09 | 5.82627387E−09 |
| A22= | 1.59021245E−10 | −2.03336798E−10 |
| A24= | −3.67359473E−12 | 4.63473836E−12 |
| A26= | 4.89835242E−14 | −6.19897203E−14 |
| A28= | −2.87552259E−16 | 3.68478049E−16 |

In the 8th embodiment, the equation of the aspheric surface profiles of the aforementioned lens elements is the same as the equation of the 1st embodiment. Also, the definitions of these parameters shown in Table 8C are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Schematic Parameters

| | | | |
|---|---|---|---|
| f [mm] | 3.65 | R1/R16 | 1.01 |
| Fno | 2.42 | R2/R16 | 0.21 |
| HFOV [deg.] | 76.9 | R2/R13 | 0.51 |
| FOV [deg.] | 153.8 | R3/R4 | 1.97 |
| TL × Fno/ImgH | 7.69 | R15/R4 | 1.12 |
| 2 × ImgH/TD | 0.67 | R7/R8 | −0.64 |
| BL/f | 0.26 | (R7 + R8)/(R7 − R8) | −0.22 |
| f/f6 | −0.03 | (R15 + R16)/(R15 − R16) | −0.47 |
| f5/f8 | 0.84 | V3/N3 | 36.27 |
| f/f56 | −0.64 | ET1/CT1 | 1.44 |
| \|f/f2\| + \|f/f3\| | 0.47 | ET3/ET6 | 2.29 |
| f/f1 + f/f5 + f/f8 | −1.51 | SAG1R2/CT1 | 1.51 |
| SL/TL | 0.39 | Yc71/Yi81 | 1.05 |
| Dr1r6/SD | 1.69 | ImgH/Y4R1 + Y1R1/Y4R1 | 10.76 |
| CT2/CT8 | 3.10 | Y1R1/Y8R2 | 1.74 |
| (T23 + T45)/T34 | 0.33 | Y7R1/Y6R2 + Y6R1/Y5R2 | 2.80 |
| (CT2 + CT3)/(CT4 + | 1.07 | — | — |
| CT5 + CT6 + | | | |
| CT7 + CT8) | | | |

### 9th Embodiment

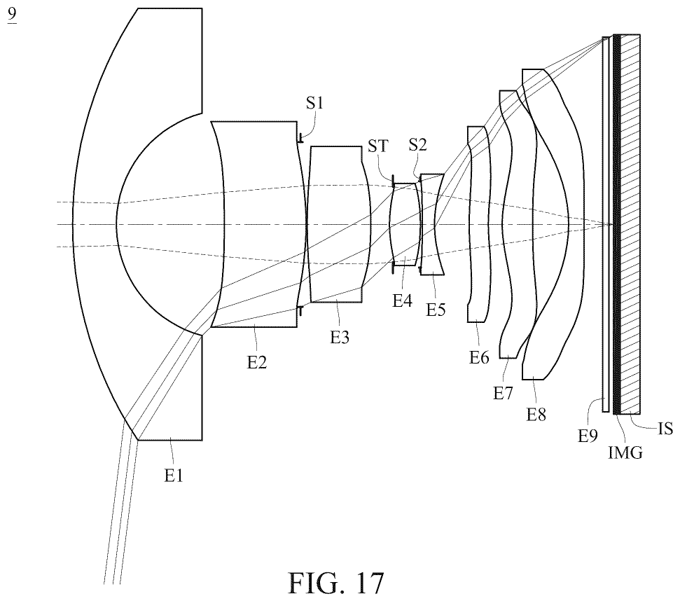

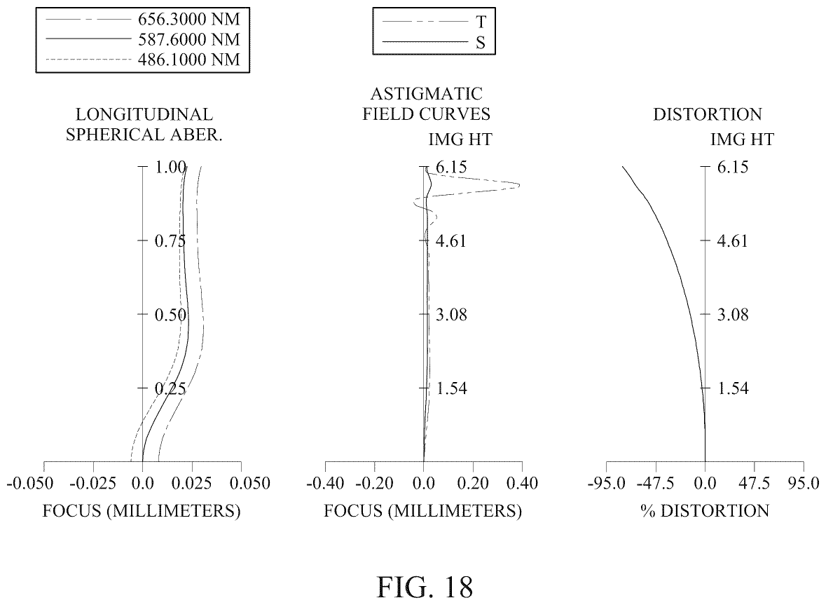

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has three inflection points. The image-side surface of the seventh lens element E7 has three inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being convex in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has four inflection points. The image-side surface of the eighth lens element E8 has two critical points in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 9th embodiment are shown in Table 9A and the aspheric surface data are shown in Table 9B below.

TABLE 9A
9th Embodiment
f = 3.83 mm, Fno = 2.66, HFOV = 82.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.6199 | (SPH) | 1.419 | Glass | 1.804 | 46.6 | −7.07 |
| 2 | | 3.7242 | (SPH) | 3.500 | | | | |
| 3 | Lens 2 | −40.1119 | (ASP) | 2.650 | Plastic | 1.587 | 28.3 | 19.54 |
| 4 | | −9.1395 | (ASP) | −0.180 | | | | |
| 5 | Stop | Plano | | 0.215 | | | | |
| 6 | Lens 3 | 16.3679 | (ASP) | 2.061 | Plastic | 1.53 | 55.8 | 13.99 |
| 7 | | −12.9712 | (ASP) | 0.718 | | | | |
| 8 | Ape. Stop | Plano | | −0.110 | | | | |
| 9 | Lens 4 | 4.1394 | (ASP) | 1.000 | Glass | 1.589 | 61.3 | 4.24 |
| 10 | | −5.7346 | (ASP) | −0.011 | | | | |
| 11 | Stop | Plano | | 0.070 | | | | |
| 12 | Lens 5 | 128.9637 | (ASP) | 0.400 | Plastic | 1.642 | 22.5 | −5.74 |
| 13 | | 3.5778 | (ASP) | 1.123 | | | | |
| 14 | Lens 6 | 8.7326 | (ASP) | 0.620 | Glass | 1.544 | 56.0 | −24.17 |
| 15 | | 5.1162 | (ASP) | 0.449 | | | | |
| 16 | Lens 7 | 3.7221 | (ASP) | 0.988 | Plastic | 1.511 | 56.8 | 8.16 |
| 17 | | 31.5366 | (ASP) | 1.164 | | | | |
| 18 | Lens 8 | −3.9428 | (ASP) | 0.500 | Plastic | 1.614 | 25.6 | −7.42 |
| 19 | | −30.8891 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.146 | | | | |
| 22 | Image | Plano | — | | | | |

Note:
Reference wavelength is 587.6 nm (d-line).
An effective radius of the stop S1 (Surface 5) is 2.672 mm.
An effective radius of the stop S2 (Surface 11) is 1.399 mm.

TABLE 9B
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | −2.44998279E−03 | 4.94331073E−03 | 2.30082170E−03 | −1.47814070E−02 |
| A6= | −5.23463870E−05 | −2.05656021E−03 | −1.84497284E−03 | 1.73960185E−03 |
| A8= | 5.19831971E−05 | 7.13052044E−04 | 2.19165097E−04 | 1.22529126E−03 |
| A10= | −2.11690882E−05 | −1.98992029E−04 | 6.75728837E−05 | −1.28177172E−03 |
| A12= | 4.73842533E−06 | 4.90896248E−05 | −3.02346317E−05 | 6.67912849E−04 |
| A14= | −6.43561763E−07 | −1.01226308E−05 | 2.54094399E−06 | −2.19929732E−04 |
| A16= | 5.27013738E−08 | 1.56588143E−06 | 8.65636428E−07 | 4.65387588E−05 |
| A18= | −2.36558785E−09 | −1.60470583E−07 | −2.43427876E−07 | −6.04776043E−06 |
| A20= | 4.42903725E−11 | 9.51805752E−09 | 2.41312093E−08 | 4.30656170E−07 |
| A22= | — | −2.46925134E−10 | −8.81415509E−10 | −1.23421565E−08 |
| Surface # | 9 | 10 | 12 | 13 |
| k= | 0.00000E+00 | 0.00000E+00 | 0.00000E+00 | −1.28363E+01 |
| A4= | −1.44493732E−02 | −1.58389704E−03 | −2.18942895E−02 | 1.10908420E−02 |
| A6= | 2.03119120E−03 | −4.16138627E−03 | 1.34054449E−02 | −3.43339039E−03 |
| A8= | −1.51310417E−03 | 2.08152350E−03 | −2.25698620E−02 | 2.37504580E−03 |
| A10= | 7.20784373E−04 | −5.02651271E−04 | 3.54069904E−02 | −1.90710730E−03 |
| A12= | −1.81609996E−04 | −2.94514644E−05 | −3.66535594E−02 | 1.20577349E−03 |
| A14= | — | — | 2.43755216E−02 | −4.97062203E−04 |
| A16= | — | — | −1.01003713E−02 | 1.12060373E−04 |
| A18= | — | — | 2.36422436E−03 | −1.03722258E−05 |
| A20= | — | — | −2.38093925E−04 | — |
| Surface # | 14 | 15 | 16 | 17 |
| k= | 0.00000E+00 | 0.00000E+00 | −8.89190E−01 | 0.00000E+00 |
| A4= | −2.98378599E−02 | −6.07864513E−02 | −3.21012563E−02 | 6.51316370E−03 |
| A6= | 2.04794829E−02 | 2.99039682E−02 | 7.76935600E−03 | −6.93042511E−03 |
| A8= | −1.39996348E−02 | −1.30839290E−02 | −2.55224885E−04 | 5.11510285E−03 |
| A10= | 7.58146006E−03 | 4.31876046E−03 | −7.75008466E−04 | −2.03934479E−03 |
| A12= | −3.11407237E−03 | −1.06071681E−03 | 3.26089673E−04 | 4.84610187E−04 |
| A14= | 9.48563681E−04 | 1.99520667E−04 | −7.42105490E−05 | −7.50083413E−05 |
| A16= | −2.08683229E−04 | −2.91727980E−05 | 1.14268737E−05 | 7.93235721E−06 |
| A18= | 3.19273904E−05 | 3.26933952E−06 | −1.26879626E−06 | −5.86325470E−07 |
| A20= | −3.20479906E−06 | −2.69543140E−07 | 1.01949029E−07 | 3.04948722E−08 |
| A22= | 1.89136156E−07 | 1.52368327E−08 | −5.74116819E−09 | −1.11376927E−09 |
| A24= | −4.96698795E−09 | −5.21671786E−10 | 2.12981234E−10 | 2.85285000E−11 |
| A26= | — | 8.07801714E−12 | −4.64298461E−12 | −5.16340767E−13 |
| A28= | — | — | 4.48682513E−14 | 6.49448739E−15 |
| A30= | — | — | — | −4.50714626E−17 |

| Surface # | 18 | 19 |
|---|---|---|
| k= | −8.38288E−01 | 0.00000E+00 |
| A4= | 3.48556753E−02 | 3.60870206E−02 |
| A6= | −3.33005305E−02 | −3.10369301E−02 |
| A8= | 1.75807516E−02 | 1.39466338E−02 |
| A10= | −5.58445698E−03 | −3.99677246E−03 |
| A12= | 1.13377631E−03 | 7.84195546E−04 |
| A14= | −1.51914297E−04 | −1.10431217E−04 |
| A16= | 1.34600086E−05 | 1.14734835E−05 |
| A18= | −7.51191754E−07 | −8.89261992E−07 |
| A20= | 2.11395375E−08 | 5.12447223E−08 |
| A22= | 2.07651848E−10 | −2.15860299E−09 |
| A24= | −4.23533424E−11 | 6.43102922E−11 |
| A26= | 1.61216012E−12 | −1.27855425E−12 |
| A28= | −2.87990119E−14 | 1.51670748E−14 |
| A30= | 2.08528425E−16 | −8.09842501E−17 |

In the 9th embodiment, the equation of the aspheric surface profiles of the aforementioned lens elements is the same as the equation of the 1st embodiment. Also, the definitions of these parameters shown in Table 9C are the same as those stated in the 1st embodiment with corresponding values for the 9th embodiment, so an explanation in this regard will not be provided again.

Moreover, these parameters can be calculated from Table 9A and Table 9B as the following values and satisfy the following conditions:

TABLE 9C
Schematic Parameters

| | | | |
|---|---|---|---|
| f [mm] | 3.83 | R1/R16 | −0.41 |
| Fno | 2.66 | R2/R16 | −0.12 |
| HFOV [deg.] | 82.9 | R2/R13 | 1.00 |
| FOV [deg.] | 165.8 | R3/R4 | 4.39 |
| TL × Fno/ImgH | 7.58 | R15/R4 | 0.43 |
| 2 × ImgH/TD | 0.74 | R7/R8 | −0.72 |
| BL/f | 0.25 | (R7 + R8)/(R7 − R8) | −0.16 |
| f/f6 | −0.16 | (R15 + R16)/(R15 − R16) | −1.29 |
| f5/f8 | 0.77 | V3/N3 | 36.47 |
| f/f56 | −0.88 | ET1/CT1 | 1.47 |
| \|f/f2\| + \|f/f3\| | 0.47 | ET3/ET6 | 3.08 |
| f/f1 + f/f5 + f/f8 | −1.72 | SAG1R2/CT1 | 1.96 |
| SL/TL | 0.41 | Yc71/Yi81 | 0.87 |
| Dr1r6/SD | 1.56 | ImgH/Y4R1 + Y1R1/Y4R1 | 10.57 |
| CT2/CT8 | 5.30 | Y1R1/Y8R2 | 1.39 |
| (T23 + T45)/T34 | 0.15 | Y7R1/Y6R2 + Y6R1/Y5R2 | 2.83 |
| (CT2 + CT3)/(CT4 + | 1.34 | — | — |
| CT5 + CT6 + | | | |
| CT7 + CT8) | | | |

### 10th Embodiment

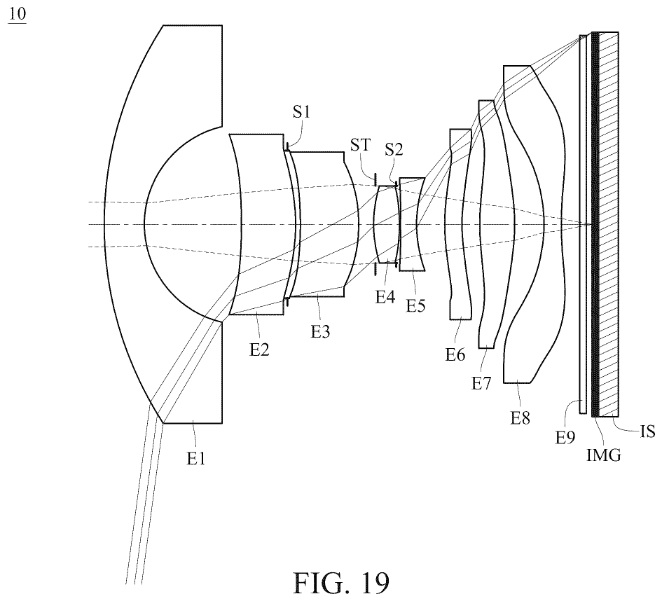

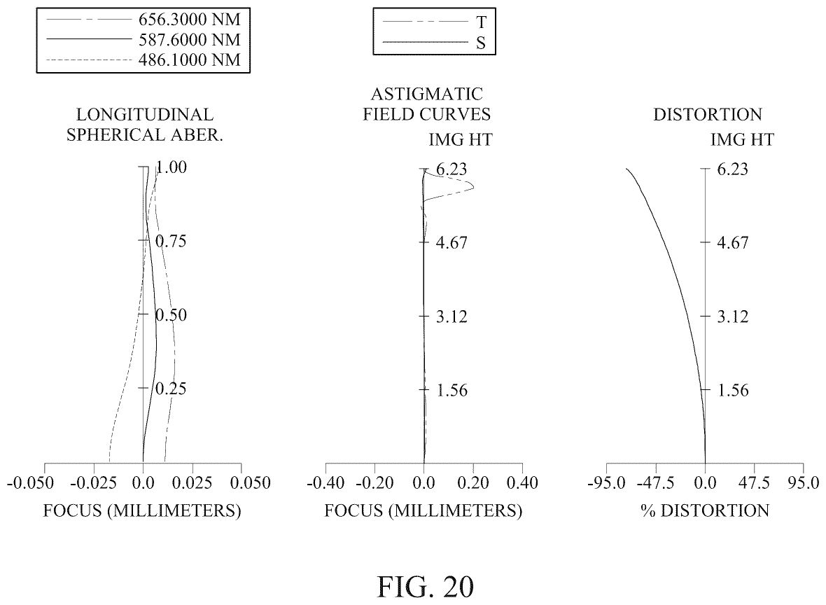

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has three inflection points. The image-side surface of the seventh lens element E7 has two inflection points. The object-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 10th embodiment are shown in Table 10A and the aspheric surface data are shown in Table 10B below.

TABLE 10A
10th Embodiment
f = 3.52 mm, Fno = 2.43, HFOV = 82.4 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 11.8211 | (SPH) | 1.301 | Glass | 1.683 | 44.5 | −7.01 |
| 2 | | 3.2549 | (SPH) | 3.146 | | | | |
| 3 | Lens 2 | −19.1750 | (ASP) | 1.756 | Plastic | 1.639 | 23.5 | 12.62 |
| 4 | | −5.8753 | (ASP) | −0.268 | | | | |
| 5 | Stop | Plano | | 0.423 | | | | |
| 6 | Lens 3 | −10.3905 | (ASP) | 1.888 | Plastic | 1.544 | 56.0 | 16.80 |
| 7 | | −5.1747 | (ASP) | 0.540 | | | | |
| 8 | Ape. Stop | Plano | | −0.056 | | | | |
| 9 | Lens 4 | 4.0413 | (ASP) | 0.836 | Plastic | 1.544 | 56.0 | 4.62 |
| 10 | | −6.1491 | (ASP) | −0.105 | | | | |
| 11 | Stop | Plano | | 0.140 | | | | |
| 12 | Lens 5 | 43.0344 | (ASP) | 0.520 | Plastic | 1.669 | 19.5 | −6.17 |
| 13 | | 3.7508 | (ASP) | 0.912 | | | | |
| 14 | Lens 6 | 5.9216 | (ASP) | 0.560 | Glass | 1.544 | 56.0 | −99.37 |
| 15 | | 5.1592 | (ASP) | 0.576 | | | | |
| 16 | Lens 7 | 7.3724 | (ASP) | 1.130 | Plastic | 1.544 | 56.0 | 6.60 |
| 17 | | −6.6139 | (ASP) | 0.952 | | | | |
| 18 | Lens 8 | −4.4914 | (ASP) | 0.560 | Plastic | 1.614 | 26.0 | −5.31 |
| 19 | | 12.4494 | (ASP) | 0.600 | | | | |

| | | | | | | | |
|---|---|---|---|---|---|---|---|
| 20 | Filter | Plano | 0.210 | Glass | 1.517 | 64.2 | — |
| 21 | | Plano | 0.182 | | | | |
| 22 | Image | Plano | — | | | | |

Note:
Reference wavelength is 587.6 nm (d-line).
An effective radius of the stop S1 (Surface 5) is 2.394 mm.
An effective radius of the stop S2 (Surface 11) is 1.251 mm.

TABLE 10B
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | −2.84979207E−03 | 9.59823444E−03 | 6.66229581E−03 | −7.52690835E−03 |
| A6= | 4.36345464E−06 | −2.89810856E−03 | −4.36977807E−03 | 1.11233307E−03 |
| A8= | 5.36640653E−05 | 6.43893981E−04 | 9.90062324E−04 | 1.26991356E−04 |
| A10= | −2.75808035E−05 | −8.27818683E−05 | −1.64336297E−04 | −9.47390045E−06 |
| A12= | 7.14774573E−06 | −1.86454602E−06 | 8.61963594E−06 | −1.41388453E−04 |
| A14= | −1.07609515E−06 | 4.02878446E−06 | 8.38293952E−06 | 1.10444245E−04 |
| A16= | 9.50950683E−08 | −9.15282154E−07 | −3.60016176E−06 | −4.10239237E−05 |
| A18= | −4.29805448E−09 | 9.60579520E−08 | 7.02576181E−07 | 8.50947444E−06 |
| A20= | 6.61114516E−11 | −3.95322579E−09 | −6.92543356E−08 | −9.48982034E−07 |
| A22= | — | — | 2.80123292E−09 | 4.45633482E−08 |
| Surface # | 9 | 10 | 12 | 13 |
| k= | 0.00000E+00 | 0.00000E+00 | 0.00000E+00 | −8.52103E+00 |
| A4= | −4.37953799E−03 | −1.00363173E−02 | −2.61786838E−02 | 4.45631662E−04 |
| A6= | 1.43488163E−03 | 8.83833736E−03 | 1.62781488E−02 | 4.63435789E−03 |
| A8= | −1.79339471E−03 | −1.11928636E−02 | −1.63332741E−02 | −2.22640839E−03 |
| A10= | 1.06732608E−03 | 8.21393897E−03 | 1.58689306E−02 | 8.81625290E−04 |
| A12= | −3.36050187E−04 | −3.21709394E−03 | −1.10179222E−02 | −1.59743174E−04 |
| A14= | — | 4.55254417E−04 | 5.07399903E−03 | −2.16462589E−05 |
| A16= | — | — | −1.43563309E−03 | 1.08818957E−05 |
| A18= | — | — | 1.85691042E−04 | −7.16717228E−07 |
| Surface # | 14 | 15 | 16 | 17 |
| k= | 0.00000E+00 | 0.00000E+00 | 0.00000E+00 | 0.00000E+00 |
| A4= | −2.32553960E−02 | −3.42161637E−02 | −1.54674918E−02 | 7.82548006E−03 |
| A6= | 1.31021924E−02 | 1.56665203E−02 | 4.93600212E−03 | 3.67457399E−04 |
| A8= | −7.50232731E−03 | −6.64063864E−03 | −2.15771822E−03 | −1.01665178E−03 |
| A10= | 3.39157678E−03 | 2.29012997E−03 | 8.48552961E−04 | 5.31354153E−04 |
| A12= | −1.11137092E−03 | −5.96849912E−04 | −2.53136627E−04 | −1.51695390E−04 |
| A14= | 2.47870714E−04 | 1.14080634E−04 | 5.18034980E−05 | 2.52850352E−05 |
| A16= | −3.55485966E−05 | −1.56920853E−05 | −7.02882056E−06 | −2.36415052E−06 |
| A18= | 2.94247071E−06 | 1.50286862E−06 | 6.17390753E−07 | 8.36683051E−08 |
| A20= | −1.06967796E−07 | −9.45984272E−08 | −3.36114062E−08 | 6.36560919E−09 |
| A22= | — | 3.50604440E−09 | 1.02892551E−09 | −9.53994794E−10 |
| A24= | — | −5.78959777E−11 | −1.35316818E−11 | 5.20875461E−11 |
| A26= | — | — | — | −1.40492817E−12 |
| A28= | — | — | — | 1.55187403E−14 |

| Surface # | 18 | 19 |
|---|---|---|
| k= | −8.09969E−01 | 0.00000E+00 |
| A4= | 1.31584629E−02 | 8.39834999E−03 |
| A6= | −5.83558165E−03 | −8.57618065E−03 |
| A8= | 8.31331387E−04 | 3.08250973E−03 |
| A10= | 1.56724205E−04 | −7.29432501E−04 |
| A12= | −8.86064944E−05 | 1.21540898E−04 |
| A14= | 1.75904652E−05 | −1.45475586E−05 |
| A16= | −2.01623894E−06 | 1.25601576E−06 |
| A18= | 1.47597579E−07 | −7.78645292E−08 |
| A20= | −7.09545106E−09 | 3.41799180E−09 |
| A22= | 2.21715939E−10 | −1.03311787E−10 |
| A24= | −4.28396325E−12 | 2.03946735E−12 |
| A26= | 4.54202957E−14 | −2.36218635E−14 |
| A28= | −1.92269657E−16 | 1.21548551E−16 |

In the 10th embodiment, the equation of the aspheric surface profiles of the aforementioned lens elements is the same as the equation of the 1st embodiment. Also, the definitions of these parameters shown in Table 10C are the same as those stated in the 1st embodiment with corresponding values for the 10th embodiment, so an explanation in this regard will not be provided again.

Moreover, these parameters can be calculated from Table 10A and Table 10B as the following values and satisfy the following conditions:

TABLE 10C
Schematic Parameters

| | | | |
|---|---|---|---|
| f [mm] | 3.52 | R1/R16 | 0.95 |
| Fno | 2.43 | R2/R16 | 0.26 |
| HFOV [deg.] | 82.4 | R2/R13 | 0.44 |
| FOV [deg.] | 164.8 | R3/R4 | 3.26 |
| TL × Fno/ImgH | 6.16 | R15/R4 | 0.76 |
| 2 × ImgH/TD | 0.84 | R7/R8 | −0.66 |
| BL/f | 0.28 | (R7 + R8)/(R7 − R8) | −0.21 |
| f/f6 | −0.04 | (R15 + R16)/(R15 − R16) | −0.47 |
| f5/f8 | 1.16 | V3/N3 | 36.27 |
| f/f56 | −0.63 | ET1/CT1 | 1.46 |
| \|f/f2\| + \|f/f3\| | 0.49 | ET3/ET6 | 2.56 |
| f/f1 + f/f5 + f/f8 | −1.73 | SAG1R2/CT1 | 1.93 |
| SL/TL | 0.44 | Yc71/Yi81 | 0.83 |
| Dr1r6/SD | 1.37 | ImgH/Y4R1 + Y1R1/Y4R1 | 10.00 |
| CT2/CT8 | 3.14 | Y1R1/Y8R2 | 1.25 |
| (T23 + T45)/T34 | 0.39 | Y7R1/Y6R2 + Y6R1/Y5R2 | 2.83 |
| (CT2 + CT3)/(CT4 + | 1.01 | — | — |
| CT5 + CT6 + | | | |
| CT7 + CT8) | | | |

### 11th Embodiment

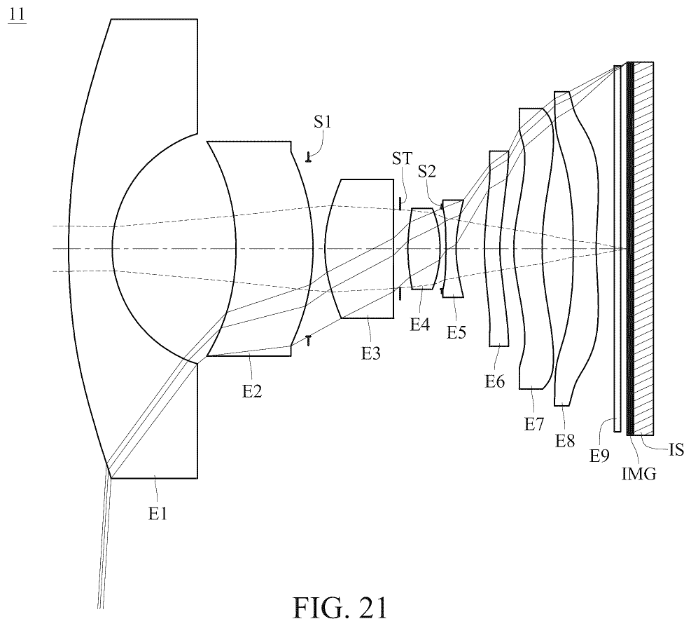

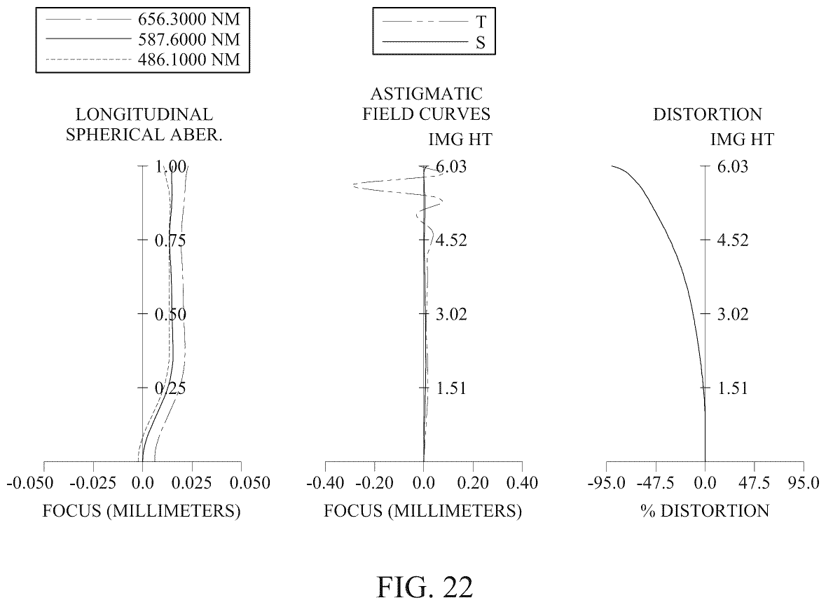

FIG. 21 is a schematic view of an image capturing unit according to the 11th embodiment of the present disclosure. FIG. 22 shows, in order from left to right, spherical aberration curves, astigmatic field curves and a distortion curve of the image capturing unit according to the 11th embodiment. In FIG. 21, the image capturing unit 11 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has two inflection points. The image-side surface of the third lens element E3 has two critical points in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has three inflection points. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 11th embodiment are shown in Table 11A and the aspheric surface data are shown in Table 11B below.

TABLE 11A
11th Embodiment
f = 3.81 mm, Fno = 2.61, HFOV = 86.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 21.7987 | (ASP) | 1.412 | Glass | 1.589 | 61.3 | −8.13 |
| 2 | | 3.8336 | (ASP) | 4.015 | | | | |
| 3 | Lens 2 | −7.4118 | (ASP) | 2.495 | Plastic | 1.544 | 56.0 | 101.57 |
| 4 | | −7.3104 | (ASP) | −0.151 | | | | |
| 5 | Stop | Plano | | 0.538 | | | | |
| 6 | Lens 3 | 4.1590 | (ASP) | 2.220 | Plastic | 1.511 | 56.8 | 9.15 |
| 7 | | 31.0341 | (ASP) | 0.213 | | | | |
| 8 | Ape. Stop | Plano | | 0.257 | | | | |
| 9 | Lens 4 | 5.1835 | (ASP) | 1.041 | Plastic | 1.53 | 55.8 | 4.33 |
| 10 | | −3.8297 | (ASP) | 0.054 | | | | |
| 11 | Stop | Plano | | 0.136 | | | | |
| 12 | Lens 5 | −36.3264 | (ASP) | 0.330 | Plastic | 1.65 | 21.8 | −5.48 |
| 13 | | 3.9611 | (ASP) | 0.920 | | | | |
| 14 | Lens 6 | 6.9824 | (ASP) | 0.500 | Plastic | 1.544 | 56.0 | −24.00 |
| 15 | | 4.4345 | (ASP) | 0.450 | | | | |
| 16 | Lens 7 | 4.1457 | (ASP) | 0.921 | Plastic | 1.551 | 44.8 | 13.93 |
| 17 | | 8.3052 | (ASP) | 1.006 | | | | |
| 18 | Lens 8 | −70.4647 | (ASP) | 0.748 | Plastic | 1.697 | 16.3 | −15.20 |
| 19 | | 12.5317 | (ASP) | 0.580 | | | | |

| | | | | | | | |
|---|---|---|---|---|---|---|---|
| 20 | Filter | Plano | 0.210 | Glass | 1.517 | 64.2 | — |
| 21 | | Plano | 0.208 | | | | |
| 22 | Image | Plano | — | | | | |

Note:
Reference wavelength is 587.6 nm (d-line).
An effective radius of the stop S1 (Surface 5) is 2.837 mm.
An effective radius of the stop S2 (Surface 11) is 1.307 mm.

TABLE 11B
Aspheric Coefficients

| Surface # | 1 | 2 | 3 | 4 |
|---|---|---|---|---|
| k= | 0.00000E+00 | 0.00000E+00 | 0.00000E+00 | 0.00000E+00 |
| A4= | −3.67843189E−05 | −8.29993991E−04 | −1.43207149E−03 | −2.06620420E−03 |
| A6= | 2.03695515E−05 | 1.24675364E−04 | 1.96101199E−04 | 1.30903401E−03 |
| A8= | −9.38866609E−07 | −1.49490241E−05 | 7.35816525E−06 | −5.10342063E−04 |
| A10= | 1.61108042E−08 | 1.57780616E−06 | −1.35104093E−05 | 1.32743977E−04 |
| A12= | −9.83302622E−11 | −8.48064008E−08 | 3.44207607E−06 | −2.33519463E−05 |
| A14= | — | — | −4.63580681E−07 | 2.72744841E−06 |
| A16= | — | — | 3.62949819E−08 | −2.00801352E−07 |
| A18= | — | — | −1.55197222E−09 | 8.38384738E−09 |
| A20= | — | — | 2.79734730E−11 | −1.50557367E−10 |
| Surface # | 6 | 7 | 9 | 10 |
| k= | 0.00000E+00 | 0.00000E+00 | 0.00000E+00 | 0.00000E+00 |
| A4= | −5.45061444E−03 | −9.46577180E−03 | −1.29760392E−02 | −8.68621469E−04 |
| A6= | 1.33379906E−03 | −6.60021057E−03 | 2.92690226E−04 | −1.31488723E−02 |
| A8= | −8.29354400E−04 | 2.33107284E−02 | 5.56211663E−04 | 1.15115517E−02 |
| A10= | 2.33956287E−04 | −3.72133349E−02 | −1.52952585E−04 | −5.93384484E−03 |
| A12= | −2.93521620E−05 | 3.73738817E−02 | 8.35674021E−05 | 1.72568545E−03 |
| A14= | −4.02655493E−06 | −2.35952929E−02 | — | −2.04266908E−04 |
| A16= | 2.22858283E−06 | 9.13479842E−03 | — | — |
| A18= | −3.27556052E−07 | −1.98164182E−03 | — | — |
| A20= | 1.73911694E−08 | 1.85120082E−04 | — | — |
| Surface # | 12 | 13 | 14 | 15 |
| k= | 0.00000E+00 | 0.00000E+00 | 0.00000E+00 | 0.00000E+00 |
| A4= | −2.19452001E−02 | −1.88973869E−02 | −2.88200037E−02 | −5.46685527E−02 |
| A6= | −5.53460806E−03 | −4.09518787E−04 | 1.78348479E−02 | 3.04342564E−02 |
| A8= | −7.24127477E−03 | 4.04047482E−03 | −1.06169371E−02 | −1.66693545E−02 |
| A10= | 3.06986581E−02 | −2.76332810E−03 | 5.48490676E−03 | 7.79026461E−03 |
| A12= | −4.14791776E−02 | 1.05175057E−03 | −2.22940581E−03 | −2.77227958E−03 |
| A14= | 3.12993001E−02 | −2.68133643E−04 | 6.59373367E−04 | 7.12378576E−04 |
| A16= | −1.40089330E−02 | 4.45814750E−05 | −1.36205427E−04 | −1.29793363E−04 |
| A18= | 3.46808989E−03 | −3.60139097E−06 | 1.90039295E−05 | 1.65395512E−05 |
| A20= | −3.65708589E−04 | −4.99995766E−09 | −1.70199946E−06 | −1.43858585E−06 |
| A22= | — | — | 8.82553207E−08 | 8.13144153E−08 |
| A24= | — | — | −2.01533930E−09 | −2.69171052E−09 |
| A26= | — | — | — | 3.96062888E−11 |
| Surface # | 16 | 17 | 18 | 19 |
| k= | 0.00000E+00 | 0.00000E+00 | 0.00000E+00 | 0.00000E+00 |
| A4= | −3.29821891E−02 | −1.05668076E−02 | −9.27241706E−03 | 2.60374262E−03 |
| A6= | 1.40766081E−02 | 6.65266285E−03 | −2.37741562E−03 | −9.84982741E−03 |
| A8= | −6.51096169E−03 | −2.48236899E−03 | 2.97063503E−03 | 4.74876482E−03 |
| A10= | 2.19930808E−03 | 4.73474536E−04 | −1.13413160E−03 | −1.30761771E−03 |
| A12= | −5.13242646E−04 | −2.97137327E−05 | 2.48524613E−04 | 2.35763925E−04 |
| A14= | 8.23360187E−05 | −6.96122385E−06 | −3.55584674E−05 | −2.94289657E−05 |
| A16= | −9.09057095E−06 | 2.04035016E−06 | 3.48434969E−06 | 2.60779604E−06 |
| A18= | 6.85346695E−07 | −2.61433622E−07 | −2.37819707E−07 | −1.65275668E−07 |
| A20= | −3.44535628E−08 | 2.02666008E−08 | 1.12871309E−08 | 7.43620396E−09 |
| A22= | 1.09723948E−09 | −1.00387268E−09 | −3.65040161E−10 | −2.31682398E−10 |
| A24= | −1.98459441E−11 | 3.11568364E−11 | 7.66927066E−12 | 4.74599111E−12 |
| A26= | 1.53157190E−13 | −5.53366258E−13 | −9.43362043E−14 | −5.74222530E−14 |
| A28= | — | 4.29774964E−15 | 5.15436333E−16 | 3.10557212E−16 |

In the 11th embodiment, the equation of the aspheric surface profiles of the aforementioned lens elements is the same as the equation of the 1st embodiment. Also, the definitions of these parameters shown in Table 11C are the same as those stated in the 1st embodiment with corresponding values for the 11th embodiment, so an explanation in this regard will not be provided again.

Moreover, these parameters can be calculated from Table 11A and Table 11B as the following values and satisfy the following conditions:

TABLE 11C
Schematic Parameters

| | | | |
|---|---|---|---|
| f [mm] | 3.81 | R1/R16 | 1.74 |
| Fno | 2.61 | R2/R16 | 0.31 |
| HFOV [deg.] | 86.5 | R2/R13 | 0.92 |
| FOV [deg.] | 173.0 | R3/R4 | 1.01 |
| TL × Fno/ImgH | 7.84 | R15/R4 | 9.64 |
| 2 × ImgH/TD | 0.71 | R7/R8 | −1.35 |
| BL/f | 0.26 | (R7 + R8)/(R7 − R8) | 0.15 |
| f/f6 | −0.16 | (R15 + R16)/(R15 − R16) | 0.70 |
| f5/f8 | 0.36 | V3/N3 | 37.59 |
| f/f56 | −0.91 | ET1/CT1 | 1.98 |
| \|f/f2\| + \|f/f3\| | 0.45 | ET3/ET6 | 2.76 |
| f/f1 + f/f5 + f/f8 | −1.41 | SAG1R2/CT1 | 1.95 |
| SL/TL | 0.41 | Yc71/Yi81 | 0.91 |
| Dr1r6/SD | 1.65 | ImgH/Y4R1 + Y1R1/Y4R1 | 10.14 |
| CT2/CT8 | 3.34 | Y1R1/Y8R2 | 1.46 |
| (T23 + T45)/T34 | 1.23 | Y7R1/Y6R2 + Y6R1/Y5R2 | 2.95 |
| (CT2 + CT3)/(CT4 + | 1.33 | — | — |
| CT5 + CT6 + | | | |
| CT7 + CT8) | | | |

### 12th Embodiment

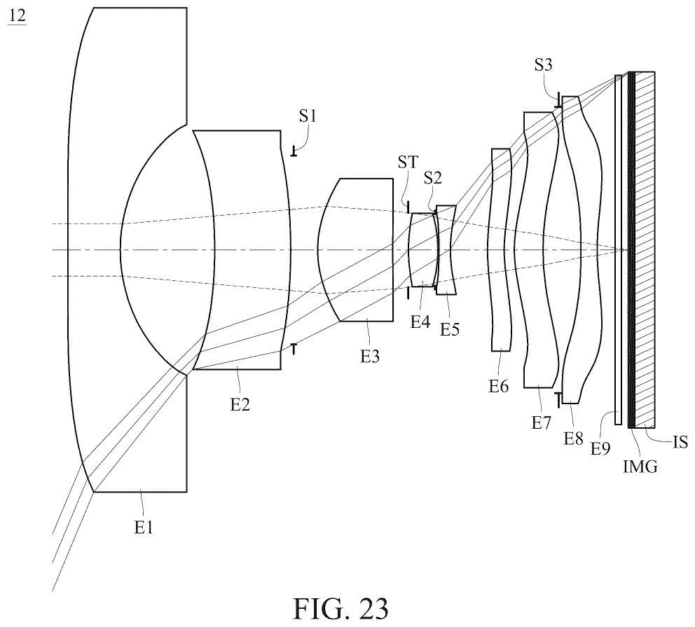

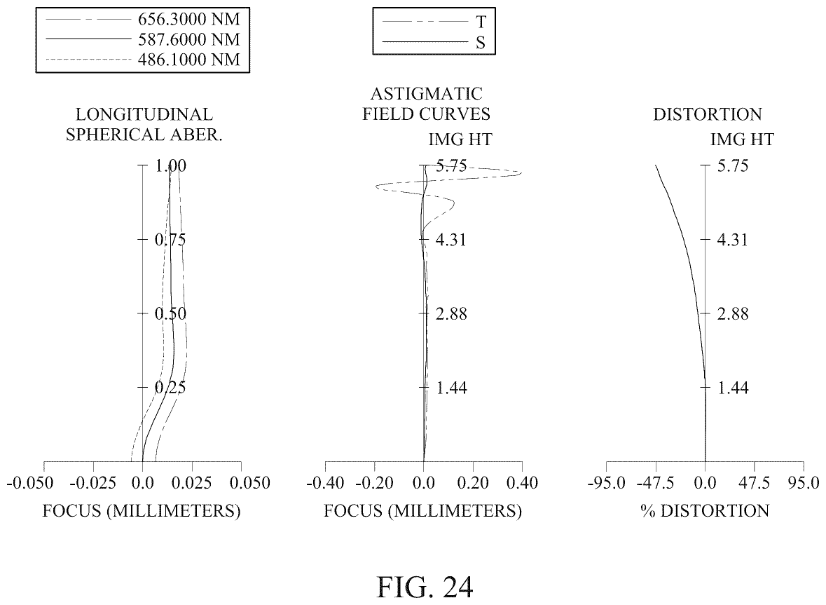

FIG. 23 is a schematic view of an image capturing unit according to the 12th embodiment of the present disclosure. FIG. 24 shows, in order from left to right, spherical aberration curves, astigmatic field curves and a distortion curve of the image capturing unit according to the 12th embodiment. In FIG. 23, the image capturing unit 12 includes the capturing optical lens assembly (its reference numeral is omitted) of the present disclosure and an image sensor IS. The capturing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, a stop S3, an eighth lens element E8, a filter E9 and an image surface IMG. The capturing optical lens assembly includes eight lens elements (E1, E2, E3, E4, E5, E6, E7 and E8) with no additional lens element disposed between each of the adjacent eight lens elements. There is an air gap in a paraxial region between each of all adjacent lens elements of the eight lens elements of the capturing optical lens assembly.

The first lens element E1 with negative refractive power has an object-side surface being concave in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The object-side surface of the first lens element E1 has one critical point in an off-axis region thereof. The object-side surface of the first lens element E1 has at least one convex shape in the off-axis region thereof.

The second lens element E2 with negative refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has two inflection points. The image-side surface of the third lens element E3 has two critical points in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The image-side surface of the eighth lens element E8 has one critical point in an off-axis region thereof.

The filter E9 is made of glass material and located between the eighth lens element E8 and the image surface IMG, and will not affect the focal length of the capturing optical lens assembly. The image sensor IS is disposed on or near the image surface IMG of the capturing optical lens assembly.

The detailed optical data of the 12th embodiment are shown in Table 12A and the aspheric surface data are shown in Table 12B below.

TABLE 12A
12th Embodiment
f = 4.61 mm, Fno = 2.73, HFOV = 67.4 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −833.3333 | (ASP) | 1.700 | Glass | 1.526 | 60.2 | −9.79 |
| 2 | | 5.1892 | (ASP) | 3.056 | | | | |
| 3 | Lens 2 | −15.3469 | (ASP) | 2.463 | Plastic | 1.544 | 56.0 | −223.43 |
| 4 | | −18.5578 | (ASP) | 0.096 | | | | |
| 5 | Stop | Plano | | 0.780 | | | | |
| 6 | Lens 3 | 3.5716 | (ASP) | 2.430 | Plastic | 1.511 | 56.8 | 7.76 |
| 7 | | 27.8091 | (ASP) | 0.504 | | | | |
| 8 | Ape. Stop | Plano | | 0.006 | | | | |
| 9 | Lens 4 | 4.9557 | (ASP) | 0.950 | Plastic | 1.534 | 56.0 | 4.51 |
| 10 | | −4.3803 | (ASP) | −0.092 | | | | |
| 11 | Stop | Plano | | 0.127 | | | | |
| 12 | Lens 5 | −26.8899 | (ASP) | 0.373 | Plastic | 1.639 | 23.5 | −5.59 |
| 13 | | 4.1420 | (ASP) | 1.203 | | | | |
| 14 | Lens 6 | 6.8988 | (ASP) | 0.539 | Plastic | 1.515 | 56.4 | −25.02 |
| 15 | | 4.3750 | (ASP) | 0.330 | | | | |
| 16 | Lens 7 | 4.0763 | (ASP) | 0.932 | Plastic | 1.551 | 44.8 | 13.99 |
| 17 | | 7.9511 | (ASP) | 0.500 | | | | |
| 18 | Stop | Plano | | 0.720 | | | | |
| 19 | Lens 8 | −49.6274 | (ASP) | 0.531 | Plastic | 1.587 | 28.3 | −12.97 |
| 20 | | 9.0328 | (ASP) | 0.580 | | | | |

| | | | | | | | |
|---|---|---|---|---|---|---|---|
| 21 | Filter | Plano | 0.210 | Glass | 1.517 | 64.2 | — |
| 22 | | Plano | 0.220 | | | | |
| 23 | Image | Plano | — | | | | |

Note:
Reference wavelength is 587.6 nm (d-line).
An effective radius of the stop S1 (Surface 5) is 3.059 mm.
An effective radius of the stop S2 (Surface 11) is 1.166 mm.
An effective radius of the stop S3 (Surface 18) is 4.636 mm.

TABLE 12B
Aspheric Coefficients

| Surface # | 1 | 2 | 3 | 4 |
|---|---|---|---|---|
| k= | −9.90000E+01 | −4.84795E−01 | 0.00000E+00 | 0.00000E+00 |
| A4= | 7.28939536E−04 | 9.78457666E−04 | −1.07768627E−03 | −7.79752460E−04 |
| A6= | −2.06854332E−04 | −5.40882072E−04 | 2.08221335E−05 | 3.17365278E−04 |
| A8= | 3.30995075E−05 | 1.50199445E−04 | 4.56652739E−05 | −8.41634451E−05 |
| A10= | −2.91665789E−06 | −2.15837864E−05 | −1.80722222E−05 | 4.44499910E−06 |
| A12= | 1.63986238E−07 | 2.38645538E−06 | 2.97256479E−06 | 2.58292695E−06 |
| A14= | −6.31592862E−09 | −2.17439462E−07 | −2.66006429E−07 | −6.93629596E−07 |
| A16= | 1.72363579E−10 | 1.38641914E−08 | 1.36623474E−08 | 8.36179531E−08 |
| A18= | −3.37324839E−12 | −5.09168406E−10 | −3.80762065E−10 | −5.57299832E−09 |
| A20= | 4.71298013E−14 | 8.06460960E−12 | 4.48193705E−12 | 1.99053099E−10 |
| A22= | −4.59770833E−16 | — | — | −2.98183546E−12 |
| A24= | 2.98204813E−18 | — | — | — |
| A26= | −1.15870997E−20 | — | — | — |
| A28= | 2.04789521E−23 | — | — | — |
| Surface # | 6 | 7 | 9 | 10 |
| k= | 0.00000E+00 | 0.00000E+00 | 0.00000E+00 | 0.00000E+00 |
| A4= | −3.63198126E−03 | −9.85318635E−03 | −1.29256391E−02 | 2.30352235E−04 |
| A6= | 4.21398785E−04 | −1.52772718E−03 | 1.59119936E−03 | −7.08233618E−03 |
| A8= | −5.42809443E−04 | 6.60414539E−03 | −5.20715325E−04 | 1.80052489E−03 |
| A10= | 3.17140634E−04 | −7.87093094E−03 | 9.25149562E−04 | 1.91110490E−03 |
| A12= | −1.45278314E−04 | 6.02431100E−03 | −2.34656264E−04 | −1.52960048E−03 |
| A14= | 4.80256069E−05 | −2.76473992E−03 | — | 2.69704251E−04 |
| A16= | −1.06509192E−05 | 6.46492654E−04 | — | — |
| A18= | 1.48667527E−06 | −1.18672668E−05 | — | — |
| A20= | −1.16903425E−07 | −2.67749856E−05 | — | — |
| A22= | 3.94271113E−09 | 4.05169735E−06 | — | — |
| Surface # | 12 | 13 | 14 | 15 |
| k= | 0.00000E+00 | 0.00000E+00 | 0.00000E+00 | 0.00000E+00 |
| A4= | −2.80637386E−02 | −2.80735741E−02 | −2.13852105E−02 | −4.67092218E−02 |
| A6= | 1.94152356E−02 | 1.50404393E−02 | 8.83810484E−03 | 2.00473791E−02 |
| A8= | −5.54051733E−02 | −9.03060582E−03 | −2.99173925E−03 | −7.46409197E−03 |
| A10= | 1.12733190E−01 | 1.21883560E−03 | 3.33392525E−04 | 2.02361668E−03 |
| A12= | −1.52708891E−01 | 4.75561168E−03 | 2.31768166E−04 | −3.57549031E−04 |
| A14= | 1.34294694E−01 | −5.49193188E−03 | −1.38964567E−04 | 3.16018109E−05 |
| A16= | −7.37946110E−02 | 2.87460253E−03 | 3.76661786E−05 | 1.11656182E−06 |
| A18= | 2.28853596E−02 | −7.61706862E−04 | −5.98301390E−06 | −6.62561896E−07 |
| A20= | −3.05171991E−03 | 8.25991741E−05 | 5.69039159E−07 | 8.15566682E−08 |
| A22= | — | — | −3.00599328E−08 | −5.11832011E−09 |
| A24= | — | — | 6.79438435E−10 | 1.66372142E−10 |
| A26= | — | — | — | −2.19205706E−12 |
| Surface # | 16 | 17 | 19 | 20 |
| k= | 0.00000E+00 | 0.00000E+00 | 0.00000E+00 | 0.00000E+00 |
| A4= | −3.12312355E−02 | −9.75099900E−03 | −1.21516363E−02 | 1.04761985E−02 |
| A6= | 1.19208198E−02 | 8.27336716E−03 | −4.12190650E−03 | −1.71152755E−02 |
| A8= | −4.46032237E−03 | −3.61795030E−03 | 5.20434242E−03 | 8.20466724E−03 |
| A10= | 1.10716236E−03 | 8.62564976E−04 | −2.04169883E−03 | −2.33305070E−03 |
| A12= | −1.58176775E−04 | −1.18715897E−04 | 4.55229785E−04 | 4.38969591E−04 |
| A14= | 7.69653407E−06 | 8.16927812E−06 | −6.61265166E−05 | −5.73248288E−05 |
| A16= | 1.38939436E−06 | 9.37570968E−08 | 6.61039773E−06 | 5.30728601E−06 |
| A18= | −3.08992765E−07 | −7.61276644E−08 | −4.64384490E−07 | −3.50133297E−07 |
| A20= | 2.86419774E−08 | 7.64445926E−09 | 2.29169799E−08 | 1.63169790E−08 |
| A22= | −1.47340797E−09 | −4.12573146E−10 | −7.78283874E−10 | −5.23771528E−10 |
| A24= | 4.10606898E−11 | 1.31737278E−11 | 1.73221476E−11 | 1.09999142E−11 |
| A26= | −4.85745112E−13 | −2.34701678E−13 | −2.27447447E−13 | −1.35871486E−13 |
| A28= | — | 1.80450617E−15 | 1.33528667E−15 | 7.47691734E−16 |

In the 12th embodiment, the equation of the aspheric surface profiles of the aforementioned lens elements is the same as the equation of the 1st embodiment. Also, the definitions of these parameters shown in Table 12C are the same as those stated in the 1st embodiment with corresponding values for the 12th embodiment, so an explanation in this regard will not be provided again.

Moreover, these parameters can be calculated from Table 12A and Table 12B as the following values and satisfy the following conditions:

TABLE 12C
Schematic Parameters

| | | | |
|---|---|---|---|
| f [mm] | 4.61 | R1/R16 | −92.26 |
| Fno | 2.73 | R2/R16 | 0.57 |
| HFOV [deg.] | 67.4 | R2/R13 | 1.27 |
| FOV [deg.] | 134.8 | R3/R4 | 0.83 |
| TL × Fno/ImgH | 8.62 | R15/R4 | 2.67 |
| 2 × ImgH/TD | 0.67 | R7/R8 | −1.13 |
| BL/f | 0.22 | (R7 + R8)/(R7 − R8) | 0.06 |
| f/f6 | −0.18 | (R15 + R16)/(R15 − R16) | 0.69 |
| f5/f8 | 0.43 | V3/N3 | 37.57 |
| f/f56 | −1.08 | ET1/CT1 | 1.77 |
| \|f/f2\| + \|f/f3\| | 0.61 | ET3/ET6 | 2.87 |
| f/f1 + f/f5 + f/f8 | −1.65 | SAG1R2/CT1 | 1.26 |
| SL/TL | 0.39 | Yc71/Yi81 | 1.02 |
| Dr1r6/SD | 1.72 | ImgH/Y4R1 + Y1R1/Y4R1 | 11.23 |
| CT2/CT8 | 4.64 | Y1R1/Y8R2 | 1.58 |
| (T23 + T45)/T34 | 1.79 | Y7R1/Y6R2 + Y6R1/Y5R2 | 3.16 |
| (CT2 + CT3)/(CT4 + | 1.47 | — | — |
| CT5 + CT6 + | | | |
| CT7 + CT8) | | | |

### 13th Embodiment

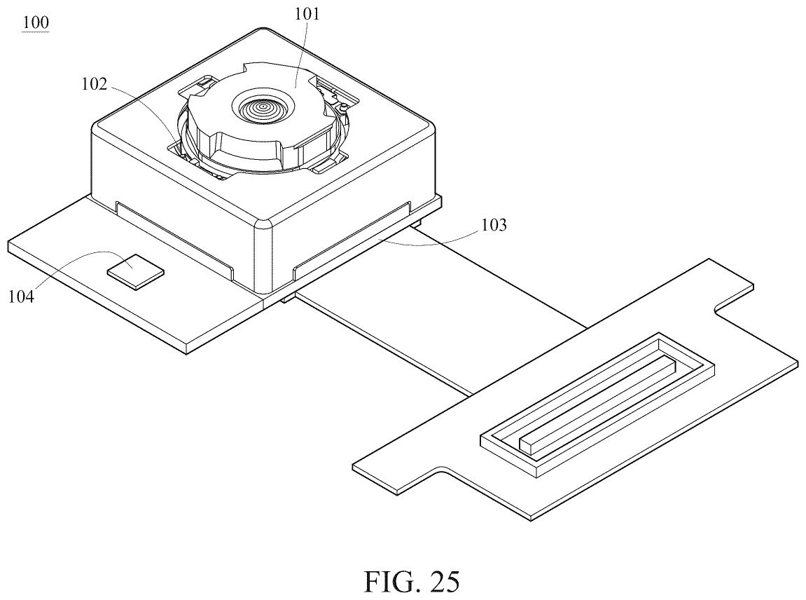

FIG. 25 is a perspective view of an image capturing unit according to the 13th embodiment of the present disclosure. In this embodiment, an image capturing unit 100 is a camera module including a lens unit 101, a driving device 102, an image sensor 103 and an image stabilizer 104. The lens unit 101 includes the capturing optical lens assembly disclosed in the 1st embodiment, a barrel and a holder member (their reference numerals are omitted) for holding the capturing optical lens assembly. However, the lens unit 101 may alternatively be provided with the capturing optical lens assembly disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems, or shape memory alloy materials. The driving device 102 is favorable for obtaining a better imaging position of the lens unit 101, so that a clear image of the imaged object can be captured by the lens unit 101 with different object distances. The image sensor 103 (for example, CCD or CMOS), which can feature high photosensitivity and low noise, is disposed on the image surface of the capturing optical lens assembly to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 14th Embodiment

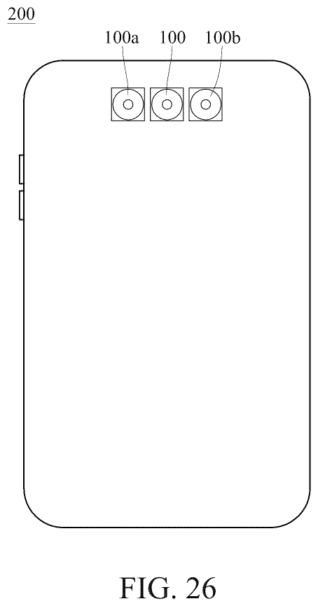

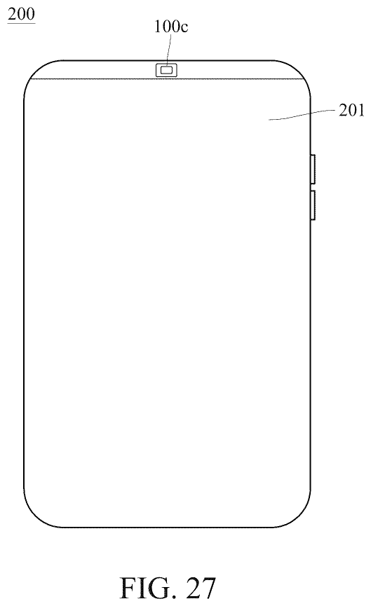

FIG. 26 is a perspective view of an electronic device according to the 14th embodiment of the present disclosure. FIG. 27 is another perspective view of the electronic device in FIG. 26.

In this embodiment, an electronic device 200 is a smartphone including the image capturing unit 100 disclosed in the 13th embodiment, an image capturing unit 100a, an image capturing unit 100b, an image capturing unit 100c and a display unit 201. As shown in FIG. 26, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 27, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the capturing optical lens assembly of the present disclosure and can have a configuration similar to that of the image capturing unit 100. In detail, each of the image capturing units 100a, 100b and 100c can include a lens unit, a driving device, an image sensor and an image stabilizer, and each of the lens unit can include a capturing optical lens assembly such as the capturing optical lens assembly of the present disclosure, a barrel and a holder member for holding the capturing optical lens assembly.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 27, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. In this embodiment, the electronic device 200 includes multiple image capturing units 100, 100a, 100b and 100c, but the present disclosure is not limited to the number and arrangement of image capturing units.

### 15th Embodiment

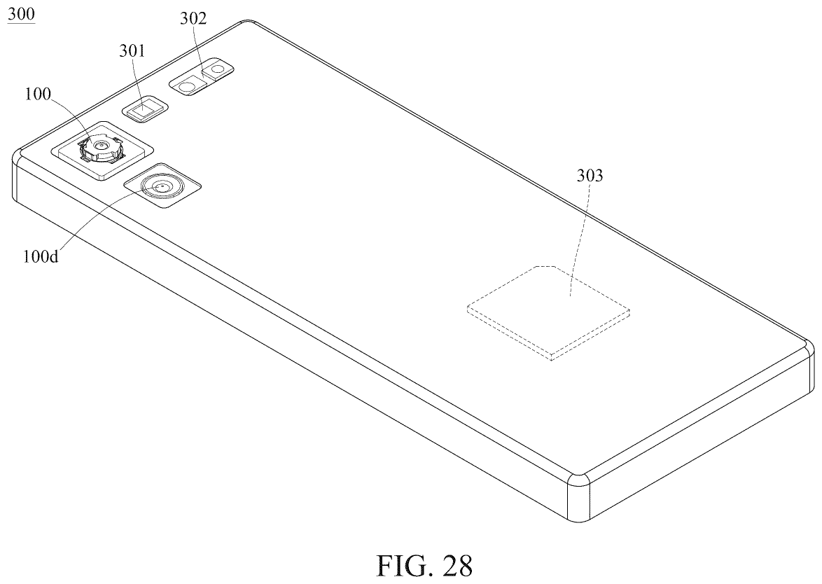

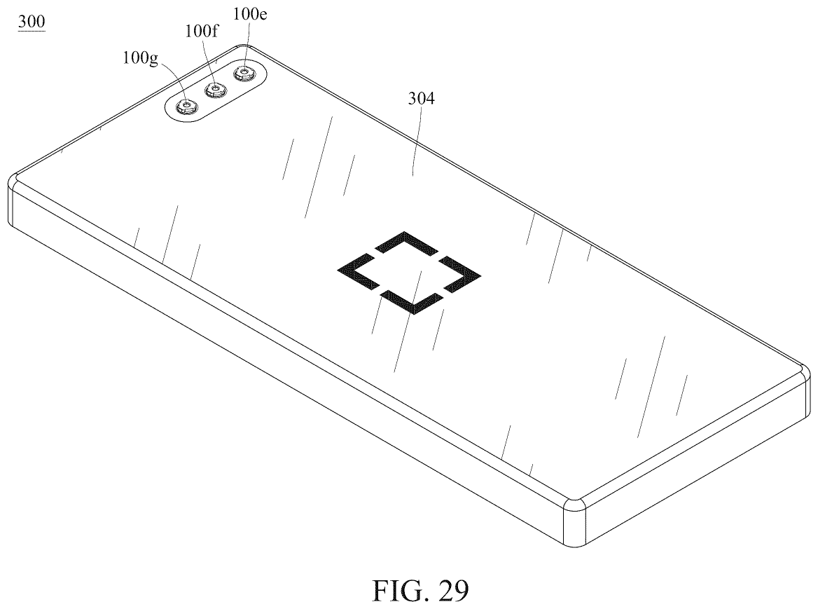

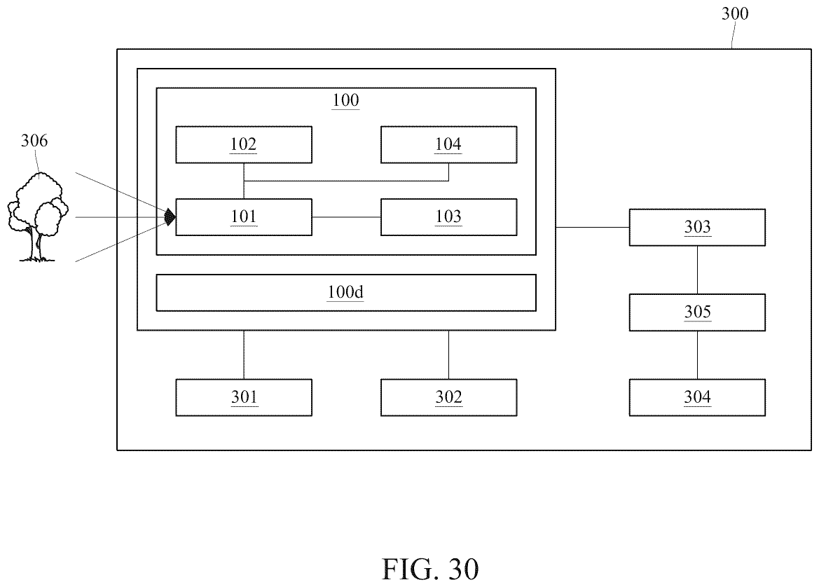

FIG. 28 is a perspective view of an electronic device according to the 15th embodiment of the present disclosure. FIG. 29 is another perspective view of the electronic device in FIG. 28. FIG. 30 is a block diagram of the electronic device in FIG. 28.

In this embodiment, an electronic device 300 is a smartphone including the image capturing unit 100 disclosed in the 13th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, the image capturing unit 100f, the image capturing unit 100g and the display module 304 are disposed on the opposite side of the electronic device 300, and the display module 304 can be a user interface, such that the image capturing units 100e, 100f, 100g can be front-facing cameras of the electronic device 300 for taking selfies, but the present disclosure is not limited thereto. Furthermore, each of the image capturing units 100d, 100e, 100f and 100g can include the capturing optical lens assembly of the present disclosure and can have a configuration similar to that of the image capturing unit 100. In detail, each of the image capturing units 100d, 100e, 100f and 100g can include a lens unit, a driving device, an image sensor and an image stabilizer, and each of the lens unit can include a capturing optical lens assembly such as the capturing optical lens assembly of the present disclosure, a barrel and a holder member for holding the capturing optical lens assembly.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can determine depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 16th Embodiment

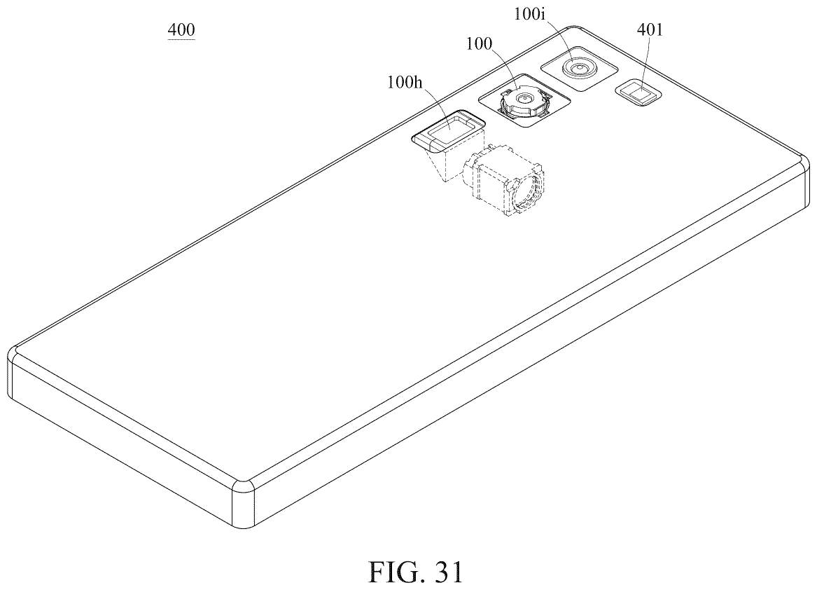

FIG. 31 is a perspective view of an electronic device according to the 16th embodiment of the present disclosure.

In this embodiment, an electronic device 400 is a smartphone including the image capturing unit 100 disclosed in the 13th embodiment, an image capturing unit 100h, an image capturing unit 100i, a flash module 401, a focus assist module, an image signal processor, a display module and an image software processor (not shown). The image capturing unit 100, the image capturing unit 100h and the image capturing unit 100i are disposed on the same side of the electronic device 400, while the display module is disposed on the opposite side of the electronic device 400. Furthermore, each of the image capturing units 100h and 100i can include the capturing optical lens assembly of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. Moreover, the image capturing unit 100h can be a telephoto image capturing unit having a light-folding element configuration, such that the total track length of the image capturing unit 100h is not limited by the thickness of the electronic device 400. Moreover, the light-folding element configuration of the image capturing unit 100h can be similar to, for example, one of the structures shown in FIG. 35 to FIG. 37, which can be referred to foregoing descriptions corresponding to FIG. 35 to FIG. 37, and the details in this regard will not be provided again. In this embodiment, the electronic device 400 includes multiple image capturing units 100, 100h and 100i, but the present disclosure is not limited to the number and arrangement of image capturing units. When a user captures images of an object, light rays converge in the image capturing unit 100, 100h or 100i to generate images, and the flash module 401 is activated for light supplement. Further, the subsequent processes are performed in a manner similar to the abovementioned embodiment, so the details in this regard will not be provided again.

### 17th Embodiment

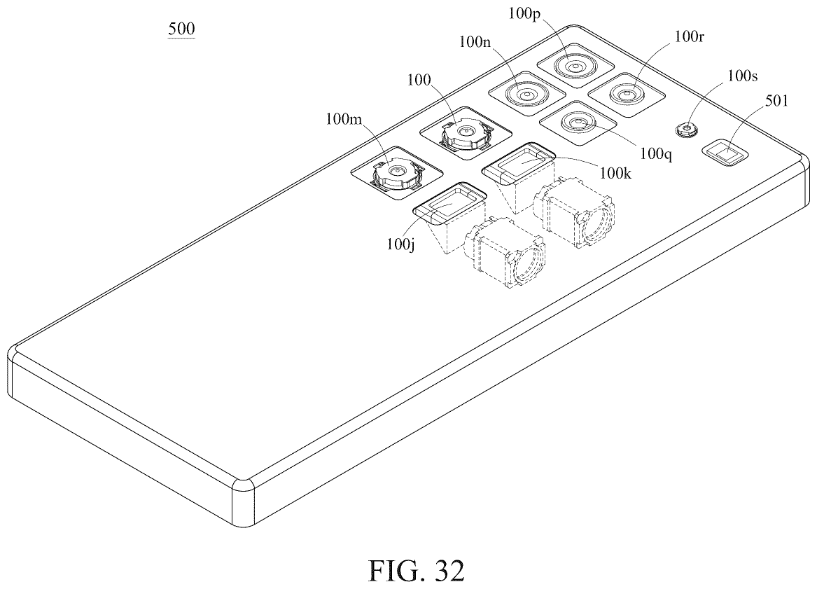

FIG. 32 is a perspective view of an electronic device according to the 17th embodiment of the present disclosure.

In this embodiment, an electronic device 500 is a smartphone including the image capturing unit 100 disclosed in the 13th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the capturing optical lens assembly of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. Moreover, each of the image capturing units 100j and 100k can be a telephoto image capturing unit having a light-folding element configuration. Moreover, the light-folding element configuration of each of the image capturing unit 100j and 100k can be similar to, for example, one of the structures shown in FIG. 35 to FIG. 37, which can be referred to foregoing descriptions corresponding to FIG. 35 to FIG. 37, and the details in this regard will not be provided again. In addition, the image capturing unit 100s can determine depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

The smartphone in several embodiments is only exemplary for showing the image capturing unit of the present disclosure installed in an electronic device, and the present disclosure is not limited thereto. The image capturing unit can be optionally applied to optical systems with a movable focus. Furthermore, the capturing optical lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-12C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A capturing optical lens assembly comprising eight lens elements, the eight lens elements being, in order from an object side to an image side along an optical path, a first lens element, a second lens element, a third lens element, a fourth lens element, a fifth lens element, a sixth lens element, a seventh lens element and an eighth lens element, and each of the eight lens elements having an object-side surface facing toward the object side and an image-side surface facing toward the image side;
wherein the first lens element has negative refractive power, the object-side surface of the fourth lens element is convex in a paraxial region thereof, the image-side surface of the fifth lens element is concave in a paraxial region thereof, the object-side surface of the seventh lens element has at least one inflection point, the eighth lens element has negative refractive power, and the object-side surface of the eighth lens element is concave in a paraxial region thereof;
wherein the capturing optical lens assembly further comprises an aperture stop, an axial distance between the object-side surface of the first lens element and the image-side surface of the third lens element is Dr1r6, an axial distance between the aperture stop and the image-side surface of the eighth lens element is SD, an axial distance between the second lens element and the third lens element is T23, an axial distance between the third lens element and the fourth lens element is T34, an axial distance between the fourth lens element and the fifth lens element is T45, an Abbe number of the third lens element is V3, a refractive index of the third lens element is N3, and the following conditions are satisfied:
$$1.05 < Dr 1 r 6 / SD < 2. ;$$
$$0.03 < ( T 23 + T 45 ) / T 34 < 5. ; and$$
$$17. < V 3 / N 3 < 50.00 .$$

2. The capturing optical lens assembly of claim 1, wherein the object-side surface of the first lens element has at least one convex shape in an off-axis region thereof, the fourth lens element has positive refractive power, the seventh lens element has positive refractive power, the object-side surface of the seventh lens element is convex in a paraxial region thereof, and the object-side surface of the eighth lens element has at least one inflection point.

3. The capturing optical lens assembly of claim 1, wherein the image-side surface of the second lens element is convex in a paraxial region thereof, the fifth lens element has negative refractive power, each of the object-side surface and the image-side surface of at least one lens element of the capturing optical lens assembly is spherical, and at least one lens element of the capturing optical lens assembly is made of glass material.

4. The capturing optical lens assembly of claim 1, wherein an axial distance between the image-side surface of the eighth lens element and an image surface is BL, a focal length of the capturing optical lens assembly is f, an axial distance between the aperture stop and the image surface is SL, an axial distance between the object-side surface of the first lens element and the image surface is TL, and the following conditions are satisfied:
$$0.08 < BL / f < 0.55 ; and$$
$$0.28 < SL / TL < 0. 62 .$$

5. The capturing optical lens assembly of claim 1, wherein at least two lens elements of the capturing optical lens assembly are made of plastic material;
wherein a central thickness of the second lens element is CT2, a central thickness of the eighth lens element is CT8, and the following condition is satisfied:
$$2. < CT 2 / CT 8 < 10.00 .$$

6. The capturing optical lens assembly of claim 1, wherein an axial distance between the object-side surface of the first lens element and an image surface is TL, an f-number of the capturing optical lens assembly is Fno, a maximum image height of the capturing optical lens assembly is ImgH, and the following condition is satisfied:
$$4.8 < TL \times Fno / ImgH < 9. 0 .$$

7. The capturing optical lens assembly of claim 1, wherein a focal length of the capturing optical lens assembly is f, a composite focal length of the fifth lens element and the sixth lens element is f56, a curvature radius of the object-side surface of the fourth lens element is R7, a curvature radius of the image-side surface of the fourth lens element is R8, and the following conditions are satisfied:
$$- 1.5 < f / f 56 < - 0.3 ; and$$
$$- 2. 0 < ( R 7 + R 8 ) / ( R 7 - R 8 ) < 2.00 .$$

8. The capturing optical lens assembly of claim 1, wherein a focal length of the capturing optical lens assembly is f, a focal length of the first lens element is f1, a focal length of the fifth lens element is f5, a focal length of the eighth lens element is f8, a curvature radius of the object-side surface of the fourth lens element is R7, a curvature radius of the image-side surface of the fourth lens element is R8, and the following conditions are satisfied:
$$- 2.50 < f / f 1 + f / f 5 + f / f 8 < - 1. ; and$$
$$- 4. 0 < R 7 / R 8 < 2.50 .$$

9. The capturing optical lens assembly of claim 1, wherein a curvature radius of the object-side surface of the first lens element is R1, a curvature radius of the image-side surface of the eighth lens element is R16, and the following condition is satisfied:
$$- 2.50 < R 1 / R 16 < 5.5 .$$

10. The capturing optical lens assembly of claim 1, wherein a curvature radius of the object-side surface of the second lens element is R3, a curvature radius of the image-side surface of the second lens element is R4, and the following condition is satisfied:
$$0.10 < R 3 / R 4 < 25. .$$

11. The capturing optical lens assembly of claim 1, wherein a focal length of the capturing optical lens assembly is f, a focal length of the second lens element is f2, a focal length of the third lens element is f3, a maximum field of view of the capturing optical lens assembly is FOV, and the following conditions are satisfied:
$$0.03 < \vert f / f 2 \vert + \vert f / f 3 \vert < 1. ; and$$
$$140. degrees < FOV < 195. degrees .$$

12. The capturing optical lens assembly of claim 1, wherein a displacement in parallel with an optical axis from an axial vertex on the image-side surface of the first lens element to a maximum effective radius position on the image-side surface of the first lens element is SAG1R2, a central thickness of the first lens element is CT1, a maximum effective radius of the object-side surface of the first lens element is Y1R1, a maximum effective radius of the image-side surface of the eighth lens element is Y8R2, and the following conditions are satisfied:
$$1.35 < SAG 1 R 2 / CT 1 < 2.5 ; and$$
$$1. < Y 1 R 1 / Y 8 R 2 < 2.00 .$$

13. The capturing optical lens assembly of claim 1, wherein a distance in parallel with an optical axis between a maximum effective radius position of the object-side surface of the third lens element and a maximum effective radius position of the image-side surface of third lens element is ET3, a distance in parallel with the optical axis between a maximum effective radius position of the object-side surface of the sixth lens element and a maximum effective radius position of the image-side surface of sixth lens element is ET6, a maximum image height of the capturing optical lens assembly is ImgH, a maximum effective radius of the object-side surface of the first lens element is Y1R1, a maximum effective radius of the object-side surface of the fourth lens element is Y4R1, and the following conditions are satisfied:
$$1.6 < ET 3 / ET 6 < 5. ; and$$
$$4.5 < ImgH / Y 4 R 1 + Y 1 R 1 / Y 4 R 1 < 16.00 .$$

14. An image capturing unit, comprising:
the capturing optical lens assembly of claim 1; and
an image sensor disposed on an image surface of the capturing optical lens assembly.

15. An electronic device, comprising:
the image capturing unit of claim 14.

16. A capturing optical lens assembly comprising eight lens elements, the eight lens elements being, in order from an object side to an image side along an optical path, a first lens element, a second lens element, a third lens element, a fourth lens element, a fifth lens element, a sixth lens element, a seventh lens element and an eighth lens element, and each of the eight lens elements having an object-side surface facing toward the object side and an image-side surface facing toward the image side;
wherein the object-side surface of the second lens element is concave in a paraxial region thereof, the image-side surface of the second lens element is convex in a paraxial region thereof, the object-side surface of the fourth lens element is convex in a paraxial region thereof, the fifth lens element has negative refractive power, and the object-side surface of the seventh lens element has at least one inflection point;
wherein the capturing optical lens assembly further comprises an aperture stop, an axial distance between the object-side surface of the first lens element and the image-side surface of the third lens element is Dr1r6, an axial distance between the aperture stop and the image-side surface of the eighth lens element is SD, a curvature radius of the image-side surface of the first lens element is R2, a curvature radius of the image-side surface of the eighth lens element is R16, a maximum field of view of the capturing optical lens assembly is FOV, and the following conditions are satisfied:
$$1.05 < Dr 1 r 6 / SD < 2. ;$$
$$- 1. < R 2 / R 16 < 1.3 ; and$$
$$130. degrees < FOV < 200. degrees .$$

17. The capturing optical lens assembly of claim 16, wherein the first lens element has negative refractive power, the object-side surface of the seventh lens element is convex in a paraxial region thereof, and there is an air gap in a paraxial region between each of all adjacent lens elements of the capturing optical lens assembly.

18. The capturing optical lens assembly of claim 16, wherein the eighth lens element has negative refractive power;
wherein an axial distance between the second lens element and the third lens element is T23, an axial distance between the third lens element and the fourth lens element is T34, an axial distance between the fourth lens element and the fifth lens element is T45, and the following condition is satisfied:
$$0.03 < ( T 23 + T 45 ) / T 34 < 5. .$$

19. The capturing optical lens assembly of claim 16, wherein the object-side surface of the eighth lens element is concave in a paraxial region thereof, and at least one lens element of the capturing optical lens assembly is made of glass material and has each of the object-side surface and the image-side surface being spherical.

20. The capturing optical lens assembly of claim 16, wherein a focal length of the fifth lens element is f5, a focal length of the eighth lens element is f8, a curvature radius of the image-side surface of the second lens element is R4, a curvature radius of the object-side surface of the eighth lens element is R15, and the following conditions are satisfied:
$$- 1. < f 5 / f 8 < 3. ; and$$
$$- 1. < R 15 / R 4 < 20.00 .$$

21. The capturing optical lens assembly of claim 16, wherein a focal length of the capturing optical lens assembly is f, a focal length of the sixth lens element is f6, a curvature radius of the object-side surface of the eighth lens element is R15, the curvature radius of the image-side surface of the eighth lens element is R16, and the following conditions are satisfied:
$$- 0.50 < f / f 6 < 0.3 ; and$$
$$- 7.5 \; 0 < ( R 15 + R 16 ) / ( R 15 - R 16 ) < 1.5 .$$

22. The capturing optical lens assembly of claim 16, wherein a central thickness of the second lens element is CT2, a central thickness of the third lens element is CT3, a central thickness of the fourth lens element is CT4, a central thickness of the fifth lens element is CT5, a central thickness of the sixth lens element is CT6, a central thickness of the seventh lens element is CT7, a central thickness of the eighth lens element is CT8, and the following condition is satisfied:
$$0.7 < ( CT 2 + CT 3 ) / ( CT 4 + CT 5 + CT 6 + CT 7 + CT 8 ) < 180 .$$

23. The capturing optical lens assembly of claim 16, wherein the image-side surface of the fifth lens element is concave in a paraxial region thereof;
wherein an axial distance between the aperture stop and an image surface is SL, an axial distance between the object-side surface of the first lens element and the image surface is TL, and the following condition is satisfied:
$$0.25 < SL / TL < 0.75 .$$

24. The capturing optical lens assembly of claim 16, wherein the curvature radius of the image-side surface of the first lens element is R2, a curvature radius of the object-side surface of the seventh lens element is R13, and the following condition is satisfied:
$$- 0.10 < R 2 / R 13 < 2.00 .$$

25. The capturing optical lens assembly of claim 16, wherein the image-side surface of the fourth lens element is convex in a paraxial region thereof;
wherein an axial distance between the image-side surface of the eighth lens element and an image surface is BL, a focal length of the capturing optical lens assembly is f, and the following condition is satisfied:
$$0.08 < BL / f < 0.55 .$$

26. The capturing optical lens assembly of claim 16, wherein a maximum image height of the capturing optical lens assembly is ImgH, an axial distance between the object-side surface of the first lens element and the image-side surface of the eighth lens element is TD, and the following condition is satisfied:
$$0.5 < 2 \times ImgH / TD < 1.10 .$$

27. The capturing optical lens assembly of claim 16, wherein a maximum effective radius of the image-side surface of the fifth lens element is Y5R2, a maximum effective radius of the object-side surface of the sixth lens element is Y6R1, a maximum effective radius of the image-side surface of the sixth lens element is Y6R2, a maximum effective radius of the object-side surface of the seventh lens element is Y7R1, and the following condition is satisfied:
$$2.3 < Y 7 R 1 / Y 6 R 2 + Y 6 R 1 / Y 5 R 2 < 4.00 .$$

28. The capturing optical lens assembly of claim 16, wherein a vertical distance between an off-axial critical point closest to an optical axis on the object-side surface of the seventh lens element and the optical axis is Yc71, a vertical distance between an inflection point closest to the optical axis on the object-side surface of the eighth lens element and the optical axis is Yi81, a distance in parallel with the optical axis between a maximum effective radius position of the object-side surface of the first lens element and a maximum effective radius position of the image-side surface of first lens element is ET1, a central thickness of the first lens element is CT1, and the following conditions are satisfied:
$$0.65 < Yc 71 / Yi 81 < 1.4 ; and$$
$$1.1 < ET 1 / CT 1 < 2.2 .$$

29. The capturing optical lens assembly of claim 16, wherein the axial distance between the object-side surface of the first lens element and the image-side surface of the third lens element is Dr1r6, the axial distance between the aperture stop and the image-side surface of the eighth lens element is SD, an axial distance between the second lens element and the third lens element is T23, an axial distance between the third lens element and the fourth lens element is T34, an axial distance between the fourth lens element and the fifth lens element is T45, an Abbe number of the third lens element is V3, a refractive index of the third lens element is N3, the curvature radius of the image-side surface of the first lens element is R2, the curvature radius of the image-side surface of the eighth lens element is R16, the maximum field of view of the capturing optical lens assembly is FOV, and the following conditions are satisfied:
$$1.29 \leq Dr 1 r 6 / SD \leq 1.67 ;$$
$$0.12 \leq ( T 23 + T 45 ) / T 34 \leq 1.23 ;$$
$$36.22 \leq V 3 / N 3 \leq 38 \text{.79} ;$$
$$- 0.1 \; 2 \leq R 2 / R 16 \leq 0.57 ; and$$
$$153.8 degrees \leq FOV \leq 173.04 degrees .$$
